(19) United States
(12) Patent Application Publication
(10) Pub. No.: US 2016/0328604 A1
(43) Pub. Date: Nov. 10, 2016

(54) SYSTEMS AND METHODS OF MONITORING ACTIVITIES AT A GAMING VENUE

(71) Applicant: ARB LABS INC., Mississauga (CA)

(72) Inventor: Adrian BULZACKI, Mississauga (CA)

(21) Appl. No.: 15/110,093

(22) PCT Filed: Jan. 7, 2015
(86) PCT No.: PCT/CA2015/000009

§ 371 Date: Jul. 6, 2016

Related U.S. Application Data
(60) Provisional application No. 61/924,530, filed on Jan. 7, 2014.

(51) Int. Cl. G06K 9/00; A63F 13/211; A63F 13/213; G07F 17/32

(52) U.S. Cl. CPC G06K 9/00355; G06K 9/00771; G07F 17/3206; A63F 13/211; A63F 13/213; G07F 17/3241; A63F 2300/1087; A63F 2300/105

(57) ABSTRACT

Systems and methods are provided in relation to monitoring activities at a gaming venue. A system for monitoring activities at a gaming venue may be provided, including one or more capture devices configured to capture gesture input data, each of the capture devices disposed so that one or more monitored individuals are within an operating range of the data capture device; and one or more electronic datastores configured to store a plurality of rules governing activities at the gaming venue; an activity analyzer comprising: a gesture recognition component configured to: receive gesture input data captured by the one or more capture devices; extract a plurality of sets of gesture data points from the captured gesture input data, each set corresponding to a point in time, and each gesture data point identifying a location of a body part of the one or more monitored individuals with respect to a reference point on the body of the one or more monitored individuals; identify one or more gestures of interest by processing the plurality of sets of gesture data points, the processing comprising comparing gesture data points between the plurality of sets of gesture data points; a rules enforcement component configured to: determine when the one or more identified gestures of interest correspond to activity that contravenes one or more of the rules stored in the one or more electronic datastores.

### FIELD

The present invention relates generally to activity monitoring, and more particularly, the present invention relates to systems and methods for monitoring activities at venues through gesture data.

### BACKGROUND

Gestures may be viewed as an important aspect of body language and may be used every day in communications between people. For many people, it may be difficult to avoid making some kind of gesture when communicating face to face with another person. Gestures may convey messages easily and seemingly wordlessly. Being able to consistently and rapidly assess and perform gestures may form the basis of many forms of entertainment, including games that can be either cooperative or competitive in nature. Gestures may represent a variety of different things including emotions to representations of more concrete things such as intentions, people, places or things. Finding a way to differentiate between these forms of communication accurately may be beneficial for a variety of purposes.

Typically in the industry, solutions to certain challenges of implementing gesture recognition systems have been suggested for example by Prof. Ling Guan and Prof. Matthew Kyan and the published papers “Computerized Recognition of Human Gestures” by A. Bulzacki, L. Zhao, L. Guan and K. Raahemifar and “An Introduction to Gesture Recognition Through Conversion to a Vector Based Medium” by A. Bulzacki, L. Guan and L. Zhao.

### SUMMARY

Machines may have the potential to successfully classify a gesture quicker and more efficiently than a human being using computer implemented processes, such as for example machine learning. Using machine learning, a machine may be taught to recognize gestures. The potential for machine-based intelligence to categorize and detect different types of gestures may be used to expand the worlds of electronic communication, interactive entertainment, and security systems. Furthermore, the same gesture, may be expressed from human to human, or from time to time by the same human, using movements that vary. Gesture may be of interest because they reflect intentions of a human, or an operator wishes to detect one or more gestures for a particular purpose. For example, certain gestures may be indicative of suspicious, fraudulent, or dangerous behaviour, and an operator may want to detect such gestures as a mechanism to prevent or act upon such behaviour. If recognition of gestures of interest requires a relatively high degree of specificity, then relevant gestures may be missed. If a threshold of specificity however is set to low then there may be false positives, thereby misinterpreting certain gestures.

Also, what actually defines a gesture, and what that gesture means may be a subjective view. Gestures may include one or more sequences of movements of a human body through a range of time. Gestures may also include a set of configurations or positions of the human body at a particular point in time. In some instances, gestures include a particular position of a human body at a particular instant or a specific point in time. A multitude of such particular positions through time may make up a sequence of movements, which may also be used to define a gesture. In some embodiments, an orientation or position of one or more body parts of a human body at a particular time, as well as the movement of these one or more body parts, such as joints, through time may define a gesture.

In an aspect, a system for monitoring activities at a gaming venue is provided, including one or more capture devices configured to capture gesture input data, each of the capture devices disposed so that one or more monitored individuals are within an operating range of the data capture device; and one or more electronic datastores configured to store a plurality of rules governing activities at the gaming venue; an activity analyzer comprising: a gesture recognition component configured to: receive gesture input data captured by the one or more capture devices; extract a plurality of sets of gesture data points from the captured gesture input data, each set corresponding to a point in time, and each gesture data point identifying a location of a body part of the one or more monitored individuals with respect to a reference point on the body of the one or more monitored individuals; identify one or more gestures of interest by processing the plurality of sets of gesture data points, the processing comprising comparing gesture data points between the plurality of sets of gesture data points; a rules enforcement component configured to: determine when the one or more identified gestures of interest correspond to activity that contravenes one or more of the rules stored in the one or more electronic datastores.

In another aspect, the gesture recognition component utilizes one or more compression techniques.

In another aspect, the one or more compression techniques comprises: determining that a subset of the gesture data points is sufficient to recognize the one or more gestures; and identifying one or more gestures of interest by comparing gesture data points from the subset of the gesture data point.

In another aspect, the determining that a subset of the set of gesture data points is sufficient to recognize a movement is determined by: applying one or more weights to the one or more gesture data points based on variance of the one or more gesture data points across a plurality of sets of data points; and selecting the one or more gesture data points that satisfy a threshold weight as the subset of the one or more gesture data points.

In another aspect, the compression techniques include principal component analysis.

In another aspect, the compression techniques include slow and fast motion vector representations.

In another aspect, wherein the compression techniques include the use of techniques based on polynomial approximation and eigenvectors.

In another aspect, a method of monitoring activities at a gaming venue is provided, the method includes capturing gesture input data using one or more capture devices, each of the capture devices disposed so that one or more monitored individuals are within an operating range of the data capture device; and storing a plurality of rules governing activities at the gaming venue; extracting a plurality of sets of gesture data points from the captured gesture input data, each set corresponding to a point in time, and each gesture data point identifying a location of a body part of the one or more monitored individuals with respect to a reference point on the body of the one or more monitored individuals; processing the plurality of sets of gesture data points to identify one or more gestures of interest, the processing comprising comparing gesture data points between the plurality of sets of gesture data points; determining when the one or more identified gestures of interest correspond to activity that contravenes one or more of the rules stored in the one or more electronic datastores.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE FIGURES

The following drawings correspond to the subject matter of the present disclosure:

FIG. 1 illustrates a block diagram of an embodiment of a computing environment in which the features of the present invention are executed and implemented.

FIG. 2 illustrates a block diagram of an embodiment of a system for detecting movements of a subject using multidimensional gesture data.

FIG. 3 illustrates a block diagram of another embodiment of a system for detecting movements of a subject using multidimensional gesture data.

FIG. 4 illustrates a flow diagram outlining steps of a method of detecting movements of a subject using multidimensional gesture data.

FIG. 5 illustrates an embodiment of a subject along with feature points referring to locations on the subject's body that are identified by the gesture data.

FIGS. 6A, 6B and 6C illustrate examples of classes and illustrations of various data points included in a frame.

FIG. 7 illustrates an embodiment of a subject with gesture data illustrated in connection with a reference point on the subject's body.

FIG. 8A illustrates an embodiment of a collection of frames in which gesture data identifies positions of the subject's body parts through a movement of frames in time.

FIG. 8B illustrates an embodiment of a collection of gesture data points within a frame in which a subject is depicted in a particular position.

FIG. 9 illustrates an embodiment of data collected in an experiment.

FIG. 10A illustrates an embodiment of a skeleton of a subject.

FIG. 10B illustrates an embodiment of a subject whose body is represented with a set of gesture data features.

FIG. 10C illustrates an embodiment of self-referential gesture data representations.

FIG. 11 illustrates an exemplary embodiment of a mathematical representation of a feature matrix comprising the gesture data.

FIG. 12 illustrates an exemplary embodiment of a mathematical representation of self-referencing of the gesture data.

FIG. 13 illustrates an exemplary embodiment of a mathematical representation of scaling and/or normalizing of the gesture data.

FIG. 14. Illustrates an exemplary embodiment of a mathematical representation of PCA collapsing of the gesture data.

FIG. 15 illustrates an exemplary embodiment of a mathematical representation of slow and fast motion vectors.

FIG. 16 illustrates an exemplary embodiment of a mathematical representation of a temporal vector.

FIG. 17 illustrates an embodiment of a block diagram of a system for providing non-contact, hardware-free display interface based on the gesture data matching technique.

FIG. 18A illustrates an embodiment of a user using the present systems and methods for interfacing with a display.

FIG. 18B illustrates another embodiment of a user using the present systems and methods for interfacing with a display.

FIG. 19A schematically illustrates a group of users standing in a view of a camera detector and gesture data captured by the detector in accordance with an embodiment of the present teachings.

FIG. 19B schematically illustrates the activation and operation of a mouse by a user in accordance with an embodiment of the present teachings.

FIG. 19C schematically illustrates a user performing a “mouse click on” gesture or motion.

FIG. 19D schematically illustrates a user performing a “mouse off” gesture.

FIG. 19E schematically illustrates four different gestures, each of which refers to a separate action.

FIG. 19F schematically illustrates a user standing in a room, where the left side of the figure shows the user surrounded by virtual user movement objects.

FIG. 20 illustrates is an embodiment of a block diagram of a system for providing non-contact, hardware-free display interface in a shower.

FIG. 21 illustrates an embodiment of a user using the present systems and methods to interface with a display in a shower.

FIG. 22 illustrates a possible embodiment of the system that is adapted to use in connection with card players.

FIG. 23 illustrates another possible embodiment of the system that is adapted to use in connection with card players.

FIG. 24A illustrates an embodiment showing 2-dimensional plots of left hand GJPs (“gesture joint point”) of a user performing a jumping jack along an x-axis as a function of time.

FIG. 24B illustrates an embodiment showing 2-dimensional plots of the left hand GJPs of a user performing a jumping jack along a y-axis as a function of time.

FIG. 24C illustrates an embodiment showing 2-dimensional plots of the left hand GJPs of a user performing a jumping jack along a z-axis as a function of time.

FIG. 25 illustrates an embodiment showing left hand GJPs of a user performing a clapping gesture using third dimensional polynomials.

FIG. 26 illustrates an embodiment showing third dimensional polynomial approximation of 45 frames and 15 frames of right hand GJPs along an x-axis.

FIG. 27 illustrates an embodiment showing the transformation of an Eigen vector.

FIG. 28 is an illustration showing distribution of classification accuracy across different numbers of samples.

FIGS. 29A, 29B, 29C, 29D, and 29E illustrate a possible embodiment of the system, for providing a monitoring system in a game playing environment such as a casino.

FIG. 30 is a possible computer system resource diagram, illustrating a general computer system implementation of the present invention.

FIG. 31 is a computer system resource diagram, illustrating a possible computer network implementation of a monitoring system of the present invention.

FIGS. 32A and 32B illustrate an example of a camera for use with, or as part of, a monitoring system of the present invention.

FIG. 33A is a representation of a casino worker monitored using the monitoring system of the present invention.

FIG. 33B is a representation of the recognition of body parts by the monitoring system of the present invention.

FIGS. 34a and 34B consist of representations of a casino worker performing a “hand wash”.

FIGS. 35A. 35B, 35C and 35D illustrate a series of individual gestures involved in detection of a hand wash.

FIG. 36A is an image showing a chip counting implementation of the present invention.

FIG. 36B shows one aspect of a chip counting implementation of the present invention, namely a scale connected to the system of the present invention.

FIG. 37 is a graph illustrative of sample count plotted against classification rate.

FIG. 38 is a graph illustrative of an eigenvector x and Matrix A.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

The present disclosure provides systems and methods of detecting and recognizing movements and gestures of a body, such as a human body, using a gesture recognition system taught or programmed to recognize such movements and gestures. The present disclosure is also directed to systems and methods of teaching or programming such a system to detect and identify gestures and movements of a body, as well as various applications which may be implemented using this system. While it is obvious that any embodiment described herein may be combined with any other embodiments discussed anywhere in the specification, for simplicity the present disclosure is generally divided into the following sections:

Section A is generally directed to systems and methods of detecting body movements using gesture data.

Section B is generally directed to systems and methods of compressing gesture data based on principal joint variables analysis.

Section C is generally directed to systems and methods of compressing gesture data based on personal component analysis.

Section D is generally directed to systems and methods of compressing gesture data slow and fast motion vector representations.

Section E is generally directed to non-contact, hardware-free display interface using gesture data.

Section F is generally directed to systems and methods of adjusting gesture recognition sensitivity.

Section G is generally directed to systems and methods of improving detection by personalization of gesture data.

Section H is generally directed to systems and methods of detecting interpersonal interaction using gesture data.

Section I is generally directed to systems and methods of distributing gesture data samples via a web page.

Section J is generally directed to systems and methods of preparing gesture samples using a software application.

Section K is generally directed to systems and methods of compressing gesture data based on polynomial approximation and eigenvectors.

Section L is generally directed to a motion monitoring system of the present invention.

In accordance with some embodiments, the systems and methods described may be used in a various applications, such as the detection of activities of interest in the context of a gaming venue, such as a casino, a race-track, a poker table, etc. For example, the gesture monitoring may be used for the monitoring of various activities, such as fraudulent activities, poor dealer form (e.g., accidentally showing cards), player activities (e.g., suspiciously placing chips into pockets), etc. Further, the systems and methods may also include the use of various sensors, such as chip counting sensors and/or other types of sensors.

### A. Systems and Methods of Detecting Body Movements Using Gesture Data

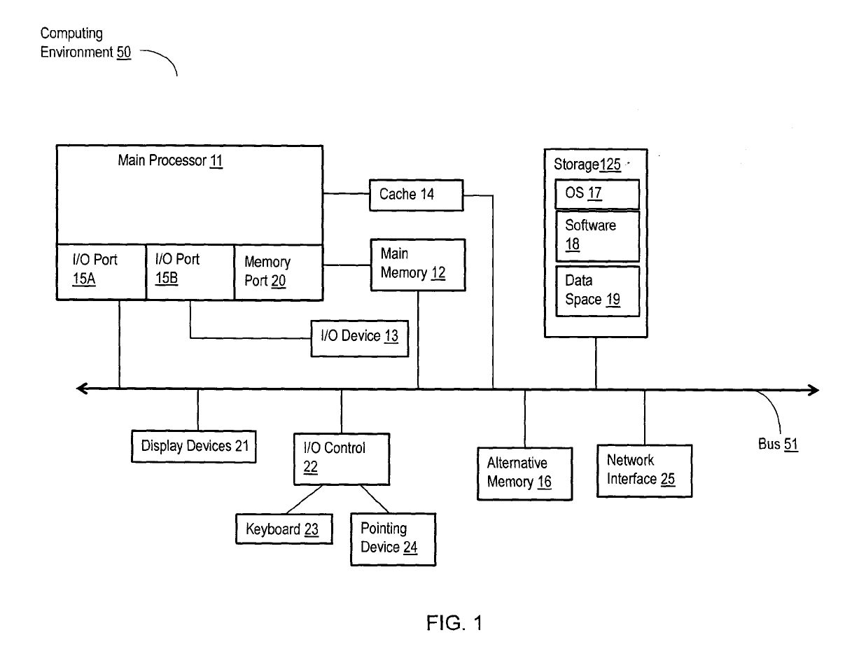

Referring now to FIG. 1, an embodiment of a computing environment 50 in which the features of the present invention may be implemented is illustrated. In brief overview, devices or systems described herein may include functions, algorithms or methods that may be implemented or executed on any type and form of computing device, such as a computer, a mobile device, a video game device or any other type and form of a network device capable of communicating on any type and form of network and performing the operations described herein. FIG. 1 depicts a block diagram of a computing environment 50, which may be present on any device or system, such as a remote crowding device or crowd sourcing system described later. Computing environment 50 may include hardware and combinations of hardware and software providing the structure on a computing device on which the embodiments of the present disclosure are practiced. Each computing device or a system includes a central processing unit also referred to as a main processor 11 that includes one or more memory ports 20 and one or more input output ports, also referred to I/O ports 15, such as the I/O ports 15A and 15B. Computing environment 50 may further include, a main memory unit 12 which may be connected to the remainder of the components of the computing environment 50 via a bus 51 and/or may be directly connected to the main processor 11 via memory port 20. The computing environment 50 of a computing device may also include a visual display device 21 such as a monitor, projector or glasses, a keyboard 23 and/or a pointing device 24, such as a mouse, interfaced with the remainder of the device via an I/O control 22. Each computing device 100 may also include additional optional elements, such as one or more input/output devices 13. Main processor 11 may comprise or be interfaced with a cache memory 14. Storage 125 may comprise memory which provides an operating system, also referred to as OS 17, additional software 18 operating on the OS 17 and data space 19 in which additional data or information may be stored. Alternative memory device 16 may be connected to the remaining components of the computing environment via bus 51. A network interface 25 may also be interfaced with the bus 51 and be used to communicate with external computing devices via an external network.

Main processor 11 includes any logic circuitry that responds to and processes instructions fetched from the main memory unit 122. Main processor 11 may also include any combination of hardware and software for implementing and executing logic functions or algorithms. Main processor 11 may include a single core or a multi core processor. Main processor 11 may comprise any functionality for loading an operating system 17 and operating any software 18 thereon. In many embodiments, the central processing unit is provided by a microprocessor unit. The computing device may be based on any of these processors, or any other processor capable of operating as described herein.

Main memory unit 12 may include one or more memory chips capable of storing data and allowing any storage location to be directly accessed by the microprocessor 101. The main memory 12 may be based on any of the above described memory chips, or any other available memory chips capable of operating as described herein. In some embodiments, the main processor 11 communicates with main memory 12 via a system bus 51. In some embodiments of a computing device comprising computing environment 50, the processor communicates directly with main memory 122 via a memory port 20.

FIG. 1 depicts an embodiment in which the main processor 11 communicates directly with cache memory 14 via a connection means, such as a secondary bus which may also sometimes be referred to as a backside bus. In other embodiments, main processor 11 communicates with cache memory 14 using the system bus 51. Main memory, I/O device 13 or any other component of the computing device comprising a computing environment 50 may be connected with any other components of the computing environment via similar secondary bus, depending on the design. Cache memory 14 however may typically have a faster response time than main memory 12 and may be include a type of memory which may be considered faster than main memory 12. In some embodiments, the main processor 11 communicates with one or more I/O devices 13 via a local system bus 51. Various busses may be used to connect the main processor 11 to any of the I/O devices 13. For embodiments in which the I/O device is a video display 21, the main processor 11 may use an Advanced Graphics Port (AGP) to communicate with the display 21. In some embodiments, main processor 11 communicates directly with I/O device 13. In further embodiments, local busses and direct communication are mixed. For example, the main processor 11 communicates with I/O device 13 using a local interconnect bus while communicating with I/O device 13 directly. Similar configurations may be used for any other components described herein.

Computing environment 50 of a computing device may further include alternative memory, such as a hard-drive or any other device suitable for storing data or installing software and programs. Computing environment 50 may further include a storage device 125 which may include one or more hard disk drives or redundant arrays of independent disks, for storing an operating system, such as OS 17, software 18 and/or providing data space 19 for storing additional data or information. In some embodiments, an alternative memory 16 may be used as the storage device 125.

Computing environment 50 may include a network interface 25 to interface to a Local Area Network (LAN), Wide Area Network (WAN) or the Internet through a variety of network connections. The network interface 25 may include a device suitable for interfacing the computing device to any type of network capable of communication and performing the operations described herein.

In some embodiments, the computing environment may comprise or be connected to multiple display devices 21. Display devices 21 may each be of the same or different type and/or form. I/O devices 13 and/or the I/O control 22 may comprise any type and/or form of suitable hardware, software, or combination of hardware and software to support, enable or provide for the connection and use of multiple display devices 21 or multiple detection devices, such as detector 105 described below.

In one example, computing device includes any type and/or form of video adapter, video card, driver, and/or library to interface, communicate, connect or otherwise use the display devices 21 or any I/O devices 13 such as video camera devices. In one embodiment, a video adapter may comprise multiple connectors to interface to multiple display devices 21. In other embodiments, the computing device may include multiple video adapters, with each video adapter connected to one or more of the display devices 21. In some embodiments, any portion of the operating system of the computing device may be configured for using multiple displays 21. In other embodiments, one or more of the display devices 21 may be provided by one or more other computing devices, such as computing devices connected to a remote computing device via a network.

Computing environment may operate under the control of operating systems, such as OS 17, which may control scheduling of tasks and access to system resources. The computing device may be running any operating system such as any of the versions of the Microsoft Windows™ operating systems, the different releases of the Unix and Linux operating systems, any version of the Mac OS™ for Macintosh computers, any embedded operating system, any real-time operating system, any open source operating system, any video gaming operating system, any proprietary operating system, any operating systems for mobile computing devices, or any other operating system capable of running on the computing device and performing the operations described herein.

In other embodiments, the computing device having the computing environment 50 may have any different combination of processors, operating systems, and input devices consistent with the device's purpose and structure. For example, in one embodiment the computing device consists of smart phone or other wireless device. In another example, the computing device includes a video game console such as a Wii™ video game console released by Nintendo Co. In this embodiment, the I/O devices may include a video camera or an infrared camera for recording or tracking movements of a player or a participant of a Wii video game. Other I/O devices 13 may include a joystick, a keyboard or an RF wireless remote control device.

Similarly, the computing environment 50 may be tailored to any workstation, desktop computer, laptop or notebook computer, server, handheld computer, mobile telephone, gaming device, any other computer or computing product, or other type and form of computing or telecommunications device that is capable of communication and that has sufficient processor power and memory capacity to perform the operations described herein.

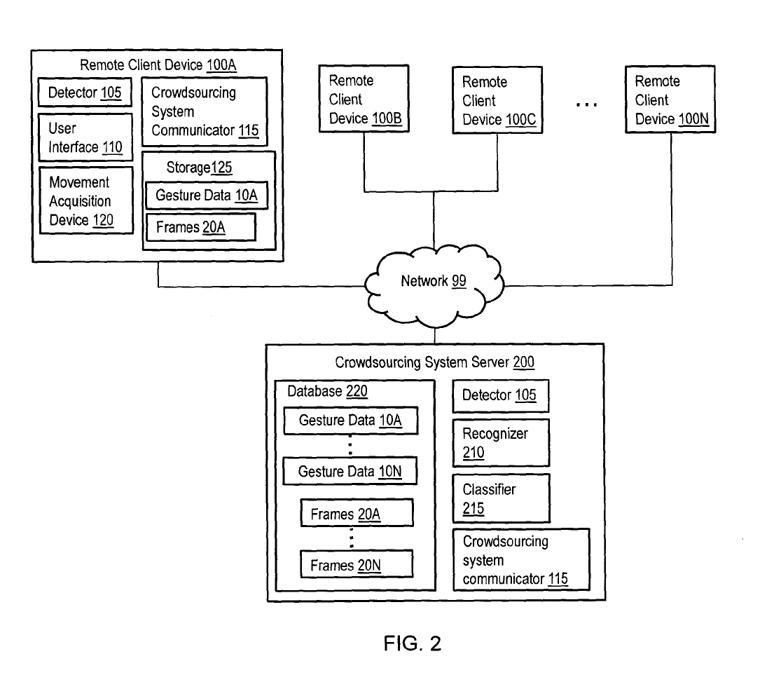

Referring now to FIG. 2, an embodiment of a system for identifying a movement of a subject based on crowd sourcing data is displayed. FIG. 2A illustrates a remote client device 100A comprising a detector 105, a user interface 110, a crowdsourcing system communicator 115, a movement acquisition device 120 and a storage 125 which further comprises gesture data 10A and/or frames 20A. FIG. 2A also illustrates additional remote client devices 100B and devices 100C through 100N that communicate with a crowdsourcing system server 200 via network 99. Crowdsourcing system server 200 comprises a database 220 that includes gesture data 10A-N and frames 10A-N which are received from remote client devices 100A-N via the network 99. Crowdsourcing system server 200 further comprises a detector 105, a recognizer 210, a classifier 215 and a crowdsourcing system communicator 115.

In a brief overview, crowdsourcing system server 200 receives from a plurality of remote client devices 100A-N gesture data 10 and/or frames 20 which the remote client devices 100A-N collected via their own detectors 105, such as the video cameras. The gesture data 10 organized into frames 20 may include information identifying movements of body parts of persons performing specific actions or body motions. Gesture data 10 organized into frames 20 may include specific positions of certain body parts of a person (e.g. a shoulder, chest, knee, finger tips, palm, ankle, head, etc.) with respect to a particular reference point (e.g. a waist of the person depicted). Frames 20 may include collections of gesture data 10 points describing a location of a plurality of particular body parts with respect to the reference point. Classifier 215 on the server 200 may use gesture data 10 of the one or more frames 20 to process and “learn” to detect the particular body movement. Classifier 215 may assign each particular frame to a particular body movement for future detection and recognition. As the frames 20 may include a series of gesture data 10 identifying positions of each of the body parts of a person at a particular time point, the collection of frames may thus include and describe the entire movement of the subject. Each of the gesture data 10 points may be used by the system will learn to classify and identify the body movement.

Upon processing by a classifier 215, once the same or similar movement is detected by a detector 105 in the future, a recognizer 210 may identify the given movement of the person using the classified frames 20 associated with this particular movement. As the database 220 of the crowdsourcing system server 200 is populated with frames 20 that include gesture data 10 gathered from various remote client devices 100A-N, the classifier 215 may classify and distinguish between an increasing number of body movements. As the result, with each additional data the classifier 215 processes and classifies, the system's capacity to recognize additional movements grows.

Using crowdsourcing data from a large number of remote clients 100 may therefore quickly provide the system with the necessary gesture data 10 and frames 20 to quickly and efficiently populate the database 220 with valid data to be used for detection and prediction of body movements of various subjects in the future.

In a greater detail and still referring to FIG. 2, network 99 may comprise any type and form of medium through which communication between the devices 100 and system server 200 may occur. The network 99 may a local-area network (LAN), such as a company Intranet, a metropolitan area network (MAN), or a wide area network (WAN), such as the Internet or the World Wide Web. In one embodiment, network 99 is a private network. In another embodiment, network 99 is a public network. Network 99 may refer to a single network or a plurality of networks. For example, network 99 may include a LAN, a WAN and another LAN network. Network 99 may include any number of networks, virtual private networks or public networks in any configuration. Network 99 include a private network and a public network interfacing each other. In another embodiment, network 99 may include a plurality of public and private networks through which information traverses en route between devices 100 and server 200. In some embodiments, devices 100 may be located inside a LAN in a secured home network or an internal corporate enterprise network and communicating via a WAN connection over the network 99 to the server 200 located at a corporate data center.

Network 99 may be any type and/or form of network and may include any of the following: a point to point network, a broadcast network, a wide area network, a local area network, a telecommunications network, a data communication network, or a computer network. In some embodiments, the network 99 may comprise a wireless link, such as an infrared channel or satellite band.

A remote client device 100, such as device 100A, 100B, 100C through 100N, can include any type and form of a computing device comprising the functionality of a computing environment 50. Remote client device 100 may comprise hardware, software or a combination of hardware and software for gathering data, processing data, storing data and transmitting and receiving data to and from the crowdsourcing system server 200. Remote client device 100 may comprise applications, functions or algorithms for gathering, structuring and/or processing data from a detector 105. Remote client device 100 may include a video game system, such as a Nintendo Wii™, a Sony Playstation™ or a Microsoft Xbox™.

Remote client device 100 may comprise a laptop computer or a desktop computer. Remote client device 100 may comprise a smart phone or any other type and form of a mobile device or any other type and form of a device capable of implementing the functionality described herein and/or communicating via a network.

Remote client device 100 may include a detector 105, a user interface 110, a movement acquisition device 120, a crowdsourcing system communicator 115, a recognizer 210 and/or any other components or device described herein. Remote client device 100 and any component of the device 100 may comprise a computing environment 50 or any functionality of the computing environment 50 to implement the functionality described herein.

Detector 105 may comprise any hardware, software or a combination of hardware and software for detecting or recording information or data identifying, describing or depicting a movement of a person. Detector 105 may comprise any type and form of a device or a function for detecting visual data that may identify or describe a person, a position of a person or a movement of a person. Detector 105 may comprise a video camera or a camcorder. Detector 105 may be a streaming camera outputting a digital video stream to the remote client device 100A. Detector 105 may be an integral part of the device 100 or an independent device external to the device 100 and interfaced with the device 100 via a chord, a cable or a network 99. Detector 105 may also be internal to or external from the server 200. Detector 105 may comprise an infrared camera.

Detector 105 may include a high definition or a high resolution digital camera or camcorder. Detector 105 may include a motion detector or an array of motion detectors. Detector 105 may include a microphone. Detector 105 may include any one or more of or any combination of: an acoustic sensor, an optical sensor, an infrared sensor, a video image sensor and/or processor, a magnetic sensor, a magnetometer, or any other type and form of detector or system which may be used to detect, record or identify a movement of a person.

Detectors 105 may include any functionality for recording movements of specific body parts with respect to a reference point, such as for example a waist of the subject being recorded. In some embodiments, a detector 105 includes the functionality for recording a distance or a position of a fingertip of a hand of a person with respect to a reference point. In some embodiments, detector 105 includes the functionality for recording a distance or a position of a shoulder of a person with respect to a reference point. In further embodiments, detector 105 includes the functionality for recording a distance or a position of a hip of a person with respect to a reference point. In certain embodiments, detector 105 includes the functionality for recording a distance or a position of an elbow of a person with respect to a reference point. In some embodiments, detector 105 includes the functionality for recording a distance or a position of a palm of a hand of a person with respect to a reference point. In further embodiments, detector 105 includes the functionality for recording a distance or a position of a knee of a person with respect to a reference point. In some embodiments, detector 105 includes the functionality for recording a distance or a position of a heel of a person with respect to a reference point. In certain embodiments, detector 105 includes the functionality for recording a distance or a position of a toe of a person with respect to a reference point. In some embodiments, detector 105 includes the functionality for recording a distance or a position of a head of a person with respect to a reference point. In some embodiments, detector 105 includes the functionality for recording a distance or a position of a neck of a person with respect to a reference point. In further embodiments, detector 105 includes the functionality for recording a distance or a position of a pelvis of a person with respect to a reference point. In certain embodiments, detector 105 includes the functionality for recording a distance or a position of a belly of a person with respect to a reference point.

The reference point may be any given portion or location of a subject being recorded. In some embodiments, the reference point with respect to which all the other body parts are identified or measured includes a frontal midsection of the person's waist. In some embodiments, the reference point is a backside midsection of the person's waist. The reference point may be the center point of the person's waist depending on the orientation of the person with respect to the detector 105. In other embodiments, the reference point may be a person's head or a person's chest or a person's belly button. The reference point may be any portion of the human body referred to herein. Depending on the design, the reference point may be chosen to be any part or portion of a human body picked such that this location minimizes the errors in detection of the distance or relation of the position of some body parts to the reference point.

User interface 110 may comprise any type and form of interface between the user of the remote client device 110 and the device 100 itself. In some embodiments, user interface 110 includes a mouse and/or a keyboard. User interface may comprise a display monitor or a touchscreen for displaying information to the user and for enabling the user interaction with the device. In further embodiments, user interface 110 includes a joystick.

In certain embodiments, user interface 110 includes a game tailored video game tool that allows the user to control data inputs to the video game or participate in the video game. User interface 110 may include functionality for the user to control the functionality of the remote client device 100. User interface 110 may comprise the functionality for controlling the gesture data 10 or data frame 20 acquisition and/or storage. User interface 110 may include the controls for the user to initiate the process of recording movements of the users via the detector 105.

Movement acquisition device 120 may comprise any hardware, software or a combination of hardware and software for acquiring movement data. Movement acquisition device 120 may comprise the functionality, drivers and/or algorithms for interfacing with a detector 105 and for processing the output data gathered from the detector 105. Movement acquisition device 120 may include the functionality and structure for receiving data from any type and form of detectors 105. For example, a movement acquisition device 120 may include the functionality for receiving and processing the video stream from a detector 105. Movement acquisition device 120 may include the functionality for processing the output data to identify any gesture data 10 within the output data. Movement acquisition device 120 may be interfaced with a detector 105, may be integrated into the detector 105 or may be interfaced with or comprised by any of the remote client device 100 or the crowdsourcing system server 200. Movement acquisition device 120 may be integrated with or comprised by any of the classifier 215 or recognizer 210.

Movement acquisition device 120 may comprise any functionality for extrapolating the gesture data 10 from the video data stream output and for forming frames 20. Movement acquisition device 120 may use gesture data 10 extrapolated from a particular image of a digital camera or a digital video camera and form or create a frame 20 comprising a collection of gesture data 10. In some embodiments, movement acquisition device 120 receives a video of a movement of a person and from the received data extracts the gesture data 10. Further, movement acquisition device 120 extracts from the received data one or more frames 20 depicting or identifying the particular body movement. Movement acquisition device 120 may comprise the functionality for storing the gesture data 10 and/or frames 20 into the storage 125 or into the database 220. As the movement acquisition device 120 may exist on the remote client device 100 or the server 200, the gesture data 10 and/or frames 20 extrapolated or created by the movement acquisition device 120 may be transmitted over the network 99 to and from the client device 100 and the server 200.

Crowdsourcing system communicator 115 may comprise any hardware, software or a combination of hardware and software for enabling and/or implementing the communication between the remote client device 110 and the crowdsourcing system server 200. Crowdsourcing system communicator 115 may include a network interface 25 and/or any functionality of a network interface 25. Crowdsourcing system communicator 115 may comprise functionality to establish connections and/or sessions for communication between the devices 110 and server 200. Crowdsourcing system communicator 115 may include the functionality to utilize a security protocol for transmitting protected information. Crowdsourcing system communicators 115 may establish network connections between devices 100 and the server 200 and exchange the gesture data 10 and/or frames 20 over the established connections. Crowdsourcing system communicator 115 may include the functionality for transmitting detector 105 data, such as the video stream data or detector output data across the network 99. Crowdsourcing system communicator 115 may include any functionality to enable the functions and processes described herein to perform the functions described.

In addition to the aforementioned features, storage 125 may include any hardware, software or a combination of hardware and software for storing, writing, reading and/or modifying gesture data 10 and/or frames 20. Storage 125 may comprise any functionality for sorting and/or processing gesture data 10 and frames 20. Storage 125 may comprise the functionality for interacting with a movement acquisition device 120, a recognizer 210 and/or a classifier 215 to allow each of these components to process the data stored in the storage 125.

Gesture data 10 may be any type and form of data or information identifying or describing one or more features of a movement of person. One or more features of a movement of a person may include a position or a location of a human body or a portion of a human body. The features of the movement, such as the position or location of a particular body part may be expressed in terms of coordinates. The features of the movement may also be expressed with respect to particular specific reference point. For example, gesture data 10 may describe or identify a position or a location of a particular body part of a subject with respect to a reference point, wherein the reference point may be a specific body part of the same subject. In some embodiments, gesture data 10 comprises data or information identifying or describing a movement of a human body or a portion of a human body. Gesture data 10 may comprise information about a location of a particular point of a human body with respect to a reference point. In some embodiments, gesture data 10 identifies a distance between a particular point of the human body and a reference point, the reference point being a point on the body of the subject recorded. Gesture data 10 may comprise any one of, or any combination of: scalar numbers, vectors, functions describing positions in X, Y and/or Z coordinates or polar coordinates.

Detector 105 may record or detect frames identifying self-referenced gesture data in any number of dimensions. In some embodiments, gesture data is represented in a frame in a two dimensional format. In some embodiments, gesture data is represented in a three dimensional format. In some instances, gesture data includes vectors in x and y coordinate system. In other embodiments, gesture data includes vectors in x, y and z coordinate system. Gesture data may be represented in polar coordinates or spherical coordinates or any other type and form of mathematical representation. Gesture data may be represented as a distance between a reference point and each particular feature represented in the frame in terms of sets of vectors or distances represented in terms of any combination of x, y and/or z coordinates. Gesture data 10 may be normalized such that each gesture data 10 point is ranged between 0 and 1.

Gesture data 10 may include a function that describes a location or a position of a particular point of the human body with respect to a waist of the same human body. For example, gesture data 10 may include information identifying a location or a distance between a fingertip of a hand of a person and a reference point. In some embodiments, gesture data 10 includes information identifying a location or a distance between a hip of a person and a reference point. In certain embodiments, gesture data 10 includes information identifying a location or a distance between an elbow of a person and a reference point. In some embodiments, gesture data 10 includes information identifying a location or a distance between a palm of a person and a reference point. In further embodiments, gesture data 10 includes information identifying a location or a distance between a finger of a person and a reference point. In some embodiments, gesture data 10 includes information identifying a location or a distance between a knee of a person and a reference point. In some embodiments, gesture data 10 includes information identifying a location or a distance between a heel of a person and a reference point. In certain embodiments, gesture data 10 includes information identifying a location or a distance between a toe of a person and a reference point. In some embodiments, gesture data 10 includes information identifying a location or a distance between a head of a person and a reference point. In further embodiments, gesture data 10 includes information identifying a location or a distance between a neck of a person and a reference point. In some embodiments, gesture data 10 includes information identifying a location or a distance between a pelvis of a person and a reference point. In certain embodiments, gesture data 10 includes information identifying a location or a distance between a belly of a person and a reference point.

A frame 20 may comprise any collection or compilation of one or more gesture data 10 points from a single image, single digital video frame or from data detected or collected by the detector 105 in a single instance. Frame 20 may comprise a file containing numbers and values that identify the gesture data 10 values. A frame 20 may include a compilation of information identifying one or more locations of body parts of the subject with respect to a reference point. A frame 20 may include a location or a distance between a head of a person and a reference point and the information identifying a location or a distance between a heel of the person and the same reference point. Frame 20 may include any number of entries and any combination of entries of any one of or combination of parts of human body measured, identified or detected with respect to the reference point. In some embodiments, a single frame 20 includes data about each of: a shoulder, a left hip, a right hip, a left elbow, a right elbow, a left palm, a right palm, fingers on the left hand, fingers on the right hand, a left knee, a right knee, a left heel, a right heel, a left toe, a right toe, the head, the neck, the pelvis and the belly. Any combination of or compilation of these data points may be described in terms of their distance or reference from the same reference point. In some embodiments, the reference point is the waist of the person. In further embodiments, the reference point is the center frontal waist point. In other embodiments, the reference point is the rear frontal waist point. However, the reference point may also be any other part of the human body, depending on the system design. The frame 20 may therefore include any number of separate gesture data 10 points. In some embodiments, only a left heel, the head and the right knee may be used for a frame 20 to describe a particular movement of a person, whereas in a separate embodiment a right shoulder, a left hip, the right heel and the left toe may be sufficient to accurately describe another movement of the human body. Depending on the decisions made by the classifier 215, frames 20 for identifying different movements may include different gesture data 10 points. Similarly, for some movements only a single frame 20 may be sufficient, while for other movements two or more frames 20 may be used to classify or identify the movement.

Classifier 215 may comprise any algorithms, programs, logic circuits or functions for learning or differentiating some movements of the human body from other movements of the human body based on the gesture data 10 and/or frames 20. Classifier 215 may comprise the functionality for receiving output data from a detector 105 and extrapolate relevant information for identifying a movement. For example, classifier 215 may comprise the means to extrapolate gesture data 10 and/or frames 20 in a manner in which they can be used to be analyzed and compared with other gesture data 10 and frames 20. Classifier 215 may include hardware, software or a combination of hardware and software for analyzing and classifying gesture data 10 and/or frames 20. Classifier may include movement acquisition device 120 or any embodiment of the movement acquisition device 120. Classifier 215 may comprise the functionality to analyze, study and interpret information in the gesture data 10 and differentiate between the information in a gesture data 10 point involving a first body movement from the information in the gesture data 10 point involving a second body movement. Classifier 215 may comprise the logic and/or functionality to identify differences between the gesture data 10 involving separate body movements. Classifier 215 may comprise the logic and/or functionality for differentiating or distinguishing between two separate body movements based on the differences in gesture data 10 in one frame 20 from the gesture data 10 in another frame 20.

Classifier 215 may develop, create and store instruction files or algorithms that can be used to distinguish a first body movement from a second body movement. The distinguishing may be accomplished later by a recognizer 210 based on the differences between gesture data 10 in one frame 20 corresponding to the first movement from the gesture data 10 in another frame 20 corresponding to the second movement. Classifier 215 may search through the frames 20 and/or gesture data 10 corresponding to a first movement and compare the frames 20 and/or gesture data 10 of the first movement with the frames 20 and/or gesture data of a second movement distinct from the first movement. Classifier 215 may identify specific gesture data 10 with each of the frames 20 which are most relevant in differentiating between the first movement and the second movement. Classifier 215 may select the most relevant frames 20 of a particular movement for differentiating most accurately this particular movement from all the other frames 20 associated with other movements. The one or more frames 20 identifying a movement that classifier 215 identifies as the most suitable one or more frames 20 for identifying the given movement may be provided to the recognizer in association with the movement so that the recognizer 210 may use these one or more frames 20 for identifying the same movement in the future.

Recognizer 210 may comprise any hardware, software or a combination of hardware and software for identifying or differentiating a body movement of a person. Recognizer 210 may include algorithms, programs, logic circuits or functions for using the gesture data 10 and/or frames 20 classified or processed by the classifier 215 to identify a particular movement of the person. In some embodiments, recognizer 210 utilizes a file, a function or a logical unit created or developed by the classifier 215 to identify a particular movement from other movements.

Recognizer 210 may include any functionality for receiving and reading incoming video stream data or any other type and form of output from a detector 105. Recognizer 210 may further include any functionality for analyzing and/or interpreting the incoming data from the detector 105 and identifying and extrapolating the gesture data 10 from the detector 105 output data. Recognizer 210 may further include any functionality for comparing the gesture data 10 or frame 20 from the data received from the detector 105 and identifying a movement of a person based on the comparison of the freshly received gesture data 10 from the detector and the gesture data 10 and/or frames 20 classified by the classifier 215 previously.

Recognizer 210 may include the functionality for interacting with detector 105 in a manner to receive the data from the detector 105, extrapolate any gesture data 10 and process the gesture data into frames 20, and compare the extrapolated gesture data 10 and/or frames 20 to gesture data and/or frames 20 stored in database 220. Frames 20 stored in the database 220 may include the gesture data 10 that was processed and analyzed by the classifier 215 previously. Frames 20 classified by the classifier 215 may be used by the recognizer 210 to recognize that the frame 20 extrapolated from the data from the detector 105 matches a stored frame 20 associated with a particular movement of a person.

Database 220 may comprise any type and form of database for sorting, organizing and storing gesture data 10 and/or frames 20. Database 220 may include a storage 125 and any functionality of a storage 125. Database 220 may further include any functions or algorithms for organizing or sorting the gesture data 10 into frames 20. Database 220 may further include the functionality for creating frames 20 from one or more gesture data 10 points for a particular movement. Database 220 may include the functionality for interacting with classifier 215, recognizer 215, detector 105 and crowdsourcing system communicator 115. Database 220 may include the functionality to share the data stored in the database 220 with the system server 220 or any remote client device 100, depending on the arrangement and configuration.

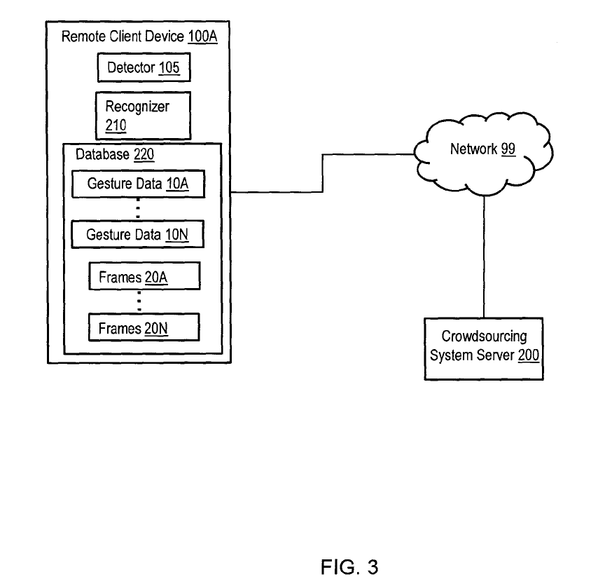

Referring now to FIG. 3, another embodiment of a system for identifying a movement of a subject based on crowd sourcing data is displayed. FIG. 3 illustrates a system in which in addition to the components that remote client devices 100 may include in FIG. 2, a remote client device 100 may also include the recognizer 210 and database 220. In this embodiment, the remote client device 100A has the functionality to recognize and/or identify body movements recorded or detected via detector 105. For example, remote client 100 may use a detector 105, such as a digital camera for instance, to record a person moving. Recognizer 210 of the remote client device 100 may, alone or in cooperation with movement acquisition device 120, extrapolate one or more frames 20 that include gesture data 10.

Recognizer 210 may then compare the extrapolated one or more frames 20 against frames 20 stored in database 220. In embodiments in which remote client device 100 does not include the entire database 220, remote client device may transmit the extrapolated frame 20 over the network 99 to the server 200 to have the recognizer 210 at server 200 identify a match corresponding to a frame of database 220 corresponding to a particular movement. In other embodiments, database 220 of the client device 100 may be synchronized with database 220 of the server 200 to enable the client device 100 to identify movements of the subject recorded or detected via detector 105 independently and without the interaction with the server 200.

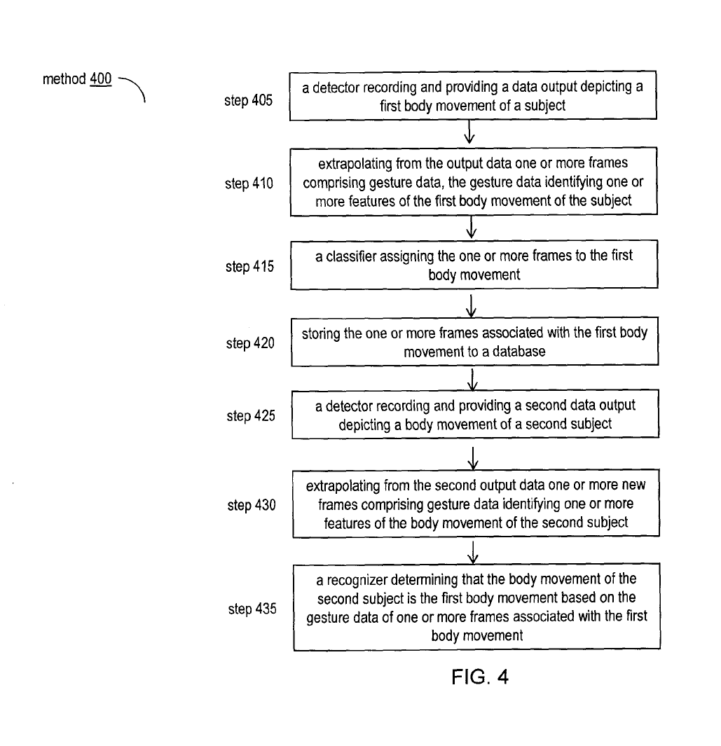

Referring now to FIG. 4, an embodiment of a method of steps of identifying a movement of a subject based on data is illustrated. In brief overview, at step 405, a detector 105 records or provides a data output depicting a first body movement of a subject. At step 410, a component of the system extrapolates from the output data one or more frames comprising gesture data, the gesture data identifying one or more features of the first body movement of the subject. At step 415, a classifier of the system assigns the one or more frames to the first body movement. At step 420, one or more frames are stored with the first body movement to a database. At step 425, a detector records a second data output depicting a body movement of a second subject. At step 430, a component of the system extrapolates from the second output data one or more new frames comprising gesture data identifying one or more features of the body movement of the second subject. At step 435, a recognizer of the system determines that the body movement of the second subject is the first body movement based on the gesture data of one or more frames associated with the first body movement.

In further detail, at step 405 a detector 105 records a movement of a subject and provides a data output depicting or describing the first body movement of the subject. Detector 105 may be a detector 105 of any of the remote client devices 100 or the detector 105 of the server 200. In certain embodiments, client devices 100 transmit the data output from their detectors 105 to the server 200. A detector may comprise a digital video camera recording movements of a person in a series of digital images or digital frames. Detector may record and provide a digital video stream. In some embodiments, the detector records data that identifies movements of the person using coordinates and values. In further embodiments, the detector records positions of particular body points of the subject with respect to a reference point. The reference point may be a designated point on the subject's body. In some embodiments, the detector provides the raw images, such as for example digital images to the system. In other embodiments, the detector extrapolates the relevant gesture data from the images and provides the extrapolated gesture data from each frame to the system. Depending on the system design and preferences, the detector may provide the frames of digital images or frames of extrapolated gesture data to the system for further processing.

Detector 105 may be a camera, such as a Microsoft Kinect Camera which may record frames of self-referenced gesture data. Detector 105 may be a camera deployed on a football stadium, baseball stadium, soccer stadium, airport or any other crowded venue and may record the crowd passing by. Detector 105 may provide a stream of frames that may include self-referential gesture data of one or more subjects recorded in the frames. Self-referential gesture data may include gesture data identifying locations or positions of various body parts of a subject in reference to a body point of the subject itself.

In some embodiments, the detector records or detects a person throwing a ball. In some embodiments, the detector records or detects a person walking. In some embodiments, the detector records or detects a person running. In some embodiments, the detector records or detects a person attempting to strike someone or something. In some embodiments, the detector records or detects a person pulling, carrying or lifting an object. In some embodiments, the detector records or detects a person walking with an unusually nervous demeanor. In further embodiments, the detector records or detects a person yelling. Detector may record any movement or action a person may do in any given situation and under any set of circumstances.

At step 410, one or more frames comprising gesture data describing the movement of the subject are extrapolated from the output data provided by the detector. Depending on the system design, any one of a detector 105, a movement acquisition device 120 or classifier 215 may perform this task. In some embodiments, Microsoft Kinect Camera records the subject and comprises the functionality, such as the movement acquisition device 120 functionality within itself, to extrapolate the gesture data from the frames. The gesture data from the extrapolated one or more frames may identify one or more features of the first body movement of the subject. In some embodiments, a feature of the gesture data identifies a position or a location of a left and/or right shoulder of the subject. In further embodiments, the feature identifies a position or a location of a left and/or right hip of the subject. In further embodiments, the feature identifies a position or a location of a left and/or right elbow of the subject. In further embodiments, the feature identifies a position or a location of a left and/or right palm of the subject's hand. In further embodiments, the feature identifies a position or a location of the fingers on the left and/or right hand of the subject. In some embodiments, the location may be one of the set of fingers, whereas in other embodiments a location of each of the fingers may be individually identified. In further embodiments, the feature identifies a position or a location of a left and/or right knee of the subject. In further embodiments, the feature identifies a position or a location of a left and/or right heel of the subject. In further embodiments, the feature identifies a position or a location of the toes on left and/or right leg of the subject. In further embodiments, the feature identifies a position or a location of a head of the subject. In further embodiments, the feature identifies a position or a location of a neck of the subject. In further embodiments, the feature identifies a position or a location of the pelvis of the subject. In further embodiments, the feature identifies a position or a location of the belly of the subject. In further embodiments, the feature identifies a position or a location of the waist of the subject.

Each of the features of the gesture data 10 identified may be self-referenced, such as to identify the location or the position of the subject identified with respect to a particular reference point within the frame. In some embodiments, the features are identified with respect to the position or location of the waist of the person. In other embodiments, the features are identified with position or location of the left shoulder or the right shoulder of the person. In yet other embodiments, the features are identified with position or location of the left hip or the right hip of the person. In yet other embodiments, the features are identified with position or location of any of the left or right palms of the person. In yet other embodiments, the features are identified with position or location of any of the fingers of the person on either of the hands. In yet other embodiments, the features are identified with position or location of any of the knees of the person on either of the legs. In yet other embodiments, the features are identified with position or location of any of the heels of the person on either of the legs. In yet other embodiments, the features are identified with position or location of any of the toes of the person. In yet other embodiments, the features are identified with position or location of the head of the person. In yet other embodiments, the features are identified with position or location of the neck of the person. In yet other embodiments, the features are identified with position or location of the pelvis of the hips of the person. In yet other embodiments, the features are identified with position or location of the belly of the person. In still further embodiments, the features are identified with the position of the chest of the person.

Still in connection with step 415, extrapolation of the one or more frames may comprise storing, formatting or organizing gesture data 10 into frames 20. In some embodiments, frames 20 are created by compiling gesture data 10 into files. In further embodiments, extrapolation of the one or more frames includes creating frames 20 from each digital image frame, where the frame 20 comprises gesture data 10 collected from the digital image frame. In further embodiments, frame 20 includes a file of gesture data 10, wherein the gesture data 10 entries comprise numbers and values identifying the location of each of the given body parts with respect to a predetermined reference point.

At step 415, a classifier 215 processes the one or more frames and assigns the one or more frames to a particular body movement. The classifier 215 may use any learning functionality and/or algorithm described herein to process the one or more frames, learn the movement, identify the features of the gesture data of the frames corresponding to the movement that identify the movement from any other movements and assign the frames and/or gesture data to the distinguished movement.

In some embodiments, the classifier determines that the one or more frames identifies a movement that was never identified before. The classifier may assign the one or more frames with the new movement, thereby adding this new movement to the database. In some embodiments, the classifier determines that the same or a substantially similar movement is already identified and stored in the database 220. If the classifier identifies that the same or similar movement is already represented, the classifier may modify the one or more frames stored with some gesture data from the new frames which may be more suitable and more accurately represent the movement. In some embodiments, classifiers assigns one or more assembled frames comprising gesture data that identifies the particular movement to the particular movement by associating the one or more frames with the movement in the database.

At step 420, the database 220 stores the one or more frames associated with the particular body movement in association with the particular body movement. In some embodiments, database 220 marks the one or more frames to identify the particular body movement. In some embodiments, database 220 sorts the frames 20 stored in accordance with the movements they identify. In further embodiments, database 220 comprises a set of name-value pairs, wherein the frames are assigned particular values corresponding to the particular movement. In further embodiments, the database stores a single frame in association with the particular movement. In yet further embodiments, the database stores two, three, four, five, six, seven, eight, nine or ten frames in association with the particular movement. In yet further embodiments, the database stores any number of frames in association with the particular movement, such as for example hundreds of frames. In still further embodiments, database 220 may store one or more frames that are modified by the classifier in view of the new gesture data the classifier determines that should be included in the existing stored frames associated with the particular movement.

At step 425, a detector records and provides a second data output depicting a body movement of a second subject. In some embodiments, the detector is a detector of a remote client 100. In other embodiments, the detector is a detector of the server 200. A detector may comprise a digital video camera recording movements of a person in a series of digital images or digital frames. Detector may record and provide a digital video stream. In some embodiments, the detector provides the data output to a recognizer 210. In other embodiments, the detector provides the data output to a movement acquisition device 120. Detector may record or detect any movement such as the movements described at step 405.

At step 430, one or more new frames from the second output data comprising the new gesture data identifying a movement of a second subject are extrapolated from the second output data. In addition to all the steps performed at step 410, at step 430 any one of a movement acquisition device 120 or a recognizer 210 may perform the extrapolating. As with the embodiments described at step 410, the new gesture data from the extrapolated one or more new frames may identify one or more features of new body movement of the second subject. The new body movement of the second subject may include any one or more of the embodiments or features of the first movement at step 410. In some embodiments, the new movement is the same as the first movement. In other instances, the new movement is a different movement from the first movement at step 410. As with the features of the gesture data at step 410, the new gesture data may identify the locations or positions of any of the person's shoulders, hips, elbows, palms, fingers, knees, heels, toes, head, neck, pelvis, belly, chest and/or waist. Also as with the gesture data at step 410, the new gesture data of the new one or more frames may be identified with respect to a reference point, such as any of the person's shoulders, hips, elbows, palms, fingers, knees, heels, toes, head, neck, pelvis, belly, chest and/or waist. The new one or more frames may be extrapolated from one or more digital images or digital frames of a digital video camera recording the movement.

At step 435, a recognizer of the system determines that the body movement of the second subject is the particular first body movement previously classified by the classifier 215 at step 415 and stored in the database at step 420. In some embodiments, the recognizer determines that the body movement of the second subject is the same or substantially similar to the first body movement. In further embodiments, the recognizer makes the determination based on determining that the gesture data from one or more new frames of the second movement is the same or substantially similar to the gesture data of the first movement stored in the database. In some embodiments, the recognizer determines that one or more of the features of the new gesture data of the one or more new frames matches the one or more features of the gesture data of the first movement stored in the database to within a particular threshold. In some embodiments, the features of the new gesture data matches the features of the gesture data of the stored first body movement to within the threshold of plus or minus a particular percentage of the values identifying the feature. For example, the features of the new gesture data may match the features of the gesture data stored in the database to within any error range of between 0 and 99%. For example, the feature of the new gesture data may match the features of the gesture data stored in the database to within 0.1%, 0.2%, 0.5%, 0.8%, 1%, 1.5%, 2%, 2.5%, 4%, 5%, 6%, 7%, 8%, 9%, 10%, 12%, 14%, 16%, 20%, 25%, 30%, 40% or 50%. The threshold may computed by comparing all of the values of the gesture data frame. The threshold may also be computed by on a per data point basis, such as for example the right foot matches within 0.1%, right ankle matches within 3.1%, left knee matches within 2.8%. The threshold may be a single threshold for each joint for all values, or the threshold may vary for each joint data point of each gesture. In some embodiments, the threshold to within which the match is identified is the same for all features of the gesture data. In other embodiments, the threshold to within which the match is identified is different for different features of the gesture data.

Still in connection with step 435, in one example, a match between the new one or more frames of the second subject's movement and the one or more frames stored in the database is identified based on the determining that between the two sets of frames, the locations of the fingers, heels, knees and elbows matches within 2.5%. In another example, a match between the new one or more frames of the second subject's movement and the one or more frames stored in the database is identified based on determining that between two sets of frames, the locations of the head, hips and heels match within 1% and palms, elbows and knees are matching within 3.8%. In some embodiments, in response to determining that a match between the gesture data of the two one or more frames is found, the recognizer determines that the body movement of the second subject is the first body. The recognizer thereby recognizes the movement of the second subject based on the data stored in the database.

In some aspects, the present disclosure is to a set of particular detailed embodiments that may be combined with any other aforementioned embodiments to create the systems and methods disclosed herein. In one aspect, the disclosure addresses a number of possible implementations that may be impacted by realistic limitations of global bandwidth, complexity and diverseness of the mannerisms of the human gesture condition.

The system of the present invention may utilize for example the Microsoft Kinect camera developed by PrimeSense. In some examples in operation 20 complex gestures may be trained, programmed to the system and recognized by the system at a mean of 98.58%, based on 607220 samples. The Kinect comes in two different versions, namely the XBOX360 version and the Windows version.

Gestures may be viewed as an important aspect of body language and may be used every day in communications between people. For many people, it may be difficult to avoid making some kind of gesture when communicating face to face with another person. Gestures can convey messages easily and seemingly wordlessly. They can also indicate behaviour that human may otherwise want to obfuscate. Being able to consistently and rapidly assess and perform gestures may form the basis of many forms of entertainment, including games that can be either cooperative or competitive in nature. Gestures can represent a variety of different things, from abstract ideas and emotions to representations of more concrete things such as intentions, people, places or things. Finding a way to differentiate between these forms of communication accurately using a detection based system has been rather difficult in the past.

Machines may have the potential to successfully classify a gesture quicker and more efficiently than a human being through a process, such as a machine learning. In a process such as the machine learning, a machine is taught a way to recognize gestures. The potential for machine-based intelligence to categorize and detect different types of gestures may be used to expand the worlds of electronic communication, interactive entertainment, and security systems.

The use of machine learning also allows improvements in accuracy of recognition of gestures that are consistent, but may not necessarily be identical. Machine learning allows the accurate recognition of corresponding gestures in part by processing a larger set of associated gestures, for example from a plurality of individuals, collected from a plurality of devices. A crowd based system that utilizes machine learning can provide improved accuracy, and without training of the system for a particular individual. For a motion monitoring system, where there is a need to monitor the motions of a human for whom a gesture profile may not yet have been acquired, the present invention provides an effective means of deploying accurate motion monitoring, using gesture recognition.

More particularly the present invention provides specific mechanisms for deriving, processing and storing gesture data that enables application of machine processing using machine learning. Furthermore, the present invention provides a system architecture that enables real time or near real time motion monitoring, using a crowd based system. The present invention provides an improved motion monitoring system in that corresponding movements are recognized accurately (as reflecting for example the same behaviour or intent) despite variability from instance to instance or human to human as to how the particular movement is expressed, or based on differences in the anatomy from one human to another human, or differences in the vantage point provided by one camera to another camera, or differences in the positioning relative to one or more cameras of one human versus another human.

What actually may define a gesture, and what that gesture may mean may be very subjective. Gestures may include any sequence of movements of a human body as well as physical configurations or positions of the human body at a particular time. In some instances, gestures include a particular position of a human body at a particular instant or a specific point in time. Multitude of such particular positions through time may make up a sequence of movements. Specifically, the orientation or position of one or more body parts of a human body at a particular time as well as the movement of certain body parts—or joints—of the human body through time may define a gesture.

From retrieved data about the positioning and movement of the joints during gestures acted out by people, it is possible to use artificially intelligent means to learn from this information, in order to predict consecutive frames of a gesture and interpret what future gestures could possibly represent. Use of artificial intelligence for prediction enables for example the correct recognition of movements using gestures without having full information, for example because a human being monitored is obscured momentarily from view (for example by another human blocking a camera's view of the person being monitored).

The idea that the process of gesture recognition can be performed by machines not only offers the convenience of automation and speed, but also opens up the potential for artificial systems to participate in gesture-based communication and entertainment. Towards this goal, some form of artificial intelligence is required to know about what categories of gestures exist and go about predicting them from contextual (e.g. visual) cues observed from human performers.

Being able to quickly and concisely interpret and perform gestures in many cases can be made into a social and co-operative (or competitive) game. In one such game, players engage in a gesture-based game by either attempting to perform gestures or recognizing which gestures are being performed by others; attempting to maximize their accuracy in both tasks. From collected information about the position and orientation of joints during gestures performed by humans, it is possible to employ artificial intelligent systems to learn from this data and make predictions about future, unseen joint information and the type of gesture that it most likely represents. Using such games in which multitude of players act out different body movements, gesture data may be generated and transmitted to the back end crowdsourcing server to be processed by classifiers and to be used for quick and efficient population and refinement of the database of gesture movements.

In one aspect of the invention, machine-learning techniques involving classification are used.

The original research problem was to begin the testing of a dynamic gesture recognition system that could understand complex hand gestures. Originally for our goal, many technical hurdles presented themselves: 1) Choose an approach for the segmentation of hand gestures. 2) Come up with a descriptor to pass on the segmented data effectively to an intelligent system for classification. 3) Once classified, a recognition system, whether real-time or beyond real-time, needs to shows signs of measurable recognition by way of an intelligent system.

One of the challenges in this research has been that comparing results with that of other researchers in the field is very difficult due to the unrepeatability of similar test conditions, arising from the diversity in acquisitioning hardware and environmental conditions. Enter Microsoft Kinect Camera that is currently the fastest selling consumer electronics device and boasts an RGB camera, IR depth camera, and onboard segmentation. This camera may be an embodiment of our detector.

We may build gesture prediction models based on several different classification algorithms. This process may begin first with gathering examples of gestures for the purposes of training each classifier. This data set may be referred to as training data, and may include gesture data in the form of joints as captured and recorded by a specialized stereoscopic camera (the Kinect device). This data may then be aggregated and transformed for optimal classification, before the classifier model is built and finally tested on a subset of the data collected.

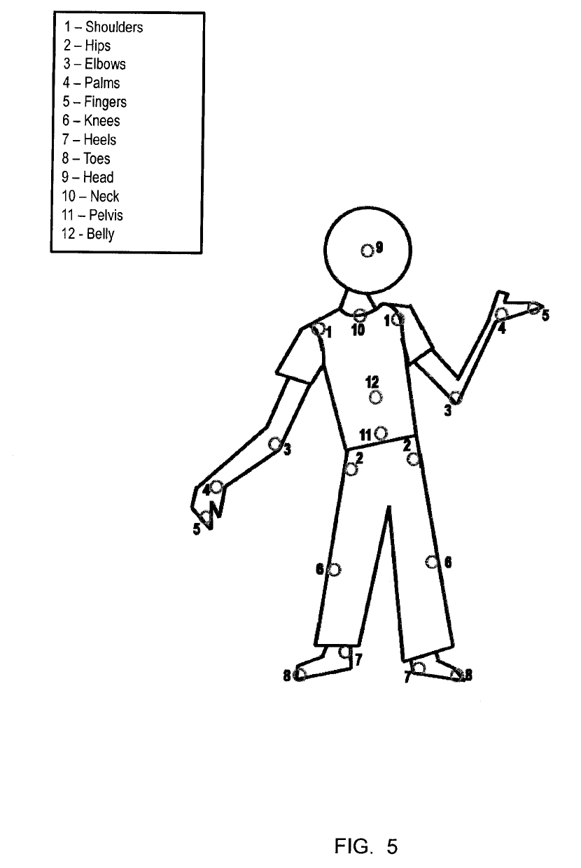

Referring now to FIG. 5, an illustration of a subject or a user with two arms, two legs and a head is illustrated. FIG. 5 comprises circles of body points which are to be tracked or monitored. For the purpose of our experimentation, a Microsoft Kinect SDK Beta1, 1.1 and 1.2 may be used in an XNA 4.0 environment. The original skeleton algorithm may be used as a starting point. The data presented later may not be conditional on the Kinect hardware; all algorithms described may be applicable to any camera or any other type and form of a detector. The camera may include a segmentation algorithm that approximates a skeleton within a body (human or animal), be it the whole body, or something more detailed, like the hands of the human body, a tail of a dog, and similar body parts of a person or an animal. In some embodiments, such capability may be removed from the camera and be included in other components of the system described earlier.

In one embodiment, presented is a hierarchical 3D shape skeleton modeling technique which is very promising for learning skeletons of many 3D objects, including people, hands, horses, octopoda and planes. Being piecewise geodesic, the segment borders are smooth and non-twisting.” A similar outcome may be achieved in a different embodiment in which the method is based on a curved skeleton representing the object's interior, which produces both a surface segmentation and a corresponding volumetric segmentation. FIG. 5 illustrates an approximation of the body shape of a single user. The Kinect camera may be designed to segment a user like this without the need for any type of calibration gesture.

The approach used in another embodiment may use the process as pose recognition, which may utilize only a single frame depth image. The technique of such an embodiment may be as follows: First, a deep randomized decision forest classifier is trained to avoid over-fitting by using hundreds of thousands of training images. Second, discriminative depth comparison image features yield the 3D translation invariance. Third, spatial modes of the inferred per-pixel distributions are computed using mean shift. The outcome is the 3D joint points. The mean shift is for feature space analysis, based on a multivariate kernel density estimator.

The stock Kinect camera may natively sample at 30 fps but can be modified to operate at 60 fps or any other rate. In one embodiment, the full segmentation can operate at 200 fps. In a further embodiment, a technique may be used to recognize gesture data at up to 600 fps. In further embodiments, an approach may be used which prioritizes accuracy of complex gestures, speed of recognition, and compression requirements. The supplemental data may begin with the assignment of 15 varied base characters, though this technique may add associations. In a further embodiment, our starting point may be first to sample in an invariant approach by beginning with a simple constant, the waist. All joints of the subject may be calculated as special references from this point. The position of each joint may be normalized to minimize variance in a user's size and/or reduce error.

In some embodiments when attempting to recognize complex gestures, descriptors, including motion descriptors, and shape descriptors like Extended Gaussian Images, Shape Histograms, D2 Shape Distributions, and Harmonics may be used. In one embodiment, a harmonic shape descriptor starting from the center mass may be used. In other embodiments, an elevation descriptor by taking the difference between the altitude sums of two successive concentric circles of a 3D shape may be used.

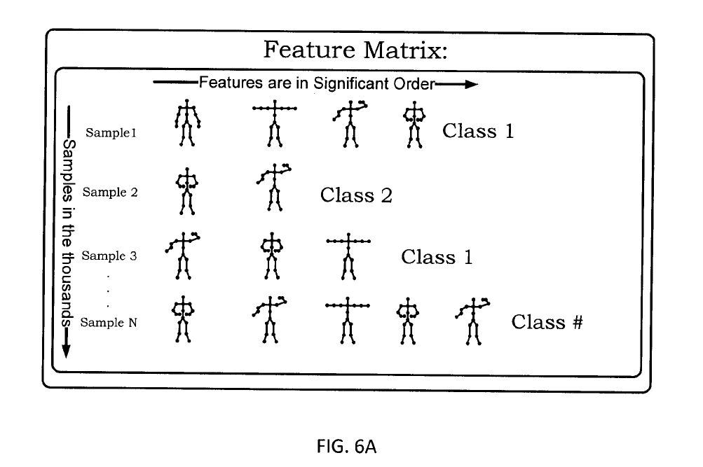

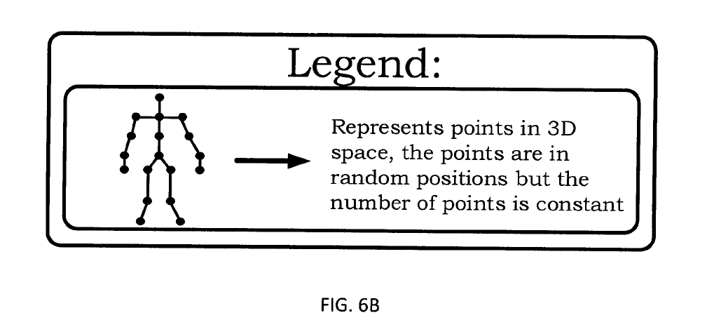

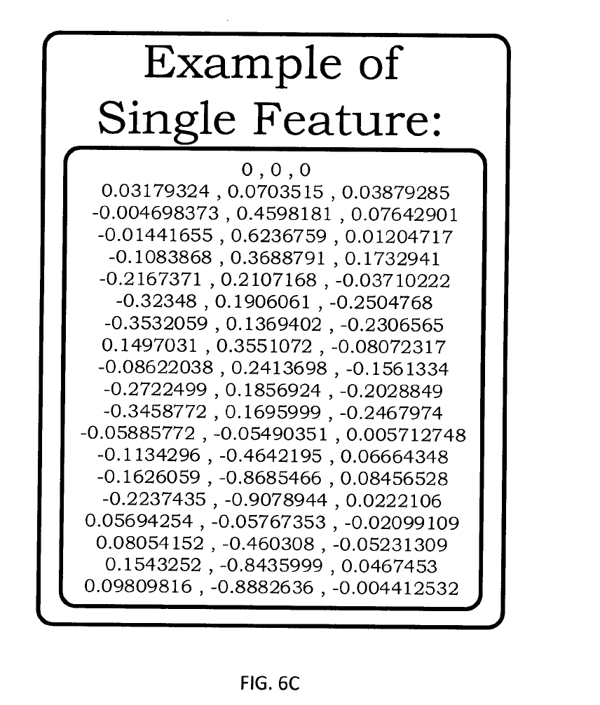

Referring now to FIGS. 6A, 6B and 6C, an embodiment of a system and system data is illustrated. In brief overview, FIG. 6A illustrates locations of body components with respect to a reference point for various different classes of movements. This is the point at which the space for the gesture data may be defined. In some embodiments, an assumption may be made that joint values are a constant in the learning process. Joint values can be any number of joints that is predefined before being handed to the learning/classification portion. There may be any number of gesture samples and any number of gesture classes. Gesture samples may vary in length even within the same class. FIG. 6B illustrates a representation in 3D space corresponding to the embodiments illustrated in FIG. 6A. FIG. 6C illustrates data points of gesture data for various points of the human body in 3D.

A free public database that includes enough diversity between full body gestures or hand gestures that include pre-segmented data may not initially be available and may need to be built and populated with gesture data. Creation of a custom full body gesture database may be needed to carry on the research. A virtual version of the game Charades may be used to collect gesture data. Data may be collected via network 99 from hundreds or thousands of players operating devices 100 and playing this game worldwide. For the purposes of an experiment, a set of twenty gestures are selected mostly randomly out of a classic commercial version of Charades. The game may be formatted in a way that the length of a gesture is trimmed by way of supervised learning, meaning another user may be used to play the game. When the second user accurately guesses the gesture by vocally naming it (voice recognition was used), this signifies the end point of the gesture. Table 1, shown below alphabetically lists the 20 gestures used in the database for the purposes of testing the system. In some embodiments, it may the gestures may be open to interpretation. Of the 20 separate gestures (i.e. classes), for the purposes of the experiment, at least 50 full samples of each gesture may be sampled.

TABLE 1
Gesture data collected for training, testing, real-time recognition
and prediction

| | | |
|---|---|---|
| Air Guitar | Crying | Laughing |
| Archery | Driving | Monkey |
| Baseball | Elephant | Skip Rope |
| Boxing | GESTURES | Sleeping |
| Celebration | Fishing | Swimming |
| Chicken | Football | Titanic |
| Clapping | Heart Attack | Zombie |

The Kinect detector may sample user “gesture” information from the IR depth camera. The data coming from the camera may be oriented relative to its distance from the Kinect. This orientation may become problematic when searching for the solution to universal truths in gestures. A normalization technique may be developed and used that converts all depth and position data into vectors relative to a single joint presumed most neutral. The waistline of a subject, such as the subject in FIG. 5, may be selected as the reference point.

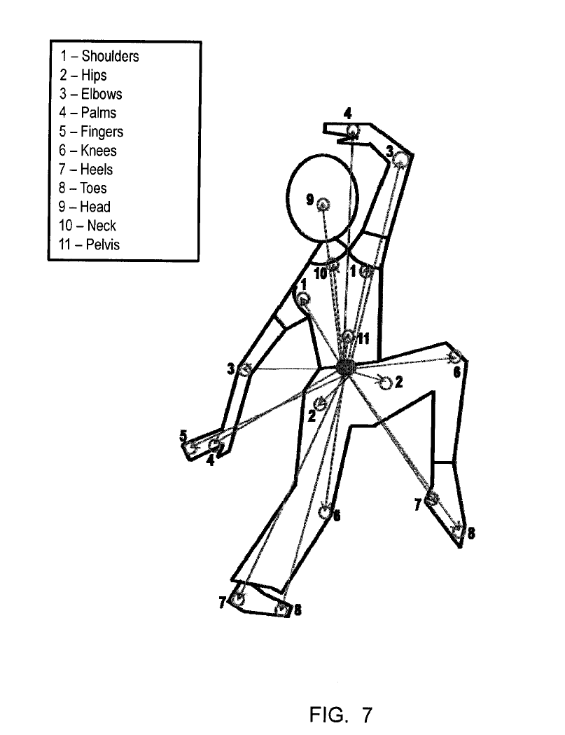

Referring now to FIG. 7, an illustration of a subject studied is illustrated. In brief overview, the subject's shoulders, hips, elbows, palms, fingers, knees, heels, toes, head, neck and pelvis are indicated with respect to the subject's waist. In this embodiment, the result includes positive and negative x, y, and z-axis values. Data scaling is later described and may be used to eliminate negative numbers. In some embodiments, data scaling is used to eliminate the negative numbers. Additionally, normalization is used to normalize all values to values between 0 and 1.

In some embodiments, the data needed to be sampled out of the Kinect is sampled through a middleware developed in-house. In some embodiments, a full gesture is made up of 1200 to 2000 frames. This may be viewed as oversampling. In some embodiments, an approach of eliminating redundant frames from the one or more frames (such as the 1200-2000 frames) is used in order to use a smaller number of frames. In some embodiments, it is safe to eliminate any redundant frames as the detector, such as the Kinect camera, data samples to the 8th decimal place on each joint. In such embodiments, it may be uncommon for the camera to sample two identical frames in a row as the circuit noise alone would prevent this from occurring. In some embodiments, the average temporal length of each gesture in the database is 200-300 frames.

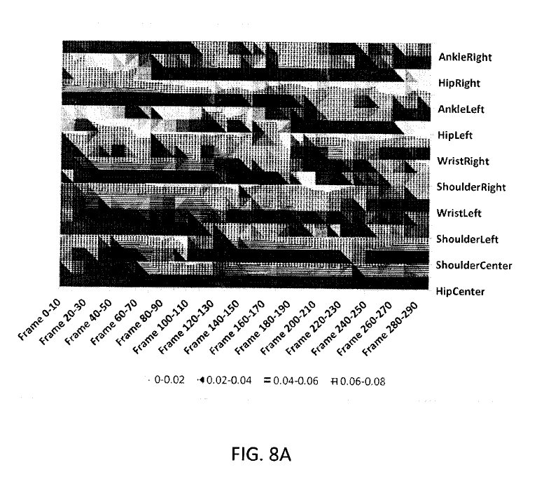

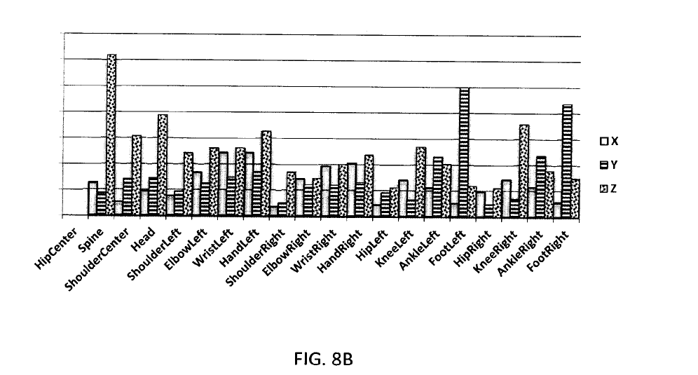

Referring now to FIG. 8A, an embodiment of an overhead view of a 3D plot of a single gesture's set of frames is illustrated depicting the frames changing through time. FIG. 8A therefore depicts features of gesture data, including: a right foot, a right ankle, a right knee, a right hip, a left foot, a left ankle, a left knee, a left hip, a right hand, a right wrist, a right elbow, a right shoulder, a left hand, a left wrist, a left elbow, a left shoulder, the head, the center shoulder, the spine and the hip center of the person. FIG. 8A illustrates these gesture data points moving through approximately 300 frames. As shown in FIG. 8A data is illustrated as moving through frames 0 through 290, such as for example in frames 0-10, 20-30, 40-50, 60-70, 80-90, 100-110, 120-130, 140-150, 160-170, 180-190, 200-210, 220-230, 240-250, 260-270 and 280-290. FIG. 8A may refer to each one of the frames between 0-290 or selections of frames between 0-290, leaving some frames out.

In reference to a dataset similar to the one depicted in FIG. 8A, for experimentation purposes, a matrix of size N rows and 60 columns of floating point numbers may be used as input. Output may include a column vector of integers denoting class ID. Each input column (each of the 60 features) may be scaled across all samples to lie in range. FIG. 8B illustrates a scaled plot of a series of frames depicting movements of the subject in FIG. 7 with normalized vectors. Data scaling may be applied to diversify the learning algorithm testing and improve gesture compression for transmission over the network. Data scaling of getting rid of negative values and/or normalizing values between 0-1 may enables the usage of a specialized compression technique for transmitting this particular type of data over the network 99, thereby enabling a more efficient communication and data exchange between the devices 100 and the server 200.

One of the equations that may be used for data scaling may be a normalization vector equation as follows:

$$\hat{u} = \frac{u}{‖ u ‖}$$

Learning and recognition may work in collaboration. Recognition systems may use several types of intelligent systems to recognize patterns between classes (in our case gesture classes). In one example, a Nintendo's Wii remote control may be used. The approach may involve using the handheld device's two 3D accelerometers to learn two different gestures moving through time (our experiments use 20 3D points.) In such an example, a Self-Organizing Map (SOM) may be used to divide the sample data into phases and a SVM to learn the transition conditions between nodes. In such an embodiment, the supervised system may score an accuracy of 100 percent for class one and 84 percent for class two. The unsupervised system may score an accuracy of 98 percent for class one and 80 percent for class two.

In another embodiment, the experiment may also involve the Wii but the gesture classes may be increased to 12 with 3360 samples. The user dependant experiments in such embodiments may score an accuracy of 99.38% for the 4 direction gestures and 95.21% for all the 12 gestures. The user independent version may score an accuracy of 98.93% for 4 gestures and 89.29% for 12 gestures.

In some embodiments, a gesture recognition approach for small samples sizes is used. For some experiments, a set of 900 image sequences of 9 gesture classes may be used. Each class may include 100 image sequences. In some embodiments, more classes and less complete samples may be utilized. A Scale-Invariant-Feature-Transform (SIFT) may be used as a descriptor while a scalar vector machine (SVM) may be used for the learning. Multiple other approaches may be shown and accuracy may be 85 percent out of 9 separate experiments.

In some embodiments, an SVM Radial Basis Function classifier is used as the classifier of the system. The Radial Basis Function (RBF) SVM classifier may be non-linear and the corresponding feature space may be referred to as a Hilbert space of infinite dimensions defined as:

k(xᵢ,xⱼ)=exp(−γ∥xᵢ−xⱼ∥²) for γ>0 Equ.2

### Equation 1 Gaussian Radial Basis Function

The RBF Kernel, grid search for parameters may include:
A. Cost controls which may have the trade-off between allowing training errors and forcing rigid margins. Cost may vary between 0.1 and 7812.5, scaling by 5 each time. There may be a soft margin that may permit some misclassifications. Increasing the Cost may increase the cost of misclassifying points and may force the creation of a more accurate model that may not generalize well.
B. Gamma may be varied between 1e-5 to 113, scaling by 15 each time. The gamma parameter may determine the RBF width.

In one embodiment, a prediction may be obtained for Cost value of anywhere between 200 and 500, such as about 312.5 and Gamma value of about anywhere between 0.2 and 0.8, such as about 0.50625.
Table 2, illustrated below, presents a performance table of an embodiment of the present disclosure using the RBF.

TABLE 2
RBF Kernel performance Table for Gamma and Cost

| Gamma/ | | | | | | | | |
|---|---|---|---|---|---|---|---|---|
| Cost | 0.1 | 0.5 | 2.5 | 12.5 | 62.5 | 312.5 | 1562.5 | 7812.5 |
| 0.00001 | 11.9088 | 11.0895 | 11.0895 | 11.0895 | 11.0895 | 28.017 | 65.6136 | 83.3715 |
| 0.00015 | 11.9088 | 11.0895 | 11.0895 | 11.9163 | 48.0545 | 80.878 | 89.702 | 93.8928 |
| 0.00225 | 11.9088 | 11.0895 | 37.1109 | 72.714 | 88.26 | 93.2538 | 95.5032 | 96.3559 |
| 0.03375 | 29.7226 | 67.0234 | 85.2106 | 92.8481 | 96.1389 | 96.9349 | 96.808 | 96.7915 |
| 0.50625 | 83.73 | 93.0102 | 96.5956 | 98.0217 | 98.3722 | 98.1005 | 97.8376 | 97.8376 |
| 7.59375 | 73.5057 | 92.8436 | 95.8249 | 95.921 | 95.9305 | 95.8808 | 95.8312 | 95.8312 |
| 113.90625 | 11.3813 | 19.893 | 40.9047 | 40.9047 | 40.9047 | 39.7976 | 38.6905 | 38.6905 |

In some embodiments, the SMV Poly setting may be used. The Poly or Polynomial SVM classifier may be a non-linear and a hyperplane in the high-dimensional feature space, which may be defined as:

k(xᵢ,xⱼ)=(xᵢ·xⱼ)^{d} Equ.3

### Equation 2 Homogeneous Polynomial

k(xᵢ,xⱼ)=(xᵢ·xⱼ+1)^{d} Equ.4

### Equation 3 Inhomogeneous Polynomial

In such an embodiment, the Polynomial Kernel Grid Search Parameter values may include:
A. Cost varied between 0.1 and 7812.5, scaling by 5.
B. Gamma which may serve as inner product coefficient in the polynomial. Gamma may be varied between 1e-5 and 113.90625, scaling by 15.
C. Degree of polynomial varied between 0.01 and 4, scaling by 7.
D. Coeff0 varied between 0.1 and 274.4, scaling by 3.
   In one embodiment, a prediction of 97.64% may be obtained with a Cost value of between 0.3 and 0.7, such as for example 0.5, Gamma values of between 0.3 and 0.7, such as for example 0.50625, Degree of between 3.0 and 4.0, such as for example 3.43, and coeff0 of between 0.05 and 0.3, such as for example 0.1

### Random Trees Parameter Selection May Include:

A. Tree Height varied between 2 and 64, scaling by 2.
B. Features considered varied between 4 and 12, with a multiple step of 2.
   In one embodiment, a prediction of 98.13% may be obtained for Max Tree Height 32 and 10 random Features.

| Features/Max | | | | | | |
|---|---|---|---|---|---|---|
| Tree Height | 2 | 4 | 8 | 16 | 32 | 64 |
| 4 | 24.38 | 46.72 | 90.09 | 97.73 | 97.89 | 97.89 |
| 6 | 26.27 | 46.48 | 89.51 | 97.92 | 97.97 | 97.97 |
| 8 | 27.93 | 45.19 | 89.36 | 98.01 | 98.11 | 98.11 |
| 10 | 30.32 | 46 | 89.25 | 98.03 | 98.13 | 98.13 |
| 12 | 31 | 44.89 | 89.16 | 97.95 | 98.02 | 98.02 |

Table 3 (above) illustrates an embodiment of performance table with max tree height vs. features

Referring now to the results in Table 4 (below), an embodiment is illustrated in which the system uses 70% random training and 30% testing. In one experiment, settings of various embodiments described earlier, including RBF kernel, Polynomial kernel and Random Tree are tested with 10 fold cross validation on the full dataset. The results of this testing are as presented below.

TABLE 4
Comparative results of embodiments of RBF, Polynomial,
and Random Tree recognition results based on
70% random training and 30% random testing.

| | | RBF | | POLY | | RandTREE | |
|---|---|---|---|---|---|---|---|
| | Samples | Correct | Correct % | Correct | Correct % | Correct | Correct % |
| Run 1 | 61078 | 60323 | 98.76% | 60304 | 98.73% | 60491 | 99.04% |
| Run 2 | 62411 | 60486 | 96.92% | 59974 | 96.10% | 59202 | 94.86% |
| Run 3 | 62689 | 62339 | 99.44% | 61712 | 98.44% | 62358 | 99.47% |
| Run 4 | 59519 | 59041 | 99.20% | 58994 | 99.12% | 59013 | 99.15% |
| Run 5 | 64364 | 64112 | 99.61% | 63982 | 99.41% | 63873 | 99.24% |
| Run 6 | 58186 | 57681 | 99.13% | 57538 | 98.89% | 57551 | 98.91% |
| Run 7 | 64948 | 64006 | 98.55% | 63948 | 98.46% | 64484 | 99.29% |
| Run 8 | 63074 | 62671 | 99.36% | 62315 | 98.80% | 62764 | 99.51% |
| Run 9 | 53703 | 52425 | 97.62% | 52336 | 97.45% | 53321 | 99.29% |
| Run 10 | 57248 | 55519 | 96.98% | 55224 | 96.46% | 55508 | 96.96% |
| Total | 607220 | 598603 | 98.58% | 596327 | 98.21% | 598565 | 98.57% |

As the results may be presented in terms of various movements or gestures performed by the subjects and the rate of correct predictions for the given embodiments, Table 5 (shown below) presents data collected for the embodiments discussed where the scaled (and/or normalized) data is compared to the non-scaled (and/or non-normalized) data.

TABLE 5
Comparative results for RBF with and without scaling.

| | Scaled | | Not Scaled | |
|---|---|---|---|---|
| | Correct | Correct | Correct | Correct |
| Gesture | Prediction | Prediction % | Prediction | Prediction % |
| AirGuitar | 7336 | 99.46% | 7356 | 99.73% |
| Archery | 6606 | 100.00% | 6606 | 100.00% |
| Baseball | 3106 | 100.00% | 3106 | 100.00% |
| Boxing | 6128 | 100.00% | 6128 | 100.00% |
| Celebration | 1006 | 94.37% | 936 | 87.80% |
| Chicken | 3967 | 98.14% | 3437 | 85.03% |
| Clapping | 8006 | 100.00% | 7847 | 98.01% |
| Crying | 2887 | 96.01% | 2776 | 92.32% |
| Driving | 6518 | 100.00% | 6518 | 100.00% |
| Elephant | 1585 | 100.00% | 1585 | 100.00% |
| Football | 1621 | 100.00% | 1621 | 100.00% |
| HeartAttack | 1910 | 98.96% | 1895 | 98.19% |
| Laughing | 1747 | 99.15% | 1752 | 99.43% |
| Monkey | 1143 | 96.86% | 1140 | 96.61% |
| SkipRope | 943 | 77.11% | 1063 | 86.92% |
| Sleeping | 1816 | 100.00% | 1720 | 94.71% |
| Swimming | 1073 | 100.00% | 1073 | 100.00% |
| Titanic | 1290 | 100.00% | 1290 | 100.00% |
| Zombie | 2767 | 100.00% | 2767 | 100.00% |
| Overall | 61455 | 98.96% | 60616 | 97.61% |

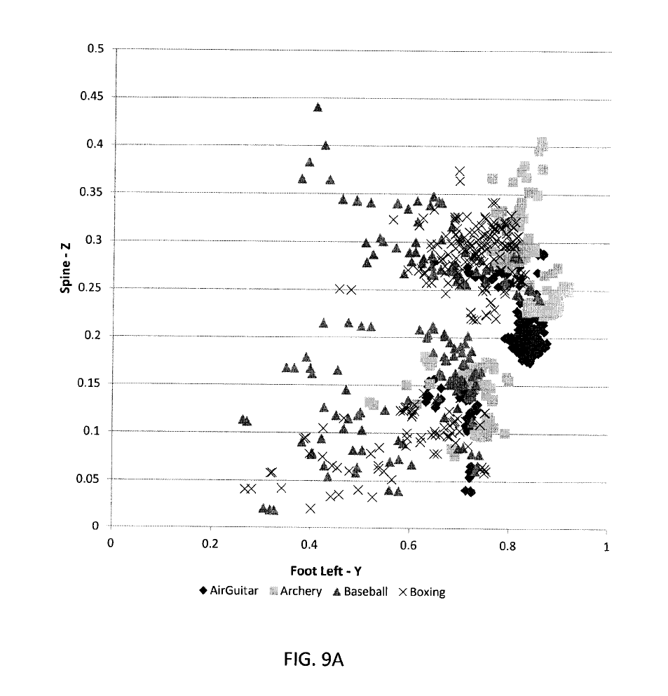

Referring now to FIG. 9, data collected for an embodiment in which RBF SVM is used is illustrated. FIG. 9 shows a plot of the first 4 alphabetical classes. These results are plotted in two dimensions, using values from the z-axis of the spin and the y-axis of the left foot. These axes were selected because the recognition system was prioritizing these points for accurate identification. FIG. 9 therefore shows support vectors in feature space. In this particular test and for this particular embodiment of the invention, a Y co-ordinate of left foot and a Z co-ordinate of a spine are found to be the most useful features while classifying gestures of various body parts.

In some embodiments, to speed up the system in terms of real-time recognition implementations a technique may be used in which display recognition results for only five of the 20 gestures are used, while the other 15 were grouped together as an “idle” gesture. In further embodiments, averaging the gesture over several frames, such as 10 frames at a time, creating a fixed minimum threshold, repeating this process 2-3 times, and averaging those results under another minimum threshold may be used before providing a recognition value.

The above discussed embodiments of systems and methods present series of approaches to complex real-time gesture recognition. These approaches may be used with any type and form of detectors, such as depth cameras, RGB cameras, or mark based tracking. The results of the tests show, in some embodiments, accuracy of greater than 98 percent. The embodiments may comprise a number of different learning algorithms (i.e. three different classifiers and/or recognizers).

While the system may operate entirely using gesture data points based on locations of joints and other body parts as represented in the Cartesian coordinate system, it is possible, and relatively simple, to represent the data using other coordinates, including the polar coordinates.

One such technique may include using representations of gesture data points which instead of locations, represent velocities between the frames of data. In such instances, the system would use an initial location and then simply represent each successive frame in terms of vector velocities representing movements of each particular gesture data point with respect to the position of the same gesture data point in a prior frame.

As another alternative, the system may also be represented using gesture data point angles. For example, if gesture data illustrates joints of a human body, each joint may be represented not in terms of X, Y and Z, but rather in terms of angles between the joints. As such, the frame may use only a single location and represent all the other gesture data points in terms of angular coordinates with respect to the single location. In such embodiments, the gesture data points may be represented as vectors with angles and magnitude.

Similarly, another way to represent the data may involve taking angles of the gesture data points and recording the velocity of the movements between the frames. However, any of these ways of representing the gesture data may involve simple mathematical transformations of different ways of representing points in a two dimensional space. One of ordinary skill in the art will recognize that representing the data in terms of Cartesian coordinate system, polar coordinate system, vectors between the frames or any combination thereof, involves simple mathematical variations to represent the same data.

### B. Systems and Methods of Compressing Gesture Data Based on Principal Joint Variables Analysis

In addition to the aforementioned embodiments, the present disclosure also relates to systems and methods of compressing, and more efficiently processing, gesture data using Principal Joint Variables Analysis (PJVA). As a frame of gesture data may include any number of features of gesture data, some of these gesture data features within a frame may be more relevant for determining a particular movement than other gesture data features. For example, when a system for identifying movements is detecting or determining a movement of a subject waving her hand, some gesture data features, such as those of right and left hands and right and left elbows, may be given more importance and weighted more heavily by the system than gesture data features of ankles, toes and knees. In these instances, when a determination of a movement depends more heavily of one group of body parts and joints, gesture data features of the more relevant body parts and joints may be selected and weighted more than others. In some instances, gesture data features that are not relevant for the determination of a particular movement or action may be completely deleted from the gesture data frames and may be left in the gesture data frames but not included in the processing during the detection process.

In one example, a frame of gesture data is meant to enable the system to identify movement of a subject pointing with her finger at a particular direction. In such an instance, the frame for identifying the pointing movement may exclude gesture data features of toes, ankles and knees and focus entirely on the gesture data features of the joints and body parts of the upper body. These determinations of weighing or prioritization of some gesture data features over others and/or truncation of the gesture data frames to exclude some less relevant gesture data features may be referred to as the Principal Joint Variables Analysis (“PJVA”).

Using the PJVA, processing speed of the system detecting subject's body movements may be significantly increased as the system needs to process only some gesture data features and not all to detect body movements. Moreover, in the instances where the PJVA leads to weighing some gesture data features more heavily than others, the system may also improve its accuracy of the detection by relying more heavily on the most relevant body parts for a particular movement than the less relevant body parts. In addition, in the instances where the PJVA leads to the system truncating frames of gesture data by deleting the irrelevant gesture data features, the size of data may be compressed because the frames for identifying gesture data are in this instance truncated and smaller than the original. PJVA may therefore be used by the system to speed up the processing, compress the gesture data as well as improve the accuracy of the system for detecting body movements.

In some embodiments, PJVA may be implemented by the system during the learning phase, thereby enabling the system to learn to recognize a movement or a gesture by using PJVA in the learning phase. PJVA compressed data may be stored in the database in a manner where only the relevant gesture data features are included. The non-relevant data that was extracted from the frames during the learning phase may be filled in with constants, such as zeros, or with random numbers. Meta data and/or data headers may include instructions helping the system understand which are relevant gesture data features and which are not. Meta data and/or data headers may also provide information to the system in terms of the weights to be included for each gesture data feature of the frame.

In one instance, a gesture may be described by 10 frames of three-dimensional data, each frame therefore comprising a matrix having three columns corresponding to X, Y and Z axis and each column comprising about 10 rows, each row corresponding to particular gesture data feature (“GDF”). Each GDF may correspond to a particular joint or a specific portion of human body, such as the forehead, palm of a hand, left elbow, right knee, and similar. Since dimensions of the frame correspond to the X, Y and Z, each row corresponding to a GDF entry may represent the GDF as a vector in terms of X, Y and Z coordinates. In such an embodiment in which a gesture recognition file includes a set of 10 frames of three-dimensional data where each dimension includes 10 GDF entries, the total number of GDFs to be calculated by the system may be expressed as:

GDFs=(10 frames)×(3 dimensions/frame)×(10 GDFs/dimension)=300 GDFs in total.

Therefore, for 10 frames of three-dimensional matrices of 10 GDFs (joints) the system would need to calculate or keep track of a total of 300 GDFs.

In comparison, when the system utilizes a PJVA technique to crop or extract the GDFs that are not relevant to a particular gesture, the system may use a larger number of frames, thereby improve the accuracy of the detection or recognition file while overall compressing the file size because of the reduction of the number of overall total GDFs and speeding up the processing. For example, when using PJVA, the system may instead of 10 frames use 15 frames of three-dimensional gesture data and instead of 10 GDFs per each dimension, extract 5 that are not needed and only use 5 relevant GDFs. In such an instance, the overall number of GDFs of 15 three-dimensional gesture data sets utilizing only the relevant GDFs, may be calculated as:

GDFs=(15 frames)×(3 dimension/frame)×(5 GDFs/dimension)=225GDFs in total.

Therefore, by using the PJVA, the system may compress the overall data while still improving the accuracy of the detection or recognition and the speed with which the data may be calculated or processed.

The present disclosure also relates to systems and methods of determining when and how to apply the PJVA compression on the gesture data. A PJVA function may be included in the system having the functionality to determine which GDFs to keep and which to exclude based on the variance of the GDFs through frames of data. Using variance of the GDF values from frame to frame may be referred to as the variance analysis, and may be employed in the PJVA as well as the PCA described below.

As some gestures may rely heavily on some parts of the subject's body, while not relying on others, a PJVA function may determine whether or not to utilize PJVA and for which of the GDFs in the matrix to utilize the PJVA. This determination may be done based on the variance of the GDFs from frame to frame. In one example, a PJVA function may analyze a set of frames of gesture data. Once the PJVA function determines that some specific GDFs vary through the frames more than others, the PJVA function may assign a greater weight to those GDFs that are varying through frames more. Therefore, GDFs that change or vary through frames less may be assigned a smaller weight and GDFs that change or vary through frames more may be assigned a larger weight. The weight assignment may be done based on the variance analysis. In one embodiment, a threshold weight may be established by which the GDFs having weight below the threshold weight may be extracted and the GDFs at or above the threshold weight may be kept and used for the determination. The determination of variability of GDFs through frames may be determined by variance from a mean value, a standard deviation from the mean or an average change of the GDFs from frame to frame.

Alternatively, even regardless of whether or not the PJVA function excludes any of the GDFs from the matrices, the weights assigned may be used by system to more heavily focus on those GDFs that are varying more through time, thereby focusing more heavily on the changes of movements of particular joints and improving accuracy of the detection or recognition of gestures. By multiplying the gesture data by the assigned weights, and using weighted gesture data, the system may give greater credence to those GDFs that vary more through time. As GDFs with greater variance between the frames of data may provide more relevant information about the gesture or movement than those with smaller variance, the overall detection and recognition accuracy may increase as the result of using the weighted GDFs.

In some embodiments, PJVA function may determine which GDFs to extract or exclude from the matrices based on standard deviation or variance of GDFs through a set of frames. For example, the PJVA function may determine a standard deviation or a variance for each GDF through the set of frames. This determination may be done by determining a mean of the GDF values through the frames and then determining variance and/or standard deviation of that GDF value through the frames. Therefore, a GDF corresponding to a left knee may be described by particular set of values in X, Y and Z directions per each frame. If the GDF corresponding to the left knee has a variance or a standard deviation from the mean value that is above a certain variance threshold, the GDF may be kept in the set. If however, this GDF has a variance or standard deviation that is below the variance threshold, then this GDF may be extracted and not included in the PJVA compressed gesture data set.

GDF variances may be determined for the GDF value as a whole or for each dimension components separately. For example, the system may use a single variance for a single GDF taking in consideration all three dimensions (X, Y and Z values) or it may determine the variance of the GDF value in X direction separately from the variances of GDF values in Y direction and Z direction. In instances where the GDF variance is done for each dimension individually, each GDF value would may have three mean values and three variance values. In instances in which the GDF variance is done for the GDF value alone, there might be only a single mean value and a single variance value for each GDF value.

During the process of compression, PJVA function may utilize the variance threshold to determine which GDF values to keep in the matrix and which to extract from it. In some embodiments, the variance threshold may equal to sigma, or one standard deviation from the mean. In other embodiments, the variance threshold may equal to two sigma, or two standard deviations from the mean. In further embodiments, the variance threshold may be set to three sigma, four sigma, five sigma or any other integer of fraction of sigma between 0 and 100. Naturally, as the variance threshold is set to a higher sigma value, only the GDFs with higher variance may be kept in the PJVA compressed gesture data set. Alternatively, a separate low-variance threshold may be set up to determine which low variance GDF values can be safely extracted. Using one or more variance thresholds as a determining factor with respect to which GDFs to keep in a matrix of gesture data and which to exclude, the PJVA function may then limit all the GDFs that are remaining more static through the frames, thereby not substantially contributing to a particular gesture. This way, PJVA function may only keep those GDF values that provide more information about the particular movement, sometimes significantly compressing the size of gesture data matrix, and speeding up the processing time.

### C. Systems and Methods of Compressing Gesture Data Based on Personal Component Analysis

The present disclosure also relates to systems and methods of compressing and/or improving gesture data processing and accuracy based on Principal Component Analysis (“PCA”). PCA may be implemented alone or in combination with the PJVA. PCA may entail a technique in which three-dimensional data, describing movements of gesture data features in terms of X, Y and Z coordinates is collapsed from the three-dimensional data set into a two-dimensional or single-dimensional data set. For example, when a particular gesture data set includes GDFs whose change in a particular axis, such as for example X-axis, is greater or more important than changes in Z-axis or Y-axis, then this data set can be collapsed from X-Y-Z three-dimensional data set into an X-axis single-dimensional data set. In such an instance, Y and Z axis data may be entirely erased or filled in by constants, such as a zero, while the X-axis values are modified to include data that is reduced from three dimensions down to a single dimension. X-axis values, may therefore be modified after the Y and Z axis are excluded, to more accurately represent or approximate the information that prior to this matrix transformation used to be represented in what is now the erased Y and Z dimension values. In such embodiments, PCA can be used to compress the data by more heavily relying only on the axis of greater importance and mostly ignoring data from the other one or two axis which are of lesser importance. In some embodiments, the axis of greater importance may be the axis along which most changes in GDFs takes place from frame to frame.

Principal component analysis or PCA, may be a linear projection operator that maps a variable of interest to a new coordinate frame in which the axis represents maximal variability. Expressed mathematically, PCA transforms an input data matrix X (N×D, N being the number of points, D being the dimension of data) to an output Y (N×D′, where often D′<D). PCA transformation of the 3 dimensional matrix down to a single dimensional matrix may be done via the following formula: Y=XP, where P (D×D′) is the projection matrix of which each column is a principal component (PC), and these are unit vectors that bear orthogonal directions. PCA may be a handy tool for dimension reduction, latent concept discovery, data visualization and compression, or data preprocessing in general.

With respect to using PCA in the system, while collapsing data may theoretically cause more errors when the data is relevant, if the system may ensure that the expelled data is not relevant or that it is substantially less important, then collapsing data from a three dimensional matrix down to a single dimensional one may not introduce a significant amount of errors. In order to determine which axis to collapse, a PCA function may be deployed to implement the PCA methodology. PCA function, in one embodiment, may implement the PCA methodology by using the above described variance analysis. For example, when a frame is represented by an X-Y-Z three-dimensional matrix of gesture data features and when variance of data in one or two of the three dimensions greatly exceeds the variance of data in the other one or two remaining dimensions, then the three-dimensional matrix may be collapsed into a one-dimensional or a two dimensional matrix, thereby reducing the size of the gesture data. This PCA process may be completed during the training or learning phase, thereby enabling the data in the data base to be collapsed and compressed. Additionally, PCA may also be done in the recognition phase as well, thereby enabling the newly extracted frames of data to be compared against the gesture data from the database when collapsed and compressed along the axis of greater importance.

Because PCA compresses the data, it speeds up classification as well as the processing. In embodiments in which the data is compressed from a three-dimensional matrix down to a single dimensional matrix, while some less significant error may be introduced by losing ⅔ of the data, additional frames may be added to improve the overall accuracy despite the fact that the data is overall compressed. So for example, if 8 frames of single-dimensional collapsed data are used for gesture recognition, despite the fact that these 8 frames are collapsed, they may still provide more accuracy than 4 frames of the non-collapsed three-dimensional data. Moreover, if we consider that 8 single dimensional frames are smaller than 4 three dimensional frames by about ⅓, we can notice the significant compression even when the accuracy improves, or at least compensates for the errors introduced. Therefore, the system may benefit by using a larger number of frames to detect or recognize a gesture or a body movement while sacrificing some accuracy per frame. However, since each additional frame provides more accuracy than collapsed singe-dimensional data set takes away, over all the accuracy improves while the data is getting compressed.

In another example, a gesture data set of frames may comprise 10 three-dimensional frames, each having ten gesture data features. The total amount of gesture data features, (“GDFs”), wherein each GDF corresponds to a joint or a location of the human body, is to be calculated for this particular set of 10 frames as:

GDFs=(10 frames)×(3 dimensions/frame)×(10 GDFs/dimension)=300GDFs in total.

Therefore, for 10 frames of 3-dimensional matrices of 10 GDFs (joints) the system would need to calculate or keep track of a total of 300 GDFs.

In comparison, a set of 20 frames of single-dimensional data sets having 10 GDFs/dimension each may result in an overall smaller number of GDFs, while still resulting in a more accurate overall detection and recognition accuracy because of twice the number of relevant frames of gesture data. In such an instance, the overall number of GDFs of 20 single-dimensional collapsed gesture data sets, may be calculated as:

GDFs=(20 frames)×(1 dimension/frame)×(10 GDFs/dimension)=200 GDFs in total

In this instance, the number of GDFs (or joints/locations of human body) for a particular detection or recognition file is reduced by ⅓ while the number of frames has doubled, thereby still improving the accuracy over the 10 frame three-dimensional gesture data sets, while the speed of the processing is also improved due to the overall smaller number of GDFs to be processed. Therefore, using the PCA to collapse the three-dimensional gesture data to a two-dimensional or a single dimensional gesture data may result in data compression and still leave some room for improvement of accuracy and speeding up of the overall process.

In some embodiments, the system may utilize both the PJVA and the PCA, in such instances the frames may be collapsed from three-dimensional matrices down to two-dimensional matrices or a single-dimensional matrix, while in addition also being collapsed in terms of the number of gesture data features per frame. So for example, a gesture of a subject pointing a finger towards a particular location may be represented collapsed from a three-dimensional matrix to a two-dimensional matrix, while also being collapsed from 10 gesture data features for each dimension down to 5 gesture data features for each dimension. In such an embodiment, the gesture or movement normally being represented by 10 frames having 3-dimensional matrices of 10 gesture data features in each dimension, the gesture or movement may be represented by 20 frames of collapsed single-dimensional matrices having 5 gesture data features in each dimension, resulting in a total compression of ⅔ from the original data size. However, since the combination of PJVA and PCA would be implemented only for the gesture data whose additional number of frames introduced would exceed the error from the PJVA/PCA compression, the overall accuracy would be overall increased, while the data would still be compressed.

PCA function may include one or more algorithms for determining whether or not to collapse one or more dimensions of the matrix of the gesture data and if so, which ones to collapse. As with the PJVA function above, PCA function may also utilize a similar variance analysis to make such a determination. In one embodiment, PCA function determines mean and variance values of the GDS values through the frames. The mean and variance (or standard deviation) values may be determined based on the GDS value itself or based on each dimension of the GDS value separately. When the PCA function determines that variance or change along X direction is greater by than a threshold value, PCA function may collapse Y and Z values and use only X values of the GDS for the gesture data recognition. In some embodiments, PCA function may determine that X and Y values have a sufficiently high variance, whereas Z values do not, and in response to the determination collapse the Z dimension, leaving only a two dimensional, X and Y, matrix for gesture data recognition. In further embodiments, PCA function may determine that Y and Z dimension GDS values have variance that is smaller than a particular low-variance threshold, and in response to this determination decide to collapse the matrix into a matrix having only the X dimension. In some embodiments, PCA function may utilize high-value variance thresholds and low value-variance thresholds to determine which dimensions have a substantially high variance and which have a substantially low variance and then collapse the matrix responsive to such determinations. High and/or low variance thresholds may be established based on sigma values, such that for example a high variance threshold may be set to two sigma, while the low variance threshold may be set to about ¼ of sigma. Sigma values may be determined based on the mean and variance along each single dimension.

In a nutshell, the present disclosure is motivated by the goal to create systems and methods to effectively represent and standardize gestures to achieve efficient recognition as acquisitioning techniques evolve. The present disclosure aims to reduce human expertise and supervision necessary to control and operate the system, to reduce the hardcoding of gestures, find universal truths of body language and create a single standard for all body gestures (the entire body, only the hands, only the fingers, or face).

In addition, the present disclosure has a goal to utilize the methodology of Random Tree Classification of Body Joints (Gesture Data Features) for the detection or recognition purposes. A random trees classification may include a classification algorithm used in the field of learning software. In one embodiment, a random tree classification may be set up like a probabilities tree in which there is only one branch or leaf that can be a winner. Random forest classification algorithm may be a multitude of random tree algorithms. During the recognition phase, the system may run through several separate random forests on each joint, having 2-100 random tree algorithms within each random forest. The system may identify and select a particular gesture file that describes the new gesture data being received from the receiver or camera using random tree classification and/or random forest classification. In one embodiment, the number of trees in the random forests that has the highest success rate in a comparison of multitude of gesture data sets is selected by the system as the winning recognizer file. Therefore the Random forest classification may be used by the system to more quickly identify the gesture data set that is the closest match to the newly acquired gesture data set of the subject whose movement the system needs to detect and identify. Random Tree Classification therefore may be used for gesture data feature recognition, real-time gesture recognition, static pose analysis and the analysis of poses of the subject moving through time.

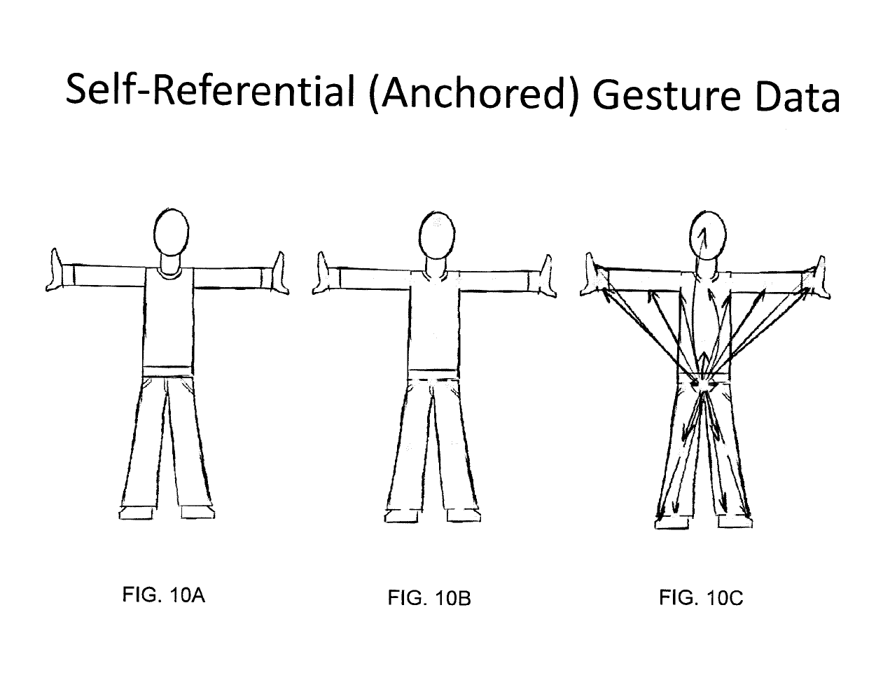

Referring now to FIGS. 10A, 10B and 10C, an embodiment of a subject striking a pose described by self-referential, or anchored, gesture data is illustrated. In brief overview, FIG. 10A illustrated an instance in which a subject is striking a particular pose or a gesture. FIG. 10B shows gesture data features plotted on top of the subject's body. Gesture data features describe locations on the subject's: head, finger tips of both hands, palms of both hands, both elbows, both shoulders, mid-shoulder section, belly, waist, both hips, both knees, both ankles and toes on each foot. FIG. 10C illustrates the same pose from FIG. 10A and the same set of gesture data features from FIG. 10B represented in terms of self-referential, or anchored, gesture data, where the each gesture data feature is represented as a vector with respect to the waist point. In this instance, each gesture data point is represented as a vector starting at the waist of the subject and ending at the location of the given feature of gesture data; e.g. left palm is represented as a vector from the waist to the left palm.

Anchoring technique may be used so that the joint of the human body represented by a feature of the gesture data is oriented from an anchoring point of view which has the least amount of variance. Reducing variance increases accuracy of the recognition. In most cases the waist or center of the shoulders, i.e. the mid-shoulder point, is used as the anchor. However, depending on the embodiment any feature gesture data point may be used as the anchor point. If joint orientation is more definite, which anchor point to choose becomes less important.

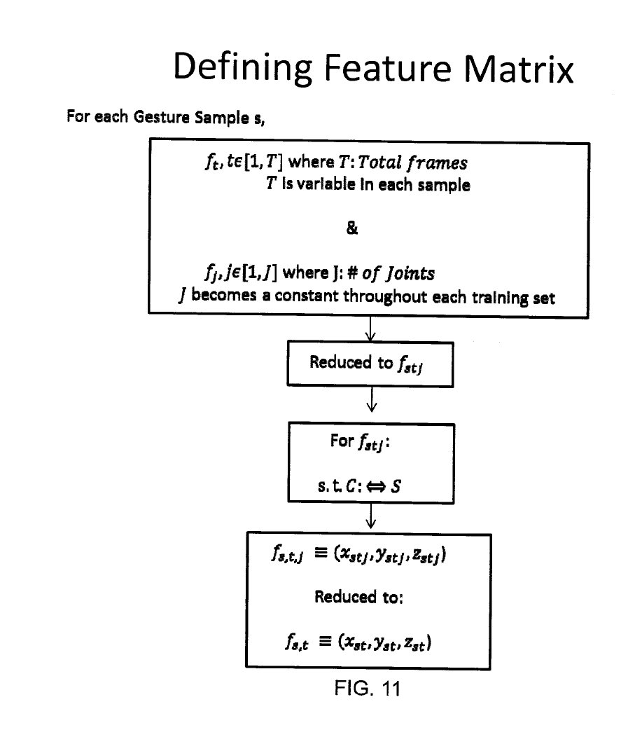

Referring now to FIG. 11, an embodiment of a technique for defining feature matrix is illustrated. While definition may very design to design and application to application, FIG. 11 relates to mathematical rephrasing of the diagram of an embodiment shown in FIG. 6A. In this embodiment, expression: tε[1,T], means that t is an element of the set [1,T]. Time, which is represented by “T” is variable sample to sample. Expression: jε[1,J] means that j is an element of the set [1,J]. Joint Number which is represented by J is a constant predefined before classification, but selectively variable. Further below, statement, C: [symbol] S means C is logically equivalent to S. This means that the Classes and Samples may be directly related to each other mathematically. Expression: f_{s,t,j}≡(xₛₜⱼ, yₛₜⱼ, zₛₜⱼ) means that for every sample or class, that the date may be prestamped with x, y, z data indexed by sample, time stamp and joint number.

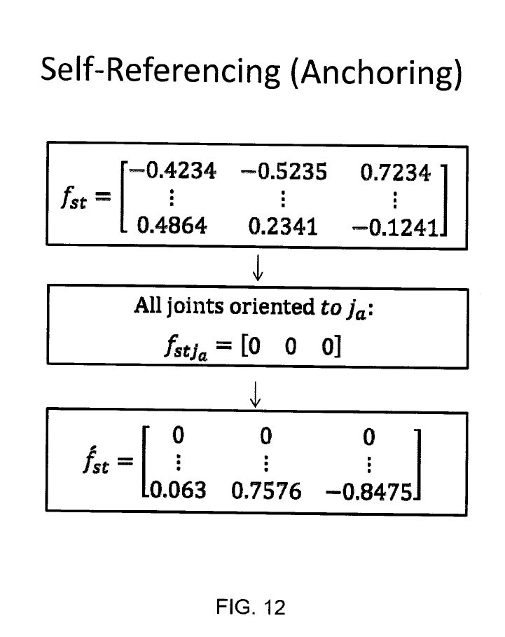

Referring now to FIG. 12, an embodiment of gesture data being anchored or self-referenced is illustrated. Anchoring or self-referencing may be implemented after the matrix is defined. FIG. 12 illustrates an exemplary matrix showing how the present system modifies the data from the input. In this example, waist is used as the anchor from which all gesture data features are referenced mathematically as a matrix. So the matrix may represent each and every gesture data feature as an X-Y-X vector from the anchor point. The first row in the bottom matrix of FIG. 12 in this case represents the value of 0, 0, 0, which means that the first point may be the anchor point in reference to itself, resulting in x, y, z values of zero.

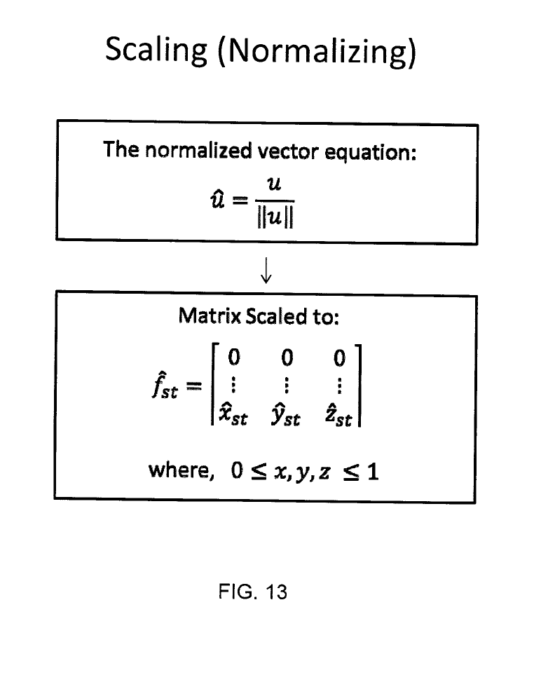

Referring now to FIG. 13, an embodiment of scaling or normalizing of the matrix of gesture data is illustrated. Scaling or normalizing may be completed after the anchoring of data. At this step, the values of the matrix are scaled and normalized to be between 0 and 1.

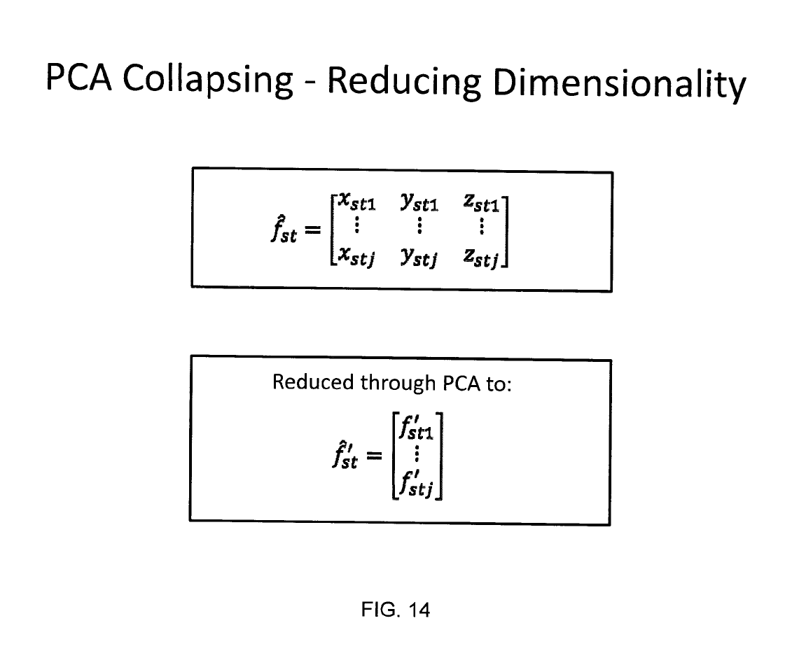

Referring now to FIG. 14, an embodiment of PCA collapsing or reduction of dimensionality is illustrated. PCA collapsing may be implemented after the data is self-referenced and normalized. PCA collapsing, as described above, may reduce a 3 column matrix to a single column representing the most significant matrix for a particular gesture. In some instances, PCA may result in reducing 3 columns of the vector down to 2 most significant columns, eliminating only one column. At this step, in addition to PCA collapsing, PJVA collapsing, as described above, may be implemented as well. Combining PCA collapsing with the PJVA collapsing may further compress the data size.

In one instance, a data set is used to conduct testing on the systems and methods for gesture recognition described herein. The data set comprises of positions of, for example, 20 joints when performing 12 different gestures. There may be a total of 594 samples with a total of 719359 frames and 6244 gesture instances. In each sample the subject repeatedly performs the gestures which are recorded at around 30 Frames per second.

In this particular example, the features may be extracted from gesture by taking polynomial approximation of motion of each joint along the 3 axis. To extract features, a sequence of N1 and N2 past frames may be taken, where N1>N2 and motion of each joint point is approximated by using a D degree polynomial. So overall the classification may have a latency of N1. To reduce the noise and enhance the quality of features, PCA may be done on extracted samples to account for a variability v. First and last 100 frames may be dropped from each sample to discard any redundant motions performed in the starting or end of recording.

In this exemplary test, 80% of the samples were randomly selected to make the train set and 20% the test set. The train set was further reduced to 200,000 feature vectors by sampling with replacement while keeping the number of samples of each gesture constant. No such sampling was done on the test set.

With respect to the table below, the following values are indicated:

N1, N2: Past frame count

D: Degree of fitted polynomial

v: Variability accounted for by the selected eigenvectors after PCA

EV count: Count of Eigen vectors selected.

Test Accuracy: the percentage of correct identification of the movement or gesture.

| | | | | V (Eigen | Test |
|---|---|---|---|---|---|
| Description | N1 | N2 | D | vectors) | Accuracy |
| Random Forest, | 30 | 10 | 4 | .95 (18) | 76.79% |
| 200 Trees, | | | | | |
| Random Forest, | 30 | 10 | 4 | .92 (14) | 69.87% |
| 200 Trees, | | | | | |
| Random Forest, | 30 | 10 | 4 | .98 (30) | 74.73% |
| 200 Trees, | | | | | |
| SVM, RBF Kernel, | 30 | 10 | 4 | .95 (18) | 62.45% |
| c = 1, Gamma = | | | | | |
| 9.25 | | | | | |
| Random Forest, | 30 | 10 | 2 | .95 (26) | 71.81% |
| 200 Trees, | | | | | |
| Random Forest, | 30 | 10 | 6 | .95 (26) | 63.91% |
| 200 Trees, | | | | | |
| Random Forest, | 60 | 30 | 3 | .95 (22) | 79.09% |
| 200 Trees, | | | | | |
| Random Forest, | 60 | 30 | 3 | .95 (17) | 74.75% |
| 200 Trees, Not | | | | | |
| normalized data | | | | | |

With respect to the accuracy across different samples in the course of this particular test, it has been found that the accuracy of classifier was significantly different on different samples. On 59% test samples the accuracy was between 90%-100%, however for few samples the accuracy was even less than 10%. This can be attributed to few problems with the recorded gestures, i.e. the provided data set, of which some examples are given in table below, and also at times same gesture performed by different subjects involve very different motions making the whole sample getting a very poor classification.
FIG. 37 is a graph illustrative of sample count plotted against classification rate.

| | Sample | | |
|---|---|---|---|
| Gesture | Id | Accuracy | Problem |
| G11_Beat_both | 40 | 0% | Wrong gesture. |
| | | | Kicking. |
| G5_Wind_it_up | 30 | 2.31% | Circular gesture |
| | | | with single hand. |
| G11_Beat_both | 33 | 7.38% | Random gesture. |
| G1_lift_outstretched_arms | 8 | 34.85% | No gesture in most |
| | | | of the frames. |

### Confusion Matrix

| | G10 | G11 | G12 | G1 | G2 | G3 | G4 | G5 | G6 | G7 | G8 | G9 |
|---|---|---|---|---|---|---|---|---|---|---|---|---|
| G10 | 81.90% | 0.00% | 0.10% | 1.00% | 0.20% | 1.70% | 2.20% | 2.00% | 10.60% | 0.30% | 0.00% | 0.00% |
| G11 | 0.00% | 62.00% | 0.00% | 13.90% | 0.00% | 0.00% | 0.20% | 5.50% | 0.00% | 0.20% | 0.30% | 17.90% |
| G12 | 0.00% | 0.00% | 95.80% | 1.90% | 0.10% | 0.50% | 0.10% | 0.10% | 0.00% | 0.60% | 0.80% | 0.00% |
| G1 | 0.00% | 39.30% | 0.00% | 52.20% | 0.10% | 0.00% | 0.30% | 6.30% | 0.10% | 0.20% | 0.00% | 1.50% |
| G2 | 0.00% | 0.00% | 0.30% | 0.00% | 98.50% | 0.00% | 0.20% | 0.00% | 0.00% | 0.90% | 0.00% | 0.00% |
| G3 | 1.00% | 0.00% | 0.80% | 0.20% | 0.10% | 93.40% | 0.00% | 0.20% | 0.00% | 2.30% | 1.90% | 0.00% |
| G4 | 0.30% | 0.20% | 0.00% | 0.40% | 0.50% | 0.00% | 88.00% | 2.90% | 1.60% | 0.00% | 0.00% | 6.10% |
| G5 | 8.80% | 7.80% | 4.40% | 5.30% | 2.50% | 14.80% | 4.70% | 44.60% | 2.50% | 2.00% | 2.30% | 0.30% |
| G6 | 0.00% | 0.00% | 0.00% | 0.10% | 0.20% | 0.00% | 1.10% | 0.10% | 98.30% | 0.10% | 0.10% | 0.00% |
| G7 | 0.60% | 0.40% | 4.70% | 3.60% | 7.10% | 1.40% | 0.30% | 1.00% | 0.20% | 80.20% | 0.60% | 0.00% |
| G8 | 0.60% | 0.00% | 0.00% | 0.40% | 0.20% | 0.70% | 0.00% | 0.10% | 0.00% | 0.00% | 98.10% | 0.00% |
| G9 | 0.00% | 2.00% | 0.00% | 5.10% | 1.20% | 0.00% | 5.80% | 0.70% | 0.00% | 0.30% | 0.00% | 84.90% |

Actual Gesture Vs. Predicted Gesture.

In this particular test and for this particular data set, a few gestures are have found to be much more difficult to recognize than other gestures. Wind it up (G5), Lift outstretched arm (G1) and Beat both (G11) have very low accuracy in recognition. In fact, discarding these 3 gestures the accuracy will go as high as 92%. Beat both hands and lift outstretched arms both involve lifting of arms above head and bringing them down sideways. And hence a low latency algorithm like the one used in our case, will find both actions exactly same as it is harder to tell the difference between them without analyzing a larger window of action.

Similar is the problem with ‘Wind it up’ which at times resembles a lot of other gestures partially.

### Not Normalized Data Confusion Matrix

| | G10 | G11 | G12 | G1 | G2 | G3 | G4 | G5 | G6 | G7 | G8 | G9 |
|---|---|---|---|---|---|---|---|---|---|---|---|---|
| G10 | 82.20% | 0.70% | 0.10% | 0.10% | 0.00% | 5.10% | 4.30% | 3.80% | 0.90% | 0.30% | 1.70% | 0.70% |
| G11 | 0.50% | 69.10% | 0.00% | 8.50% | 0.70% | 0.10% | 7.20% | 3.00% | 0.70% | 0.00% | 0.00% | 10.00% |
| G12 | 1.10% | 0.50% | 90.20% | 2.60% | 1.10% | 0.10% | 0.00% | 0.30% | 0.00% | 0.20% | 3.80% | 0.00% |
| G1 | 0.10% | 25.20% | 0.00% | 54.50% | 7.00% | 0.30% | 0.10% | 3.10% | 0.40% | 2.80% | 0.10% | 6.50% |
| G2 | 0.50% | 0.60% | 2.60% | 1.90% | 83.30% | 0.30% | 1.10% | 0.40% | 0.00% | 6.30% | 3.00% | 0.00% |
| G3 | 13.80% | 4.60% | 1.30% | 0.40% | 0.90% | 69.40% | 0.00% | 2.60% | 1.70% | 3.30% | 1.80% | 0.00% |
| G4 | 0.40% | 0.20% | 0.00% | 0.30% | 0.00% | 0.00% | 91.80% | 1.70% | 2.50% | 0.00% | 0.00% | 3.20% |
| G5 | 0.80% | 16.90% | 0.10% | 9.30% | 0.30% | 0.50% | 7.30% | 57.50% | 6.20% | 0.60% | 0.10% | 0.50% |
| G6 | 2.20% | 0.10% | 0.50% | 0.40% | 0.00% | 0.10% | 9.40% | 0.90% | 85.40% | 0.10% | 0.00% | 1.00% |
| G7 | 1.00% | 0.20% | 4.70% | 6.10% | 10.20% | 2.10% | 0.10% | 0.50% | 0.00% | 74.00% | 0.90% | 0.20% |
| G8 | 3.90% | 0.00% | 0.40% | 3.50% | 0.00% | 1.40% | 0.00% | 0.50% | 0.00% | 0.00% | 90.10% | 0.20% |
| G9 | 0.00% | 6.90% | 0.00% | 10.10% | 0.00% | 0.10% | 13.30% | 1.10% | 0.60% | 0.10% | 0.00% | 67.90% |

However, the above identified experiment, along with its data set represents only a single experiment, out of many which can be done. Varying the settings, the data set as well as the parameters may completely change the accuracy and the results of the set up. Therefore, these results should not be interpreted as any limitations to the system, as the system described herein may be customized for various environments, applications and usage, depending on the target movements and gestures the system is expected to monitor and identify.

### D. Systems and Methods of Compressing Gesture Data Slow and Fast Motion Vector Representations

Present disclosure further relates to systems and methods of compressing data based on slow and fast motion vector representation. Slow and Fast motion vector representations may be used to compress gesture data and use a smaller number of frames and then later on decompress the data by generating additional frames from the gesture data of the existing frames.

In one example, when a gesture data set may need a set of 300 frames to accurately describe a gesture, Slow and Fast Motion Vector (SFMV) compression may be used to utilize a smaller set of frames ordered chronologically, such as for example 45 consecutive frames, to accurately represent the gesture. The smaller set of 45 frames may be used to extract and generate additional frames, thereby increasing the number of frames from 45 to anywhere around 300, which may then be used to recognize or detect a gesture. SFMV may utilize 4 degree polynomial functions for each of the GDF values in each of the existing dimensions of the frames to determine, or estimate, the values of the frames to be generated. For example, when a smaller set of 45 frames is used, SFMV technique may be used to create a mid-frame between frame 22 and frame 23, and 4 degree polynomial function plots using GDF values through frames may be used to estimate the GDF values for each given dimension for the newly created mid-frame. This way, any number of mid-frames may be generated to provide the system with a sufficient number of frames to detect or recognize a particular gesture.

To implement the SFMV functionality, an SFMV function may be deployed to use one or more algorithms to compress or decompress gesture data frames using the SFMV technique. In brief overview, SFMV function may extract, or provide the tools for extracting, a smaller set of gesture data frames from a larger gesture data frame set. The smaller set of gesture data frames may include any number of frames that is smaller than the original frame set that is being shrunk. The smaller set of gesture data frames may include: 10, 15, 20, 25, 30, 35, 40, 45, 50, 55, 60, 65, 70, 75, 80, 85, 90, 95, 100, 110, 120, 130, 140, 150, 160, 170, 180, 190, 200, 220, 240, 250, 270, 290 or 300 frames. In one embodiment, the smaller gesture data set includes 45 frames. These 45 frames may include consecutive frames minus any erroneous frames which may have been cut out. The last 15 frames of the 45 frames may be given a special weight. While the set of 45 frames may be referred to as the slow motion vector set, the last 15 frames may be referred to as the fast motion vector set. These last 15 frames may be counted by the algorithm twice. By counting the last 15 frames twice, the system gives these past 15 frames twice the credence as the other prior 30 frames. However, depending on the embodiment, the weight of the last 15 frames may be any weight between 0 and 100.

SFMV function may comprise the functionality for generating mid-frames by extrapolating data from the 45 consecutive frames. A mid-frame may be generated by SFMV function using 4 order polynomial functions to represent the movement or position of each separate GDF entry through the frames, meaning each dimensional value of each GDF may be plotted using the 4^{th} order polynomial function representing that particular GDF dimensional value through time (e.g. through consecutive, or at least chronological, frames). A mid-frame may be generated therefore by calculating each GDF value individually, including the X, Y and Z dimensional values from the 4^{th} order polynomial function. Using this methodology, SFMV function may generate any number of mid-frames. The mid-frames may be positioned within the frame set such that they do not undermine the chronological order. In other words, consecutive order of the frames and mid-frames may be maintained. SFMV function may recreate a sufficient number of mid-frames to have the same number of frames as the larger original set, which the smaller set of gesture data frames was meant to replace. By utilizing this smaller set, SFMV function may implement compression and decompression of data.

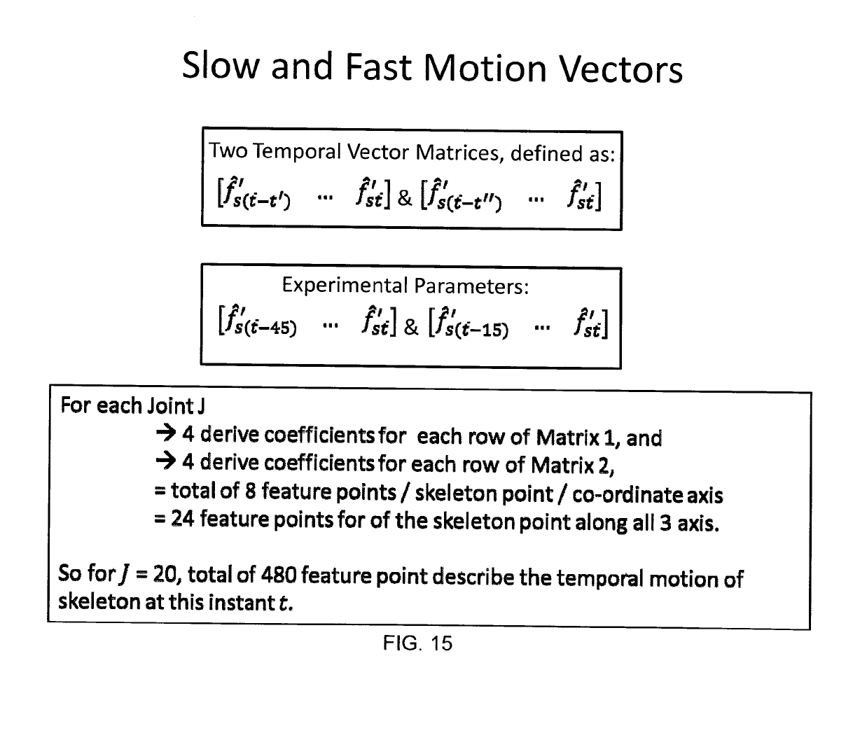

Referring now to FIG. 15, an embodiment of slow and fast motion vector representations are illustrated. In brief overview, FIG. 15 may represent an embodiment of the matrix data after polynomial approximations, whereby gesture motion data may be most visible. The first function or equation may represent a general statement saying that with respect to a frame somewhere inside a sample, we take a larger number of frames before that frame point and a smaller number of frames after that frame point and join them into one matrix row.

The second equation may represent a more specific function in which we take the previous 45 frames and join them with the last 15 frames. This process gives us a slower and a faster sets of the gesture data. However, this process is not limited to only two gesture speed lengths, as multiple lengths of varying size may be used.

In one instance, for each joint J represented by the matrices, 4 coefficients may be derived to approximate each row of the first matrix. Similarly, another 4 coefficients may be derived to approximate each row of the second matrix. Once we have 8 coefficients, corresponding to feature points, per skeleton point of the subject's body per coordinate axis, we have about 24 feature points describing the motion of this skeleton point along all 3 axis. The 4 coefficients may include X, Y and Z values and a time stamp, therefore corresponding to space and time. In some embodiments, only X, Y and Z values may be used, without the timestamp. The two matrices may correspond to the two set of frames, the first matrix corresponding to the 45 frames and the second matrix corresponding to 15 frames.

In one embodiment, the 4 coefficients are X, Y, Z and Timestamp. The row of a matrix may be represented such that each value in the row can have a X, Y and Z components of the GDF inside the matrix. In the instances in which PCA compression has been applied, the three dimensions are then replaced by one dimension after the PCA. However, PCA can be applied prior to this step or after it.

For example, if we have 20 joints represented by “J”, we would have 480 GDFs or feature points, to describe the temporal motion of this skeleton at this point in time t. Therefore, if the gesture data frames are compressed using PCA and/or PJVA, such a process may greatly reduce the number of calculations needed.

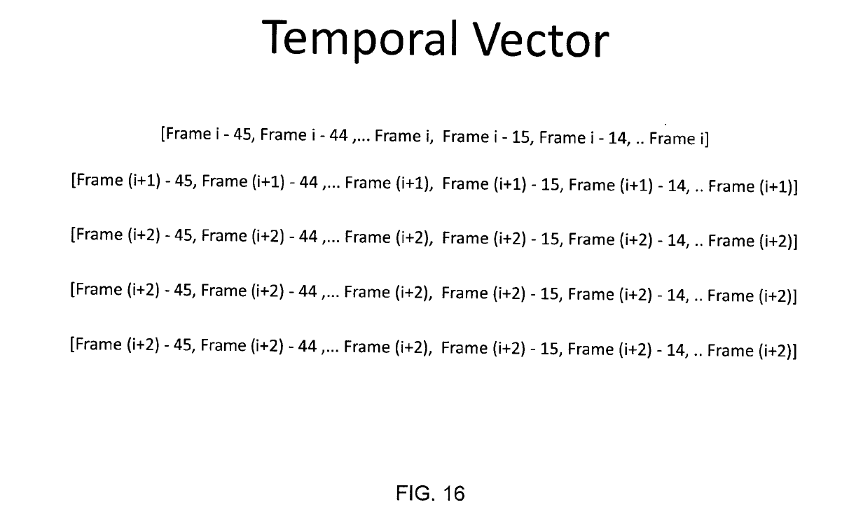

Referring now to FIG. 16, an embodiment of a temporal vector is illustrated. FIG. 15 refers to a step of generating additional gesture data frame samples from the smaller set of gesture data frames. The newly generated gesture data frames may be saved into database by adding more random starting points to the above slide approach. Each starting point may refer to a particular position of the mid-frame with respect to other frames having its own position in the chronological order. For example, the value of “i” in FIG. 16 expressions may be changed to generate new samples with different slices of time and use them in the classifier.

In one embodiment, the system combines the all the functionality of the gesture data recognition together with the PCA technique, PJVA technique, SFMV technique and temporal vectors into a single system for detection and recognition of gestures using self-referential gesture data.

The system may grab a frame of gesture data and normalize the GDFs corresponding to the skeleton points or locations of the subject's body, as described above. The system may select and maintain a queue of the past 45 frames. The 45 selected frames may be the smaller set of gesture data frames. In some embodiments, the number of frames may vary to be different from 45. The frames may be ordered chronologically. The frames may also be consecutive, one immediately preceding the other. A 4^{th} degree polynomial approximation function may be derived for each GDF for the selected 45 frames.

As a next step, a complete GDF array of floating point coefficients of polynomials derived above may be prepared. The array of the coefficients may correspond to: 20 GDFs of each frame, each of the GDFs being described by 4^{th} degree polynomial equation for the selected frame set, each of which are completed for two sets of frames (one for the selected 45 frames and another one for the last 15 frames of the selected 45 frame set), all of which is again done for each of the 3 dimensions (X, Y and Z). Therefore, the complete GDF array may have the size of 20 GDFs*4 degree polynomial function*2 frame sets*3 dimensions=480 GDF entries. At this stage, a vector of length of 480 is derived to denote the temporal motion by considering the selected 45 frames and the 15 last frames of the selected 45 frame set. This vector may represent temporal gesture of all GDF points from the selected gesture data frame set.

The system may then compress the complete GDF array by doing PCA and/or PJVA compression. In the instances in which the PCA compression is completed based on a determination that two of the dimensions have a small variance and that one dimension has a large variance, the compressed feature vector may be collapsed to a single row having 30 columns (i.e. the vector of length 30). The single row may represent a single dimension, however the values of this dimension may be transformed from the original dimension values.

The system may then predict the gesture that is being completed by the subject in real time by using random forest classification. In one example, for each gesture data set (sample) the first 45 frames may be skipped. Since the selected 45 frames are used to define the motion to be detected, at the 46^{th} frame onwards the system may be able to specify the temporal motion of each skeleton point (each GDF).

For each frame starting from the 46th frame onwards, to prepare a vector describing its temporal motion, the following functions or algorithms may be implemented:

First, using nomenclature define x_{i,j}=x coordinate of i-th GSD (skeleton point) in j-th frame. Suppose the current frame is j-th frame. In this instance, the system may specify the motion of each skeleton point at this point in time using the past 45 and 15 points (from the past 45 selected frames, and the last 15 frames of the 45 frames). In some embodiments, the input for skeleton point 0 may be defined as:

$$[ \begin{matrix}{x}_{0 , j - 45} & … & {x}_{0 , j} \\ {y}_{0 , j - 45} & … & {y}_{0 , j} \\ {z}_{0 , j - 45} & … & {z}_{0 , j}\end{matrix} ] and [ \begin{matrix}{x}_{0 , j - 15} & … & {x}_{0 , j} \\ {y}_{0 , j - 15} & … & {y}_{0 , j} \\ {z}_{0 , j - 15} & … & {z}_{0 , j}\end{matrix} ] .$$

Using this input, the system may derive 4 coefficients for approximating each row of first Matrix, and another 4 coefficients approximating each row of second matrix. These actions may result in 8 coefficients (GSDs coefficient values) per skeleton point per co-ordinate axis, or 24 GSDs coefficient values describing the motion of this skeleton point along all 3 axis (8 GSD entries for each of X, Y and Z axis).

However, for 20 GSDs, there may be 20 such skeleton points resulting in a total of 24*20=480 feature points describing the complete temporal motion of skeleton at this instant j, to be stored in a feature vector or a GSD

In one embodiment, the system may take a maximum of 30000 feature vectors prepared as above for training the classifier. This number may be selected based on the memory and CPU constraints. Then, the system may construct a Matrix where each row corresponds to a feature vector prepared above. The matrix in which each row corresponds to a feature vector or a GDF array of entries, which may be represented as:

$$[ \begin{matrix}{p}_{45 , 1} & … & {p}_{45 , 480} \\ {p}_{46 , 1} & … & {p}_{n , 480} \\ {p}_{n , 1} & … & {p}_{n , 480}\end{matrix} ] ,$$

P_{i,j}=where a feature point j corresponding to Frame i. Each frame is approximated by a 480 length coefficient vector derived in step 2. There are total of n frames in this sample. However, the system may derive feature vector for only 45th frame onwards.

At the next step, the PCA may be implemented over this feature vector matrix, and keep eigenvectors which accounts for 98% variability in the given data. (This may leave somewhere around 30-40 eigenvectors in case of data trained using all the 19 gesture classes.

$$[ \begin{matrix}{x}_{1} \\ {x}_{2} \\ ⋮ \\ {x}_{n}\end{matrix} ] ↦ [ \begin{matrix}{A}_{1 , 1} & {A}_{1 , 2} & … & {A}_{1 , n} \\ {A}_{2 , 1} & {A}_{2 , 2} & … & {A}_{2 , n} \\ ⋮ & ⋮ & ⋱ & ⋮ \\ {A}_{n , 1} & {A}_{n , 2} & … & {A}_{n , n}\end{matrix} ] [ \begin{matrix}{x}_{1} \\ {x}_{2} \\ ⋮ \\ {x}_{n}\end{matrix} ] = [ \begin{matrix}{y}_{1} \\ {y}_{2} \\ ⋮ \\ {y}_{n}\end{matrix} ]$$

Once the collapsing is implemented for the PCA, the compress feature matrix by projecting them into lower dimension space given by the selected eigenvectors above.

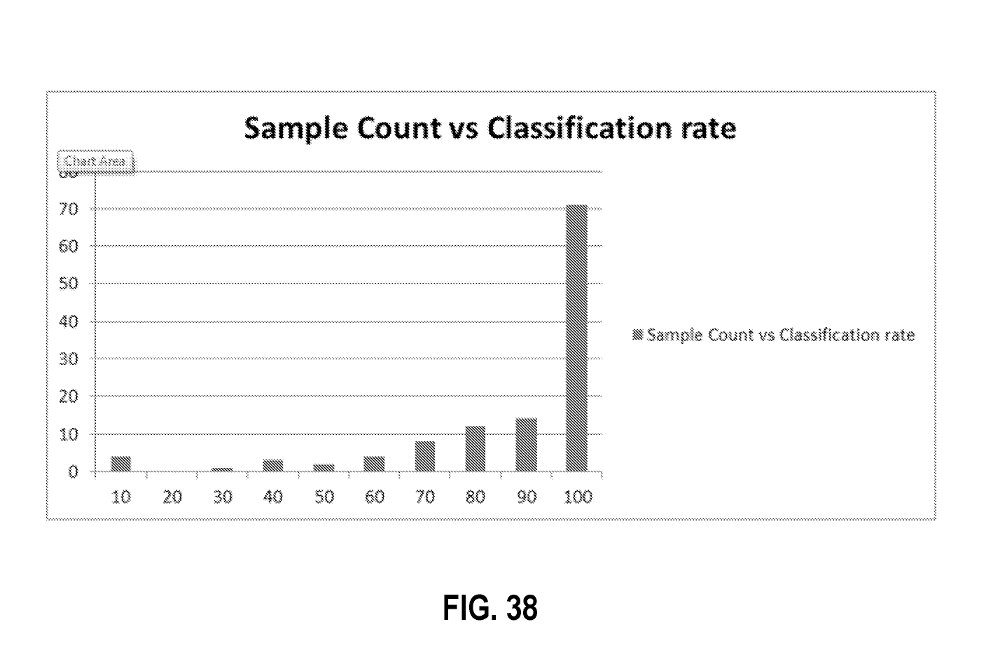

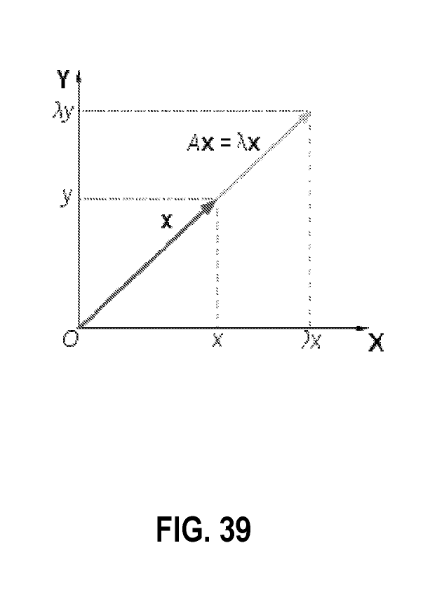

FIG. 38 is a graph illustrative of an eigenvector x and Matrix A.

Then, the system may identify the max height of trees. A good value for max height of trees may be determined by fixing the number of active variables to square root of the feature vector size and successively trying 2ⁿ as max tree height, resulting in outcomes, such as 2, 4, 8, 16, 32, 64 . . . .

Max height may be fixed as the best height determined above and then another sequential search for best active variable counts may be implemented by training a Random Forest with 3, 6, 12 . . . , which is the feature vector length divided by 2. The final random forest result may be trained with best parameters derived as above.

In another embodiment, the system may implement the feature vector calculations as shown below:

Feature Vector:

Step 1=>(Frame i−45, Frame i−44 . . . . Frame i)=>Polynomial motion approximation=>A floating point array (Feature Vector)
Step 2=>i takes the value from 1- to −number of frames, however no feature vector is generated for i<=45.
Step 3=>In the example 139 was an instance value of i to explain what previous 45 frames mean.

Set 1 of 45 Frames and Set 2 of 15 Frames:

When preparing the feature vector, motion is approximated in past 45 frame window to capture slow moving gestures, and also in past 15 frames to capture fast moving gestures. So to break down the feature vector preparation step shown above in further detailed manner (Each step changes the data from previous step into the form given in this step).

Then:

Step 1: (Frame i−45, Frame i−44, . . . Frame i)

Step 2: =>(Frame i−45, Frame i−44, . . . Frame i)+Frame (i−15, Frame i−14, . . . Frame i)

Step 3=>Polynomial approximation of joint motions in past 45 frames+Polynomial approximation of motion in past 15 frames

Step 4=>A floating point array for past 45 frame motion+A floating point array for past 15 frame motion

Step 5=>concatenation of both arrays

Step 6=>A single floating point array (Feature Vector)

### E. Non-Contact, Hardware-Free Display Interface Using Gesture Data

In some aspects, the present disclosure also relates to systems and methods that enable a user to remotely interface with a display screen without using making any physical contact with the display and without using any hardware to interface with the display. In brief overview, the above discussed gesture data may be used to identify movements of the user as the user is pointing to a particular feature on a display. For example, gesture data stored in a database may correspond to a user pointing at a particular feature on a display screen. A machine may have already gone through the process of learning the gesture data for identifying various actions of the user. For example, the gesture data stored in the database of the system may include the gesture data corresponding to the acts in which the user selects particular features on a display screen, moves particular feature from a first location to a second location on a screen, opens a window or closes a window on the screen, opens a link and closes a link, opens a page or closes a page, grabs an object or releases the object, zooms in or zooms out of a particular picture, page or a frame and more. Specific hand signals of the user may be learned by the system to recognize particular sign specific commands, such as the turn on or turn off signals, wake up or go to sleep signals or selection signals. The database may also include any additional gesture data for any particular action which is known in the arts today which the user may perform on a screen including browsing through the menu, opening and closing files, folders, opening email or web pages, opening or closing applications, using application buttons or features, playing video games and more.

In addition to the above identified gesture data, the gesture data features may also include gesture data of positions of each of the five fingers on each of the hands of the user. For example, in one embodiment, the gesture data may identify the locations or positions of each of the five fingers of a person's hand with respect to a particular point, such as a person's palm or a wrist of the same hand. In another example, the gesture data may identify the locations of each of the five fingers and the palm or the wrist of the person, each with respect to a different body part, such as the waist of the person. In one example, a user may point at a particular section of the projected display and the pointing movement may be identified as the selection movement. The pointing movement may include pointing with a single finger, with two, three or four fingers or with a whole hand. Open and closed fist may indicate a particular action, such as open the selected feature for an open fist or close the selected feature for a contracted or tightened fist.

In some embodiments, the gesture data may identify locations of the tips of each of the five fingers. In addition to any of the above identified gesture data features, these palm or hand directed data features may enable the system to identify particular hand gestures which the user may use to indicate the request to open a particular link, close a particular advertisement, move a particular icon, zoom into a particular picture, zoom out of a particular document, or select particular software function to implement. In some embodiments, the system may be configured such that any number of hand, arm or body gestures are learned to enable the user to send specific commands using her hand gestures, body gestures, arm gestures to implement various types of functions on a selected display feature.

In one aspect, in addition to the gesture data matching algorithm, the system may further comprise an algorithm for identifying the exact coordinates on the display to which the user is pointing. In some embodiments, the system uses the algorithm for gesture data matching to identify locations on the screen to which the user is pointing. In other embodiments, a separate algorithm is used for identifying the exact location to which the user is pointing. The algorithm may use the directions and/or positions of the user's fingers, wrists, elbows and shoulders to identify the location on the display to which the user is pointing. The algorithm may also use the position and/or location of the user's eyes to identify the section of the display to which the user is pointing or the user of the screen in which the user is interest.

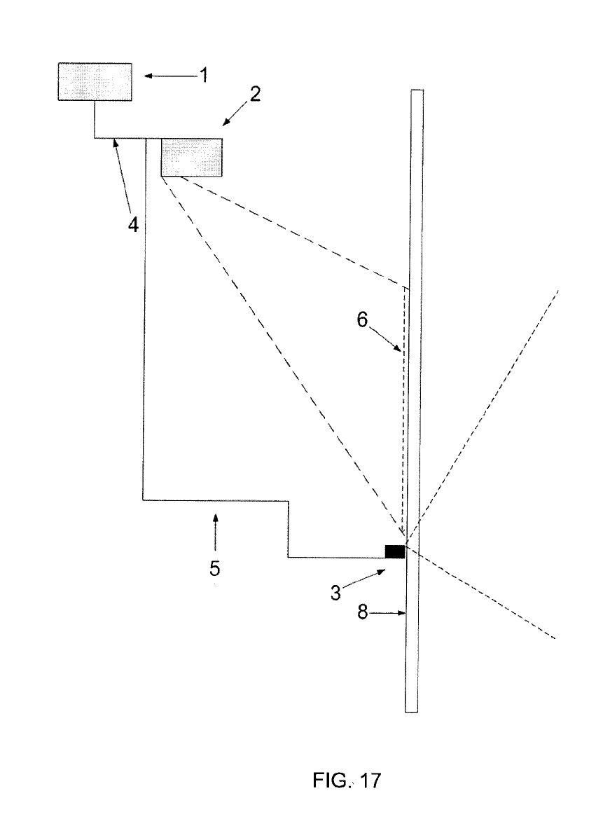

Referring now to FIG. 17, an embodiment of a system for providing non-contact, hardware free display interface is presented. In a brief overview, a device may be deployed behind a glass panel 8 which may be used to display the image projected from projector 2. The projected area 6 is presented as a dotted line to represent the area covered. A sensor camera 3 is located under the projected area and is connected to the host computer 1. This camera sensor may track both hand and head gestures and calculate where the user who is being recorded by the camera is looking towards a feature on a display and pointing to it. This camera sensor may also include or be connected with a device that extrapolates gesture data from the incoming recorded frames of the user. The data may be transmitted to the computer 1 via a cable represented by number 5. When a user is looking and pointing at one area of the display the host computer 1 may use the gesture data stored previously stored in a database to search and find a particular gesture data that matches the newly extrapolated gesture data of the user standing in the camera sensor's field of view. Once the extrapolated gesture data is matched against the stored gesture data within a substantial threshold for each one of the gesture data features in the gesture data frames, the host computer 1 may determine that the user's movement or selection is equivalent to a particular selection described by the stored gesture data from the database. The host computer may then further utilize additional data from the camera sensor recorded frames to identify the exact locations where the user is pointing in order to identify the areas selected. The host computer 1 may then change the projected image via a link represented by number 4. The user has the ability to select from 20 different areas by simply looking and pointing at what they would like to select. In some embodiments, the user has the ability to select from any number of different areas, such as 5, 10, 15, 25, 30, 40, 50, 60, 70, 80, 100, 120, 140, 180, 200, 250, 300, 350, 400 or any number of areas of the display which the user may select.

In some examples of the above described embodiments, the user may point towards a particular advertisement projected on a store window. The graphical image projected onto the store window may be an image of a computing unit, such as a live image of a computer display. The camera sensor recording the user may identify that the user is pointing to the particular advertisement by matching the gesture data being extrapolated from the live feed recording the user to the gesture data stored in a database. Should an algorithm determine that there is a substantial match between the user's extrapolated gesture data set and a gesture data of a movement of the user pointing at a display. The system may also determine the exact location on the store window projected display at which the user is pointing. The system may therefore determine that the user is selecting the advertisement at which the user is pointing.

Alternatively, the system may be set up such that upon identifying the particular advertisement at which the user is pointing, the system further awaits for an additional body movement of the person, such as a more directed pointing at the same advertisement, a particular hand signal with respect to the advertisement, a sign to open the advertisement, a thumbs up, or a wave, any of which may identify the user's intention to open the advertisement projected on the window store display. The camera sensor may record this movement using the same gesture data technique as described above and determine that the user is wants to select and open the particular feature. Upon determining the user's selection, the system may command the projector to project onto the store window the graphical representation of the opening of the advertisement. The advertisement may lead to a web page with additional advertisement information, such as the price of the article being advertised, a video to be played corresponding to the article advertised or any other advertisement related material which may be displayed.

Similarly, depending on the settings, the system may be set up to project a computer display onto a wall of a conference room. The projected display may be a display from a laptop. The user may point at a link for a particular presentation. Using the gesture data matching techniques described above, the system may open the presentation. The user may then give the presentation by controlling the presentation displayed such that the hand gestures of the user are used by the system to determine the signals to open a new presentation slide, move onto the next slide, move to a previous slide, zoom into particular graphs or similar actions. Each hand gesture may be unique to a particular command. For example, one hand gesture, such as pointing, may indicate that the user wants to select a particular feature or a section of the display. Another hand gesture, such as for example two extended fingers up, or a thumbs up, may indicate that the user intends to open the selected feature or window. Another hand gesture, such as a hand wave or a thumbs down, may indicate that the user wants to close the selected feature or window.

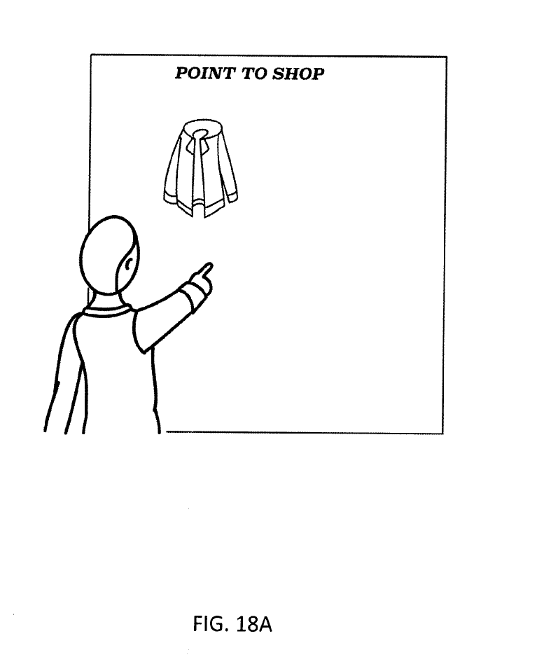

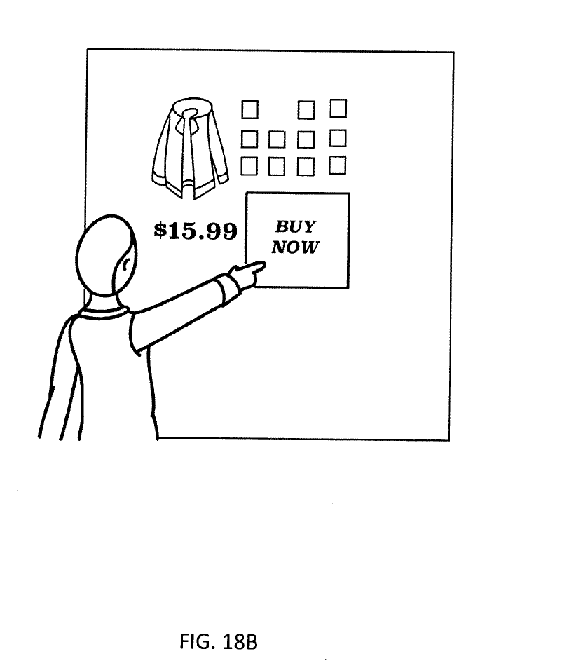

Referring now to FIGS. 18A and 18B, an embodiment of the systems and methods is illustrated as deployed and used on a store window. In brief overview, a user passing by a store window may notice a projected message on a window of the screen. FIG. 18A illustrates a store window on which a projected message reads “point to shop”. The user may decide to point at the message. The system utilizing the gesture data extrapolated via the camera recording the user in real time may identify via a gesture data matching technique described earlier that the user is pointing at the message. In response to the determination, the system component, such as the server 200 or the client device 100 may send a command the projector to update the projected display such that the link associated with the message is displayed. As illustrated in FIG. 18B, the projector may then open a window in which the user may view a selection of goods, such as articles of clothing for example, which the user may select and get informed about the prices. The user may keep selecting and opening different links displayed on the store window until the user decides to buy an article in the store or decides to simply leave.

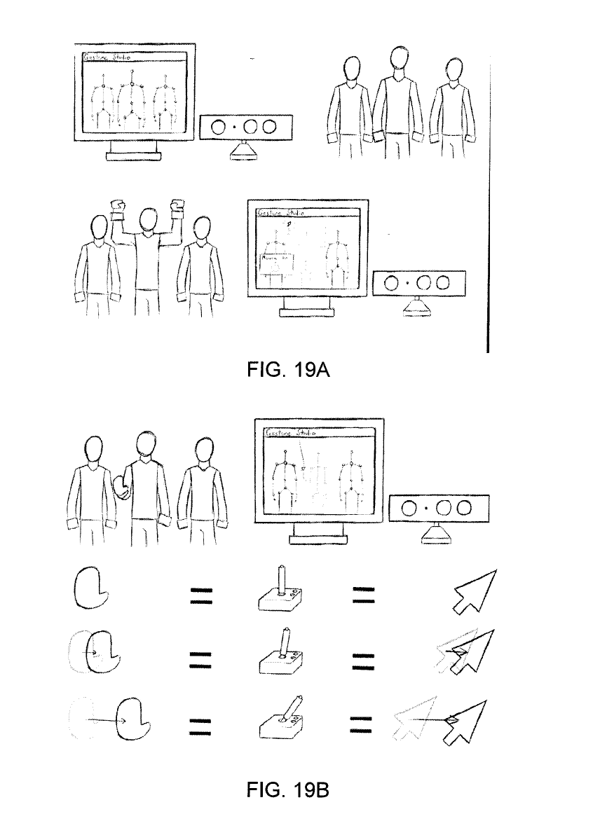

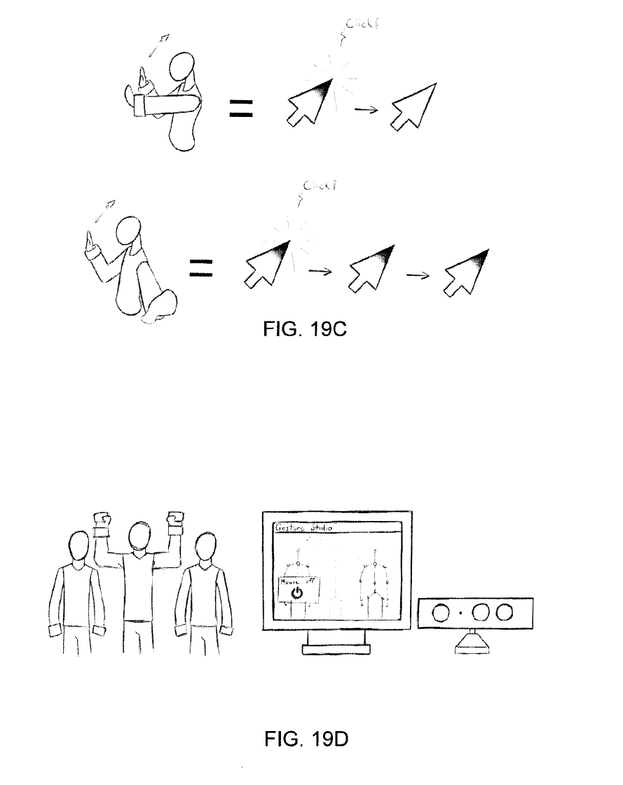

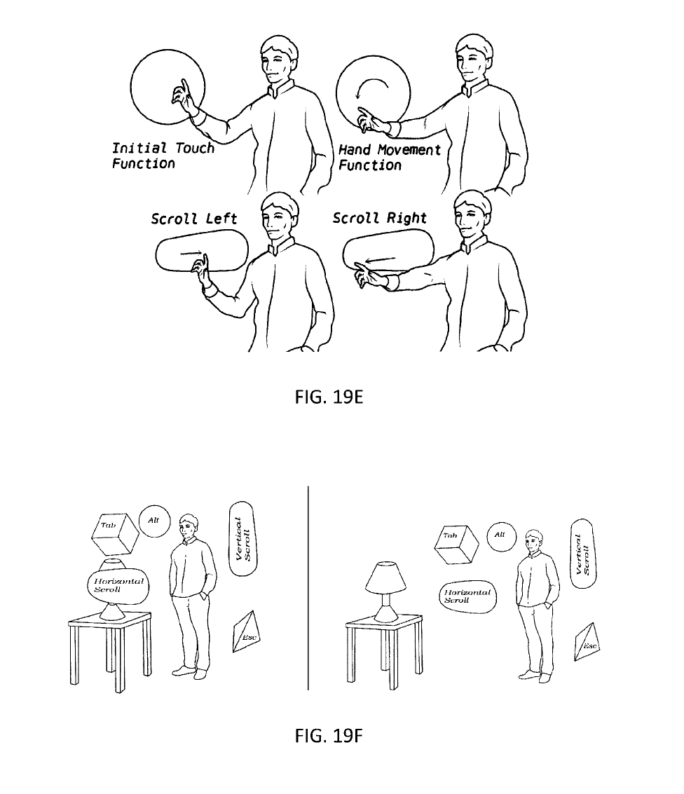

In some aspects, the present disclosure relates to systems and methods of directing a mouse using a non-contact, hardware free interface. Referring now to FIG. 19A, a group of users standing in a camera detector 105 view is illustrated. The top portion of the FIG. 19A shows the users illustrated on the right hand side and the gesture data captured by the detector 105 in accordance with the aforementioned techniques displayed on the monitor on the left side of the top part of FIG. 19A. Gesture data points illustrate locations of joints, though the data may also be illustrated using the aforementioned joint velocity, joint angles and angle velocities.

The bottom part of FIG. 19A shows one of the users raising his arms, such that both arms make right angles with respect to the shoulders. This particular motion may be configured to mean that the mouse is now turned on, and that this particular user will be directing the mouse. This motion for activating the mouse may therefore be assigned a particular meaning and a function to turn the mouse function on. Upon recognizing the gesture illustrated in the bottom of FIG. 19A, the system may identify and determine that the mouse gesture has been detected. In response to this identification of the gesture and the determination that the given gesture is a “mouse on” gesture, the system may trigger a function to turn on the mouse function.

The mouse function may enable a mouse to be displayed on the projected surface with which the users are interacting. The user that has identified the mouse function may then be assigned the mouse functionality enabling this user to operate the mouse.

FIG. 19B illustrates the user that has activated the mouse now further operating the mouse. The movement of the user with his right hand towards the right side slowly may trigger a slow movement of the mouse to the right. Similarly, a faster movement of the user towards the right side may correspond to a faster movement to the right. In some embodiments, the user may use a left hand instead of the right. The user may move the mouse left or right, up or down to select any projected image or object.

The top portion of FIG. 19C illustrates the user gesturing a “mouse click on” gesture or motion. The “mouse click on” motion may involve any gesture which the user may perform, such as for example the left hand of the user extended forward. Upon identifying and determining that the user has performed the “mouse click on” gesture, the system may perform the mouse click function on the particular location on which the user has previously placed the mouse. In some embodiments, instead of the click gesture, the user's movement illustrated in top portion of FIG. 19C may be any movement which causes the system to click down onto a mouse button, without releasing the button. The mouse click function may involve selecting the particular location on the projected display screen.

The bottom part of FIG. 19C illustrates the user gesturing a “mouse click off” gesture or motion. The “mouse click off” motion may involve any gesture which the user may perform, such as for example the left hand of the user extended left away from the body. The “mouse click off” gesture may be done by the user once the user has performed a “mouse click on” gesture and dragged a particular object to a location in which the user wants to implement a “mouse click off”. For example, the user may utilize the mouse click on and off gestures to click onto an object and to drag the object to a specific folder or a location, such as for example a store “cart” such as the virtual shopping carts in web pages selling goods on the internet.

Once the user has completed the functions using the mouse, as illustrated in FIG. 19D, the user may perform the “mouse off” gesture to indicate to the system that the user is no longer controlling the mouse. In response to recognizing the gesture by the user, the system may turn off the mouse function.

Referring now to FIG. 19E, the system may enable a user to operate various user movement objects. For example, FIG. 19E illustrates four different gestures, each referring to a separate action which the user may command in order to operate user movement objects. In brief overview, the top left gesture in FIG. 19E shows a user in a field of view of a detector 105, such as a camera touching an area which corresponds to an “initial touch function”. The user movement object, in this case, is the area within which the user may touch in order to gain control over an operation. The initial touch function area may be an area which the system simply assigns with respect to a position of the user, and which moves together with the user. Alternatively, the initial touch function area may be an area which is stationary area. Initial touch function area may be displayed on a projected screen, and the user may see it and direct her hand towards the initial touch function area and perform a “touch” movement with his/her hand in order to initiate a function. The initial function area may then trigger a function that turns on the functionality for the user to operate a mouse, perform hand movements, scroll left, right, up or down.

The right top gesture of the FIG. 19E shows the user using user movement object of the hand movement function. The hand movement function may enable the user to move a mouse or a selector across the projected screen. In one embodiment, the user may use a mouse across the store window to select particular objects on the store window.

The left and right bottom gestures correspond to scroll left and scroll right user movement objects, respectively, and pertain to the user's ability to scroll through various displayed objects by scrolling. The hand movement to the left may indicate the scroll to left, while the hand movement to the right may indicate the scroll to the right. It may be obvious to one of ordinary skill in the art, that any different movement may be assigned a scroll movement, just as it may be assigned a mouse click movements or any other movement. Similarly, the user may be given an option to scroll up or down.

Referring now to FIG. 19F, the left side drawing illustrates the user standing in a room, whereas the right side drawing illustrates the user given the option to operate various user movement objects. The left hand part of FIG. 19F drawing shows the user as recorded in reality. The right hand part of FIG. 19F drawing shows the user surrounded by virtual user movement objects which the system provides to enable the user to operate various functions on the projected screen or display. The user may simply touch the virtual area, such that the system recognizes the movement of the user's hand onto the particular given area to trigger the particular function of the user movement object. As illustrated, user movement objects of FIG. 19F include a “tab” user movement object, which may perform the same function as tab key on a computer keyboard, “alt” user movement object, which may perform the same function as alt key on a computer keyboard, and “esc” user movement object which may perform the same function as “esc” key on the computer keyboard. In addition, the user may also be provided with user movement objects of vertical scroll and horizontal scroll. By placing his/her hand on any of these virtual objects, the user may activate the user movement objects and may operate any of the mouse, scroll, tab, alt and escape functions which the user may be able to use on a personal computer.

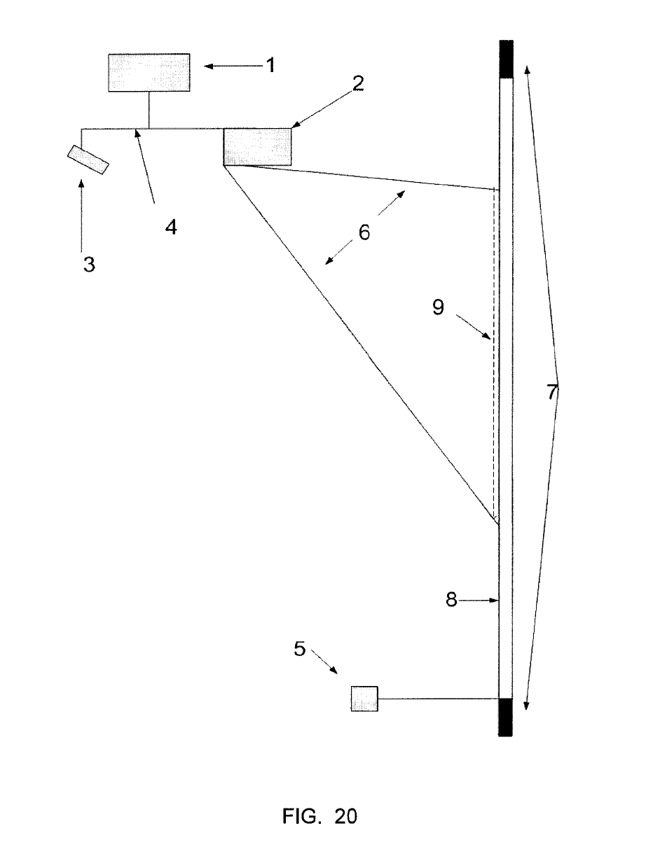

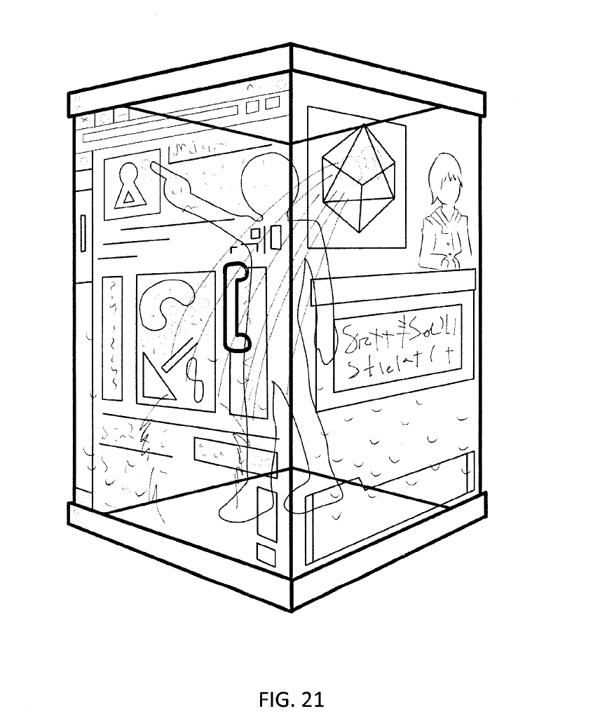

Referring now to FIGS. 20 and 21, an aspect of the present disclosure relating to systems and methods for providing a new medium for information in the form of an interactive display unit inside a modern shower installation is illustrated. The shower, such as the shower displayed in FIG. 21, may comprise shower walls which may be made out of any material, including glass and onto which a projector may project video features, thereby forming a display on the walls of the shower with which then the user may interface. FIG. 20 illustrates a block diagram of an embodiment of a non-contact, hardware free display interface system installed inside the shower. The user inside a shower may use the interface and control a video screen using the above-described gesture data based techniques. A camera sensor may be installed inside the shower to enable or provide extrapolation of the gesture data from the user in the shower. Information can be digested as well as shared while inside or outside a shower. For example, a user may be using a shower and may be able to interact with a video feed projected onto the one or more walls of the shower using the gesture data matching technology. As a projector projects the video feed onto the wall of the shower, the system may identify movements of the user matching particular machine learned movements stored in the database as the gesture data to identify that the user is pointing to and/or selecting a particular feature on the display. The system may then update the screen to reflect the user's selections. The user may therefore be able to use the present non-contact and hardware-free display interface technology to access the internet, view, read and write emails, and access any web page, any application on a device or use any software that might otherwise be accessible via a personal laptop computer or a tablet.

Referring now to FIG. 20 and FIG. 21 in a greater detail, the system device is deployed in or around a shower. Similarly, the system device may be deployed in front of any surface which may be used as a screen for a projected image, such as a wall, a window, a piece of fabric inside of a room, or outside on the street. In one example, some features of the system are surrounded by a smart glass panel 8 which may be used to display the image projected from the projector 2 which is located behind the smart glass window 5. The lasers 7 may be projected from under and over the smart glass 8 from the top and bottom of the screen and may cover the projected area 9 (drawn as dotted lines to represent the area covered) to create a multi-touch surface on the window 8. Window 8 can be made of glass or plastic and may be covered with an anti-fog coating to prevent fogging and ensure a visible image. A camera 3 which may be connected to a host computer 1 via a connection represented by 4 may be attached on the ceiling in front of the smart glass window. The camera may detect when the screen is touched or when the user points to a particular feature on the screen. The camera or another component of the system may use the live feed of the user from the camera to identify and send this pointing or selection information to the host computer 1. Projector 2 which may also be connected to the host computer 1 via connection 4 may project information onto the smart glass 8. The smart glass may be activated by switch number 5 which may be directly connected to the glass. When the switch 5 is active the glass 8 may be fully polarized and opaque and when it is deactivated by switch 5 the glass may appear to be transparent.

In one embodiment, after the user enters the shower the user may touch or activate a particular sensor or a switch to activate the display. In some embodiments, the user may touch a resistive/capacitive touch sensor on the glass wall of the shower to activate the display. The user may then be able to use an infrared pen to interact with the display by simply moving the pen over the glass to move the cursor and pressing against the glass to click. In other embodiments, the user may point to the glass without touching it. An infrared camera, attached to the device may be configured to detect the location of the pen on the glass using the above identified gesture date matching. If the projector is projecting onto the shower door, there may be a switch attached to the shower to detect whether the door is closed before projecting to ensure the projector will not attempt to project onto the user. The projector may be positioned inside or outside of the shower to ensure a clear line of sight which will not be intercepted by the user. Similarly, the camera sensor may be positioned at a particular location that ensures correct and accurate view of the user.

### F. Systems and Methods of Adjusting Gesture Recognition Sensitivity

Referring now back to FIG. 8A, an embodiment of a gesture data set that may be used for sensitivity adjustments is illustrated. For example, FIG. 8A shows a data set which may be used for recognizing a particular gesture. For example, the system such as the remote client device 100 or a crowdsourcing system 200, illustrated in FIGS. 2 and 3, may include a software interface that enables the user to modify or configure the sensitivity of the recognition for one or more gestures. The system may include the interface which may be taught or programmed to recognize a particular gesture or a movement at any range of sensitivities and using any number of frames of gesture data. The user interface may include various range options and settings for the user to specify the number of frames to be used, to select which frames to be used, to average frames of data and select the threshold values. As illustrated in FIG. 8A, in one instance, the gesture data may include around 300 frames and each frame may include multitude joint data points, such as for example, right foot, right knee, left wrist, left hand, and more. The system may be configured or adjusted to use different sizes of data sets to recognize the gesture.

For example, in some embodiments, a gesture may be recognized with a great accuracy using a set of 300 frames of data. In such instances, sensitivity may be increased. For a specific application, a user may need to recognize the gesture rather more quickly, despite any possible trade-offs between the speed of the recognition and accuracy, due to the fact that sometimes more frames of data in a recognition data set may result in a higher overall accuracy of the recognition.

In one example in which the user may need a faster recognition, the sensitivity may be reduced and a fewer than 300 frames may be used. For example, a subset of 10 frames of gesture data may be used for a quicker recognition, or even just a single frame. In some embodiments, the reduced data set may include any one of 3, 5, 7, 10, 15, 20, 30, 50, 70, 90, 120, 150 or 200 frames. In other embodiments, a user may need to maximize the sensitivity to increase the accuracy of the prediction. In such instances, the system may use a larger set of gesture data which may include 350, 400, 600, 800, 1000, 1500, 2000, 3000 or even 5000 gesture data frames. Based on the user's desire to prioritize accuracy or speed, the user may configure the sensitivity of the system to utilize a larger or a smaller subset of the gesture data, respectively. Therefore, when a user wants to maximize the accuracy, the system may use a larger subset of gesture data frames or a larger number of data frames to recognize a gesture or a movement. Similarly, when a user wants to maximize the speed, the system may use a smaller subset of gesture data frames or a smaller number of data frames to recognize the gesture or a movement.

When a system is learning a gesture, the system may configure the gesture data to allow the user to use the particular data for a particular gesture either to maximize the speed or accuracy. For example, a particular gesture data may include a total set of 30 frames of gesture data. While configuring the learned gesture data, the system may enable any range of sensitivities or speeds to be utilized during the recognition phase. The speed at which the gesture is to recognized may be adjusted by the number of frames of gesture data that may be used. For example, if the system is using 30 frames to make a guess instead of just one, the system may divide the 30 frames into 3 sets of 10. In such an example, the system may select a first set of 10 frames, then a second set of 10 frames and then a third set of 10 frames, and create average frames for each of the three sets. This way, the system may utilize several versions of the frame average, one for each of the three sets. The system may then average the averages of each of three sets to create the final average result frame representing the particular gesture. The system may then create the thresholds using this one single final average result frame. If, for example, the threshold is set to 2% from each of the gesture data value points within the final average result frame, the system would be able to identify a gesture based on only a single result. This methodology may sometimes result in a reduced accuracy of the gesture detection. However, it may be useful for recognizing gestures where a speedy recognition and identification is most important.

Alternatively, when the importance is placed on accuracy and not on the speed of the recognition, the system may simply utilize all 30 frames to recognize the gesture. In additional embodiments, the system may operate by recognizing gestures using a single average result frame first, and then follow up by checking if the match of the single average result frame also correspond to the corresponding larger gesture data set, such as all 30 frames in this instance. This way the system may quickly identify a gesture, and then go back and double check if that gesture is really correct using a more accurate, larger, data set.

### G. Systems and Methods of Improving Detection by Personalization of Gesture Data

In some aspects, the present disclosure relates to systems and methods for personalization and customization of the database gesture samples. Database gesture samples may refer to gesture data sets stored in a database which may then be used to be compared against the incoming newly generated gesture data frames which represent the gestures that the system need to identify. The system may identify the gestures represented by the newly generated gesture data by comparing the database gesture samples (also referred to as the gesture data sets) against the new gesture data sets of the incoming data.

Personalization or personal customization of the gesture samples stored in the database may be done by the system in order to modify the gesture samples such that they are more suited to the user for whom they're intended. In other words, if a gesture sample includes a gesture data set comprising frames of data representing a user pointing a finger at a direction, upon determining that the subject implements the same function slightly differently, the system may modify the gesture sample to more closely resemble this movement or pose by the subject. Therefore, as the system observes movements of the subject and identifies that the subject's movement vary slightly from the gesture samples stored in the database, the system may modify the gesture sample to more closely mimic the way the subject does that specific movement.

A personalization function may comprise the functionality to determine the differences between the gesture sample stored in the database and the newly acquired gesture data representing the subject's movements. The personalization function may, in response to the determination that there are the differences and in response to identifying what those differences are, modify the gesture samples in the database to more closely resemble the subject's movements.

In one example, the system may record and observe the subject walking down the street. Upon correctly identifying the movement and determining that the subject is walking, the system may identify changes between some GDFs of the gesture samples in the database and the GDFs from the newly generated gesture data representing the subject walking. These slight changes in some entries may include changes or differences, such as for example the differences in the GDF entries of the right elbow in the Y axis, or the GDF entry of the left knee in the Z direction, or the GDF entry of the right shoulder, etc. These slight changes in GDF entries between the gesture sample stored in the database and the newly generated gesture data may provide signature for more accurately identifying the walk of this particular subject in the future.

In some embodiments, the gesture sample may be replaced or updated with the new gesture sample such that the gesture sample for walking is modified to more accurately suit this particular subject. In other embodiments, the original gesture sample may be maintained and not replaced in the database, but instead the new gesture sample may be added to the database to help identify this specific way of walking in addition to the original walking gesture sample data set. The system may then be able to identify not only that a subject is walking, but also that a particular subject is walking, all based on the subject's walk patterns. In other words, the system may then, during the process of identifying a movement of the same subject in the future, identify the subject himself by his specific walking pattern. As most people walk in a unique manner, this specific subclass of walking that may be stored in the database may enable the system to identify a particular individual among a group of individuals.

In some embodiments, the system may determine that the subject is walking by comparing the newly generated gesture data of the subject's walking movement with the gesture sample stored in the database. The system may determine that some GDFs of the gesture sample are slightly different from the GDFs of the newly generated gesture data using variance analysis or comparing average GDF entries and determining that a few entries are substantially different. In response to such a determination, the system may modify the gesture samples stored in the database to correct those GDFs in order to personalize the gesture samples to more closely resemble the movements and gestures of the subject.

In another embodiment, a subject may be recorded by the system while running. The system may first correctly identify that the subject is running using the methodology described above. However, in addition to this determination, the system may also determine that the running motion of the subject differs in terms of some GDF entries with the running gesture sample in the database. Personalization function may then identify the GDF entries in the matrices of the gesture sample frames which need to be modified and modify those gesture sample frames to more closely suit the subject recorded. Then, the personalization function may either replace the original running gesture sample with the newly created, modified, running gesture sample, or alternatively, the personalization function may leave the original running gesture sample in the database and simply add an additional running gesture sample, personalized to this particular subject's way of running.

Determination with respect to which GDF entries inside the frames to modify may be done based on any number of thresholds. In some embodiments, personalization function may use variance thresholds to identify which GDFs to modify. In such instances, a mean and variance for each particular GDF entry through the frame set of the gesture sample may be determined. Alternatively, a mean and variance for each particular GDF entry through the frame set of the newly generated gesture data set may be determined. Personalization function may then determine which GDF entries fall a sufficient amount outside of the variance range. In one embodiment, personalization function may set the threshold at two sigma. In such an embodiment, all GDF entries whose variance from the mean (the mean of the GDF entry from either the gesture sample from database or the newly generated gesture data set) is greater than two sigma (or two standard deviations away from the mean), may be replaced by the new GDFs from the new gesture data set. Naturally, the threshold of two sigma may be replaced by any variance threshold value that may any multiple or fraction of sigma, including: ⅛ sigma, ¼ sigma, ½ sigma, ¾ sigma, 1 sigma, 1.5 sigma, 2 sigma, 2.5 sigma, 3 sigma, 4 sigma, 6 sigma or 10 sigma. Once the GDF values outside of the variance range are identified and modified and/or replaced, the newly generated gesture sample may be stored in the database.

### H. Systems and Methods of Detecting Interpersonal Interaction Using Gesture Data

In some aspects, the present disclosure relates to systems and methods of detecting interpersonal interaction between subjects. Utilizing the aforementioned techniques, the present disclosure may identify movements or gestures of two or more individuals simultaneously. The movement or gesture detection may be implemented using self-referenced, or anchored, gesture data sets. Since the present disclosure detects movements and gestures using a relatively small set of data samples, e.g only several GDFs corresponding to joints and/or other particular locations of the human body, the processing resources used for the herein described determinations may be much less demanding than the processing power of other conventional gesture movement detection systems. Because of this advantage in terms of using smaller data sets which improves the processing speed, the presently described systems and methods may simultaneously determine multiple gestures and movements.

In one embodiment, a camera extrapolating gesture data, such as the detector 105 of a device 100 or server 200, may be recording an area in which multiple subjects are located. The camera may record and acquire a sequence of frames of gesture data and from these acquired frames the system may further extrapolate gesture data sets for each individual subject in the camera's field of view. Since the present technology relies on GDFs corresponding to joints and particular portions of the human body, the system may simply increase scale up to accommodate all of the subjects in addition to the first subject. Accordingly, regardless of how many subjects the camera records, the system may use multiple instances of the above identified concepts to simultaneously determine gestures of multiple subjects. Therefore, if the camera has acquired 100 frames of gesture data while recording four individuals, the system may extrapolate four separate sets of gesture data each comprising a 100 frames. Alternatively, the system may extrapolate a single set of gesture data in which all four subjects will be processed and distinguished from one another.

The system may then use the Random Forest Selection methodology to identify the movements and/or gestures of each of the subjects substantially simultaneously. The system may then employ an interpersonal interaction function (IIF) to determine the nature of the interaction, if any, between the four subjects recorded.

Interpersonal interaction function (IIF) may comprise any functionality having one or more algorithms for utilizing the recognized gestures to between two or more subjects to determine the nature of the interaction of the subjects. IIF may utilize the database storing gesture samples as well as a separate, additional database storing gesture samples of interpersonal interaction. IIF may then, upon identifying gesture movements or motion of each subjects individually, further determine their movements or motions as a group.

In one example, upon determining by a system that subject 1 is punching, while subject 2 is ducking down, the IIF may determine based on these two individual actions of the two subjects as well as their approximation and position with respect to each other that the two subjects are involved in a fight. In another example, upon determining that subject 1 is running towards point A and that subject 2 is also running towards the same point A, IIF may determine that both subjects are running towards the same point. Based on other movements of the subjects, as well as the location of the point A, the IIF may further determine that both subjects are running after a ball while playing soccer. In another example, upon determining that subject 1 is talking and that subject two has turned towards a side, the IIF may determine in response to the locations and orientations of the subject 1 and subject 2 that subject 1 has said something to subject 2 and that subject 2 has turned towards subject 1 in response to the said words from subject 1.

As shown in these brief examples, IIF may utilize the previously discussed gesture detection functions to provide another layer of gesture detection, i.e. gesture interaction between two or more subjects simultaneously recorded by the camera. In some embodiments, IIF may conduct these determinations based on frames of two subjects from two separate cameras.

In one aspect, the present disclosure relates to systems and methods of detecting cheating at a casino gaming table. For example, the system may be programmed to include data sets pertaining to various gestures and movements that are indicative of cheating at a game in a casino, such as a card game, or a roulette game, or any other game. The system described herein may utilize gesture data of joints or human body parts to observe behavior or movement of players at a casino gaming table. Gesture data may be customized to also include positions of eye pupils to indicate locations towards which the user is looking. Gesture data locations of human pupils may be referenced with respect to a human nose, or a point between human eyes, to more accurately portray the direction at which the object is looking. Gesture data may also be customized to include human hands, including each of the finger tips and tips of the thumbs on each hand. The locations of the finger tips and thumb tips may be done in reference to another portion of a hand, such as a palm, or a joint such as a wrist of that particular hand. Gesture data may further include the mid sections of the fingers, underneath the tips, thereby more accurately portraying the motions or gestures of the human hands. Gesture data may also include the aforementioned joints or human body parts, such as those described by FIG. 8A.

Using the techniques described herein, the system, such as the device 100 or a server 200, may utilize a camera, such as a detector 105, to view multiple players at a gaming table simultaneously. Gesture data may then be extrapolated and the gesture data of each of the players may be processed individually with respect to the learned gesture data stored in the database 220. Sensitivity of the detection or recognition may be adjusted to more quickly or more accurately focus on any particular motion or a movement of a casino gaming player.

A further configuration of the system may be done to allow the system to count and keep a track of locations of non-human objects, such as the chips on the casino gaming table. For example, the system may be configured to identify and recognize a casino chip, as well as to keep track of the amount of chips in front of a player. Should a player suddenly and illegally remove chips from the pile, the system would be able to recognize the motion of the user, as well as identify that the chips are now missing.

Referring now to FIG. 22, an embodiment of a frame of data captured by a camera detector 105 filming a casino gaming table is illustrated. In brief overview, in this embodiment the system is already taught gestures and motions. The system may now include a database which is filled with numerous gesture data sets for identifying motions and gestures. The system may keep processing the incoming stream of frames of data, checking the extrapolated gesture data between the players to see if the players are interacting. The system may also identify if the players are looking at each other, if they are looking at other players, if they are turned towards each other or other players, if they are signaling by hands or shoulders or body postures. The system may therefore observe the behavior and movement of the players bodies, hands, eyes and even lips to see if the players are making any verbal statements. Gesture data may be configured to also include data points for upper and lower lip, which may be anchored or referenced to another part of a body, such as a nose or chin for example. In such instances, gesture data may include multiple reference points, not only one. In such instance, gesture data, such as the one described in FIG. 8A may be referenced with respect to a body waist point, while the gesture data for hands may be referenced by another anchor point, such as a wrist or a palm. Similarly, gesture data for lips and eyes, or eye pupils, may be referenced to another anchor point, such as a nose. Therefore, gesture data may include one or more reference points.

Referring back to FIG. 22, a frame of data recorded by a camera detector 105 captures four players at a casino gaming table. The captured data records the four players sitting and playing a card game along with a set of chips on the table. The captured data may record the players' lips positions and eye pupil positions with respect to a reference point, and further record hand movements, shoulder movements and movements of other body parts. Since the gesture data in this instance does not care particularly for the positions of body below the waist, the gesture data may be compressed using PJVA to remove gesture data points below the waist as they would not be particularly useful. Similarly, the system may also use PCA compression as well.

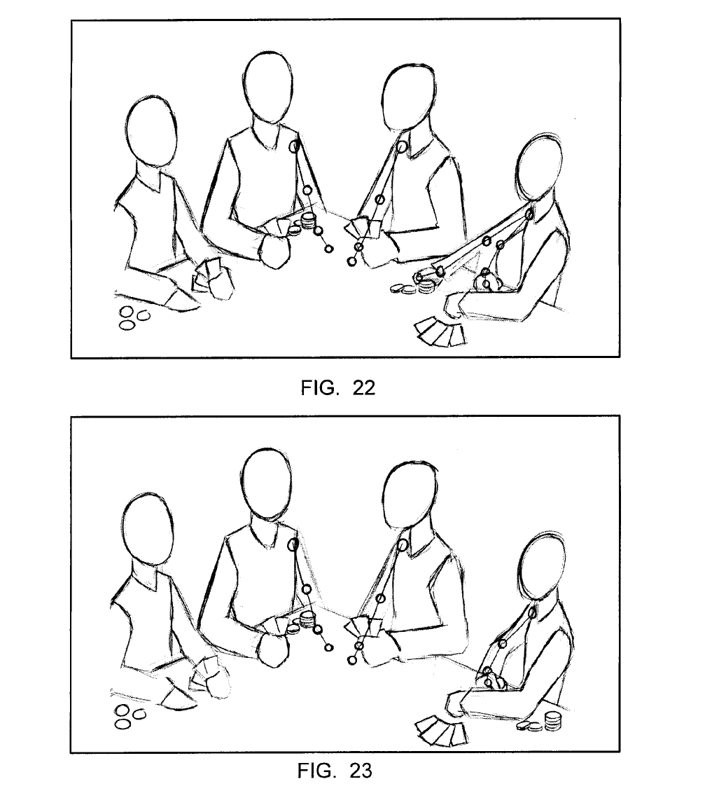

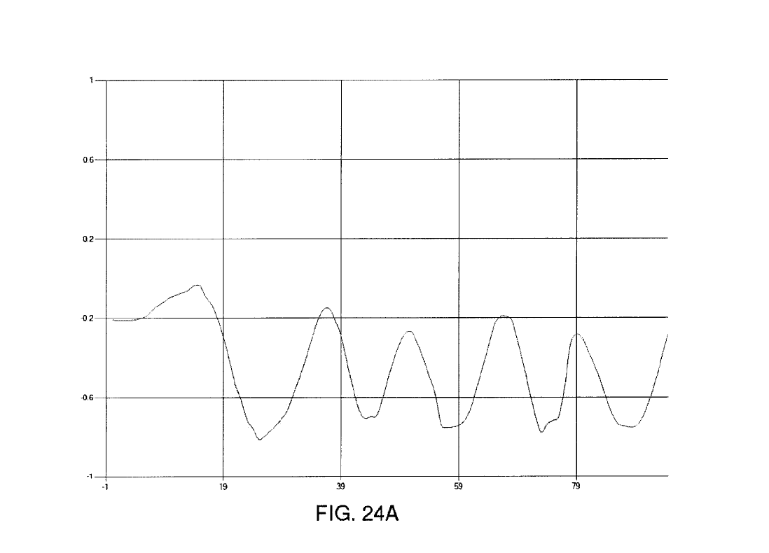

Referring now at FIG. 23, a frame of data recorded by camera detector 105 captures the four players where the rightmost player has removed the chips from the table. Gesture data from the captured frames may be matched by the system to the movement of grabbing and pulling the chips from the table and determine that the rightmost player has pulled the chips towards himself. This particular example illustrates the kinds of determinations that the system may implement in a casino.

Similarly, the system may identify other more interactive motions, such as the players waving to each other, hand signaling, hand shaking, approaching the chips, approaching the cards, holding the cards or any other movement or gesture which the casino may be interested in monitoring at a gaming table.

### I. Systems and Methods of Distributing Gesture Data Samples Via a Web Page

Present disclosure further relates to systems and methods of distributing, via a webpage, gesture data samples to be stored in the gesture sample databases. Gesture data samples may comprise gesture data sets of a learned movement which users may simply download via a web page and download into their own database. As the users are populating their databases with the gesture data samples, the user's systems may be able to recognize more and more movements or gestures.

In a brief overview, a web page may comprise a number of gesture movements expressed as either animated gif files, video files, flash animation or any other type and form of motion depiction that can be expressed on a web page. Users may wish to download a number of gesture data samples to populate their own individual databases to be able to recognize more gestures using their own systems. Such users may access the web page of the present disclosure and simply download the gesture data samples by clicking on them and downloading them. The web page may comprise a whole library of gestures samples. Each gesture sample may include a link to a gesture sample comprising a number of gesture data frames, each comprising GDFs that can be used to identify a particular movement or gesture by a subject.

The users may be able to click and download the whole gesture samples, individual frames of gesture data, variable number of frames or any selection of gesture data they want. In some embodiments, users download more than one version or more than one sample of the whole gesture. Range of frames may be between 40 and 10000, such as for example 45, 50, 75, 100, 150, 200, 250, 300, 350, 400, 450, 500, 600, 700, 800, 900, 1000, 2000, 3000, 5000, 7000, and 1000 frames.

In some embodiments, gesture data sets may include PCA collapsed gesture data samples, PJVA compressed gesture data samples, SFMV compressed samples or any other type and form of gesture data set described herein. In some embodiments, gesture data samples available for download include a set of 500 consecutive frames. In other embodiments, gesture data samples include a set of 45 frames with the last 15 frames repeated for a total set of 60 frames. In further embodiments, gesture data samples available on the web page include a continuum of 60 frames of gesture data.

Web page may comprise the functionality to remove a whole frame or one or more frames, enabling the user to select the frames which the user wants to include into the gesture data sample. The frames may be edited to appear consecutive after editing, even if some frames were taken out during the editing process.

Autoremove feature or function may be included in the functionality of the website to automatically remove a frame in a succession of frames upon determining that the frame includes an error. For example, autoremove function may remove a frame of data that includes erroneous artifacts. Autoremove function may remove a frame that includes unwanted subjects. In such instances the unwanted gesture data may be erased from the frames by the autoremove function either automatically or with a user's control and selection. Autoremove function may be automated, and therefore implement these function without any input or interaction from a user, or it may be semi-automated, enabling the user to control which actions to take and in what manner.

Removal may be suggested to the user or automatically implemented by the function of the web page if a body portion of the subject is not visible. In one embodiment, if a subject is partially or wholly removed from the viewing angle, the function of the web page may produce an error. The error may result in automatic deletion of the erring frame or in an error message to the user alerting the user of the issue.

Web page may organize gestures into particular families of gestures to make more available for different kinds of users. In one example, dancing gestures may be organized into a single group enabling the users interested in dancing games to view and download dancing gestures in a single collection. In another example, aggressive gestures may be organized into a single group to enable users interested in recognizing aggressive behavior to download the relevant gestures. For example, a web page may enable a prison security guard to access the web page and download a series of gesture data samples helping the security person to use the cameras of the prison system to extrapolate gestures and movements that may resemble fights or security issues. A similar classification of other families of gestures and movements may be grouped and made available in a clear and easily researchable format on the web site.

### J. Systems and Methods of Preparing Gesture Samples Using a Software Application

Present disclosure further relates to systems and methods of preparing gesture samples using a software application or a software function. Gesture samples, which may then be used to detect and recognize movements or gestures of subjects, may be created by an application which may be called Gesture Studio. Gesture Studio, also referred to as the GS, may comprise hardware, software and a combination of hardware and software for creating, refining and modifying complete gesture sample sets that can then simply be stored into a database and used by the recognizing functions to detect and identify motions, gestures and movements of one or more subjects.

Gesture Studio may be used in any step of the process of recording a movement, selecting gesture data features to be used to represent the movement and/or editing the gesture data during the creating or refinement of the gesture sample. GS may include software functions for neatly trimming the gesture data. Gesture Studio may include a user interface for enabling sensitivity adjustments, for editing gesture data and adjusting thresholds for each gesture, frame or gesture data point within any of the frames. Gesture data may be deleted or modified in the GS. Gesture data features in X, Y, Z or time dimension may be changed and modified to more accurately represent a motion, gesture or a movement. Gesture studio may enable a user to pick a reference point or the anchoring point to which the gesture data will be anchored. In some embodiments, the user may pick that for a particular gesture sample, a GDF of a waist of the user is selected as anchoring point with respect to which all the GDFs are described as vectors. An example of this is further described in FIGS. 10A-C. Gesture Studio may also enable a user to use any of the compression or processing functions described herein, including the PCA, PJVA, SMFV or other compression or enhancing functions. Gesture studio may enable the user to establish and set any threshold described herein, including any thresholds that may be used for PCA, PJVA and/or SFMV. Gesture Studio may work in conjunction with a learning algorithm and may send that gesture data set to be learned by the learning algorithm.

In some embodiments, gesture studio may comprise all functionality described herein for learning to recognize the gesture from gesture data. Gesture studio may operate on a personal computer as a specialized and installed software, and on any processing device, such as a server. Gesture studio may include the functionality for automatically trimming, modifying or deleting erroneous gesture data or gesture data frames. Gesture Studio may also allow for the integration of the recognizer file that the cloud produces to be attached to code triggers. Currently Gesture Studio may be a desktop app, but it can may also be deployed via website.

In brief overview, Gesture studio may be used as follows:

A user may mark a position on the floor where a camera, such as a Kinect camera, may detect a body of a subject without intersecting with the line of sight. Then, Gesture Studio may enable the user to select custom tracking if specific points of the body (i.e. gesture data features) are especially important, or more important than others. Gesture studio may then allow the user to “start recording” or “Record” to begin capturing the movement or gesture via the camera. In some embodiments, a button for recording may show up on a computer screen, which upon pressing may trigger the recording operation. In some embodiments, repeating the gesture several times increases accuracy as the Gesture Studio may acquire additional frames of gesture data. Gesture studio may enable a user to stop the capture mode and stop recording.

Gesture studio may also include the functionality for removing undesired frames from the gesture sample set. Gesture studio may also include an auto-remove function for eliminating the erroneous or bad frames of gesture data. Gesture studio may include the function to enable the user to name a gesture and save it as a file. Gestures with same or similar names may be grouped together by the GS. Gesture studio may also produce an animated gif or a video illustrating the motion or movement or gesture represented by the saved gesture sample. Gesture studio may also provide a window showing the GDFs through frames, enabling the user to observe the relative locations and positions of each of the GDFs on the screen. Gesture studio may also provide a window comprising the matrices of gesture data for each of the frames or through time. Gesture studio may also enable the user to view and/or edit any of the entries in the feature matrix, including the GDF entries, polynomial constants and any entries of the gesture data matrices described herein.

Gesture studio may provide any number of gesture data samples for a particular movement or a gesture. In some embodiments, the GS may provide a minimum of 2, 3 or 5 gesture data samples. The provided gesture data samples may include anywhere between 10 and 10,000 frames of gesture data. In some embodiments, gesture data samples include 45 frames, 100 frames, 200 frames, 300 frames or 500 frames of gesture data.

User may pick and choose which gestures to record, edit and send to system to learn and store in a database. Gesture identification may be shown in a color, such as for example red. Gesture studio function may enable the user to easily assign keyboard and/or mouse keys to learned gestures or specific functions which the user may use during the process. Gesture studio may be operated individually or in conjunction with a video game using gesture movements. User may therefore teach the game the gesture movements in real time, while playing the game. Gesture Studio may be deployed online as a component of the web page described above. The GS may be implemented as a function of the web page, in flash, java or javascript. Gesture studio may be accessed by the users via their web browser, and the users may use their individual personal computer's video cameras or the cameras from mobile devices to record a gesture or a movement to teach and process via the gesture studio. Users may upload videos of themselves or others to process using the Gesture Studio via their web browsers.

### K. Systems and Methods of Compressing Gesture Data on Polynomial Approximation and Eigenvectors

The present disclosure also relates to systems and methods of compressing and/or improving gesture data processing using polynomial approximation.

Processing data from multiple frames may negatively affect the efficiency and speed of a machine learning process applied to gesture recognition. The machine learning process may be negatively affected due to numerous factors, such as inefficiencies caused by processing of non-gesture related data, processing gesture data corresponding to gestures of different lengths, and processing gesture data corresponding to gestures moving at different speeds. For example, a system attempting to learn left and/or right swipe hand gestures may process non-hand gesture related data, such as data related to leg joints that may occur in one or more frames. In some cases, 10-20 times more non-gesture related data may be processed.

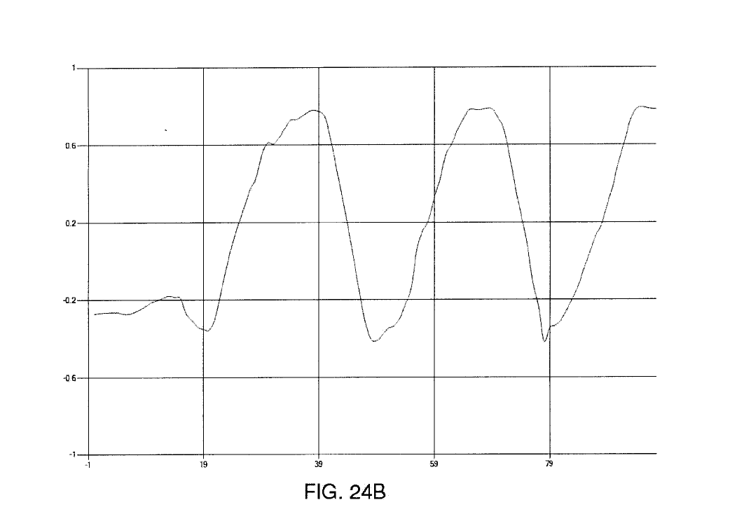

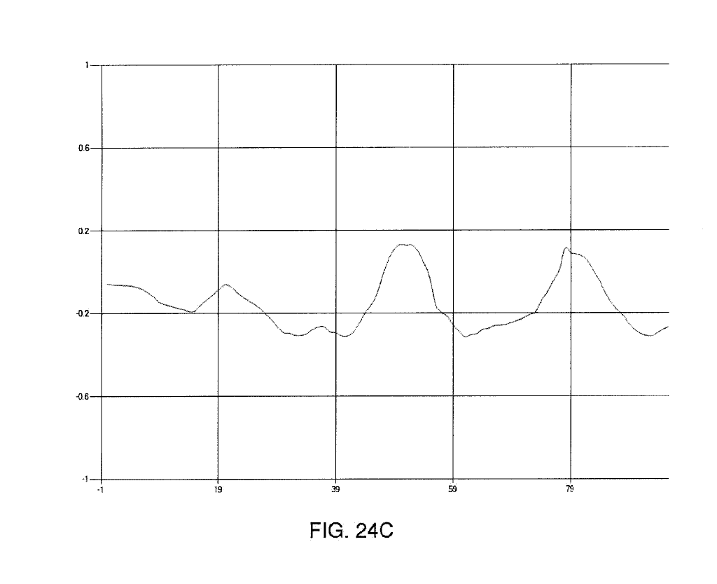

Embodiments of the present disclosure include methods and system for compressing or removing data so that more important data (e.g., data elements corresponding to each gesture) may be processed, improving speed and efficiency of processing, while maintaining accurate identification of gestures. As described above, embodiments may utilize PJVA, which is used to select and weigh relevant body parts and joints more than other body parts to improve speed and efficiency of processing. For example, FIGS. 24A, 24B and 24C are illustrations showing the 2-dimensional plots of left hand GJPs (excluding other body parts (e.g., legs)) of a user performing a jumping jack. A GJP can be a gesture joint point that refers to a single axis joint coordinate.

FIGS. 24A, 24B and 24C show the GJPs along the x-axis, y-axis and z-axis, respectively, as a function of time (t-axis). Rotation values, velocity and angular velocity may also be taken into account which is obtained from camera. This may be generated by the camera or extracted from the camera data.

As described above, the processing of gesture data corresponding to gestures of different lengths may also negatively affect the process of learning hand gestures. In some aspects, constants may be defined to maintain continuity of vector length when training and recognizing. Selecting a length that is too short may make it difficult to recognize the difference between similar gestures. Selecting a length that is too long, however, may result in difficulty recognizing fast or subtle gestures. To compromise, a gesture may be assumed to have two lengths (e.g., 900 GJPs (45 frames) and 300 GJPs (15 frames)). Embodiments may include other assumed length values and the length values may be assumed regardless of the varying sample lengths in a given gesture dataset. A vector matrix may be constructed beginning with the first 45 frames followed by the last 15 of the 45 as shown in Equation [5]. Although not implemented in the embodiments described herein, embodiments may include synthetically growing a database by advancing the position of i in Equation [5].

[Frame i−45,Frame i−44, . . . Frame i,Frame i−15,Frame i−14, . . . Frame i] Equation [5]

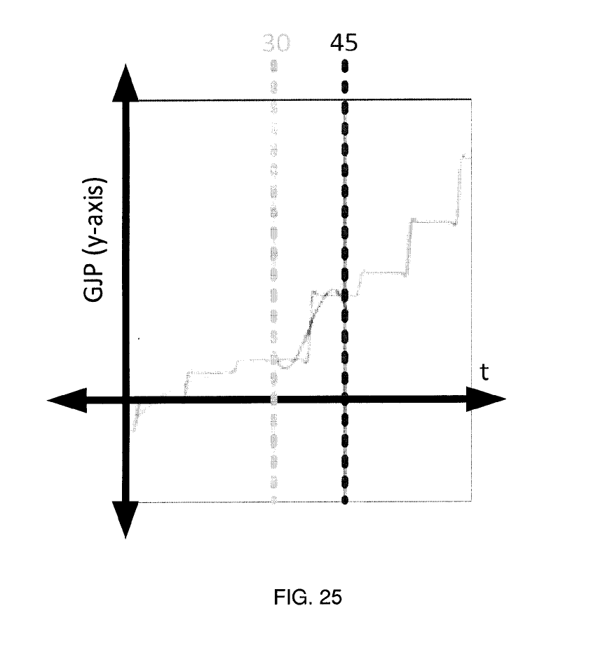

Processing the data from the sum of the two lengths (e.g., 1200 GJPs) may be inefficient. Accordingly, in some embodiments, the data may be reduced using polynomial approximation. Embodiments may, however, include methods other than polynomial approximation for reducing the data. FIG. 25 is an illustration showing left hand GJPs of a user performing a clapping gesture using third dimensional polynomials. FIG. 25 shows the left hand GJPs along the y-axis as a function of time.

In some embodiments, n-order polynomials may be used to approximate, fit and/or represent curves. For example a curve may be approximated using a number of points, or conversely, a curve may be fit onto a number of points. Such techniques may be useful for compression and/or interpolation, for example, where there is curve fitting of one axis of a joint. Curves may also be represented using a set of fewer points.

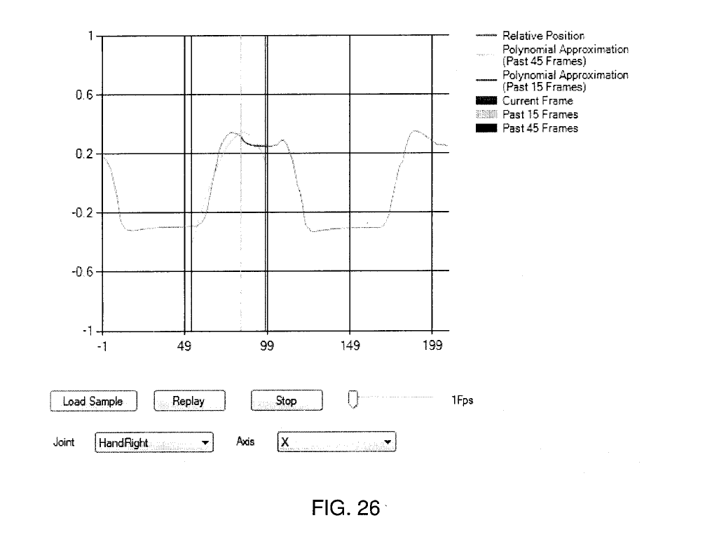

For example, first dimensional through fourth dimensional polynomials that may be used to reduce data. For example, by solving for a third dimension polynomial, the 45 frames and the 15 frames may each be reduced to 4 vectors. Accordingly, a larger number of GJPs (e.g., 1200 GJPs) may be reduced to a smaller number of GJPs (e.g., 160 Vector GJPs) or a 1×480 Vector Matrix. In some embodiments, 2nd degree polynomial, 3rd degree polynomial and 4th degree polynomial may be used to accurately represent the data. Embodiments may, however, include use of other degrees of polynomials to represent data. FIG. 26 is an illustration showing third dimensional polynomial approximation of 45 frames (approximately frame 53 to frame 98) and 15 frames (approximately frame 83 to frame 98) of an x-axis right hand GJP.

As described above, PCA may be used as a tool for dimensionality reduction (e.g., transforming a 3 dimensional matrix to a two dimensional matrix or a single dimensional matrix). The following further describes and illustrates exemplary embodiments that utilize PCA for dimensionality reduction. In some embodiments, PCA may find a linear project of high dimensional data into a low dimensional subspace such that the variance of the projected data is maximized and the least square reconstruction error is minimized. PCA may use an orthogonal transformation to convert a set of observations of possibly correlated variables into a set of values of linearly uncorrelated variables called principal components. For example, an exemplary method for transforming a N by d matrix X into a N by m matrix Y may include centralizing the data by subtracting the mean value of each column from each element of the column. The method may also include calculating a d by d covariance matrix using Equation [6]:

$$C = \frac{1}{N - 1} {X}^{T} X \qquad Equation [ 6 ]$$

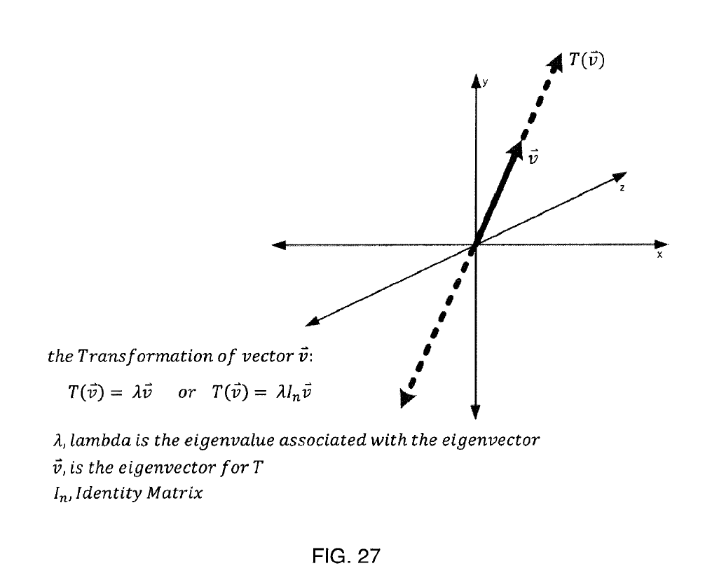

The method may further include calculating the Eigen vectors of the covariance matrix C and selecting m Eigen vectors that correspond to the largest m Eigen values to be the new basis. For example, FIG. 27 shows the transformation of vector \vec{ν}, according to the exemplary embodiment.

As described above, in some embodiments, PJVA may be used with PCA to provide dimensionality reduction. The following exemplary embodiment illustrates the use of PJVA with PCA for an N by 480 X-Matrix, where N is the number of gesture feature samples. Embodiments may, however, include other matrices having other values. For an N by 480 X-Matrix, each feature sample has 480 feature points. The feature sample may be derived by approximating temporal motion by 4 degree polynomials. Two types of time frames (e.g., 60 frames and 45 frames) may be used. Further, the exemplary embodiment includes 20 body joints (each body joint having 3 axis) and a 4^{th} degree polynomial, providing each feature vector with 480 feature points. Using the exemplary method described above, dimensionality may be reduced according to the following Equation [7]:

$$C = \frac{1}{N - 1} {X}^{T} X , \qquad Equation [ 7 ]$$

Cvᵢ=λᵢvᵢ

V=[v₁,v₂, . . . v₃₀],
X (N by 480) sample feature matrix is multiplied by V, to dimensionaly reduce X′ (N by 30)

In the exemplary embodiment, C is a 480 by 480 square matrix. Embodiments may, however, include matrices having other sizes. 30 Eigen vectors with the largest Eigen values are selected. Embodiments may, however, include selecting other numbers of Eigen vectors.

Table 6 shows examples of erroneous data from within a dataset comprised of 20 3-D joints from 30 people performing 12 different gestures moving through time. The data shown in FIG. 23 shows results from a total of 594 samples with a total of 719,359 frames and 6,244 gesture instances. In each sample, a subject repeatedly performed the gestures which are recorded at around 30 frames per second. The dataset can be used as a whole (12 Class Problem) or divided into: (i) iconic datasets that include data corresponding to iconic gestures that have a correspondence between the gesture and a reference; and (ii) metaphoric datasets that include data corresponding to metaphoric gestures that represent an abstract concept.

The data shown in Table 6 results from embodiments that include untrimmed data recordings that typically begin with blank data (zeros for each joint axis) followed by a person walking into position before beginning the instructed gesture. In these embodiments, the recordings also include persons walking out of camera view after the gesture is performed. The Joint positions are oriented from the perspective of the camera. In these embodiments, the gestures are labeled in the dataset. In some embodiments, however, the label may not represent the actions performed (i.e., right push sometimes is done with the left hand, or in some other cases the gesture). The error types shown in Table 6 may have an effect on the classification accuracy.

TABLE 6

| | Sample | | |
|---|---|---|---|
| Gesture | Id | Accuracy | Problem |
| G11_Beat_both | 40 | 0% | Wrong gesture. |
| | | | Kicking. |
| G5_Wind_it_up | 30 | 2.31% | Circular gesture |
| | | | with single hand. |
| G11_Beat_both | 33 | 7.38% | Random gesture. |
| G1_lift_outstretched_arms | 8 | 34.85% | No gesture in most |
| | | | of the frames. |

In some embodiment, one or more features may be extracted from gestures by taking polynomial approximation of motion of each joint along the 3 axis. To extract features, a sequence of N1 and N2 past frames may be taken, where N1>N2 and motion of each joint point is approximated by using a D degree polynomial. So overall the classification has a latency of N1. To reduce the noise and enhance the quality of features, PCA may be performed on extracted samples to account for variability. In some embodiments, numbers of first frames (e.g., 100 first frames) and numbers of last frames (e.g. 100 last frames) may be dropped from each sample to discard any redundant motions performed in the starting or end of recording.

In the exemplary embodiment described above, 80% of the samples were randomly selected to make the train set and 20% the test set. Other exemplary embodiments may include sampling any percentage of samples. The train set was further reduced to 200,000 feature vectors by sampling with replacement while keeping the number of samples of each gesture constant. Other exemplary embodiments may include reduction of any number of feature vectors.

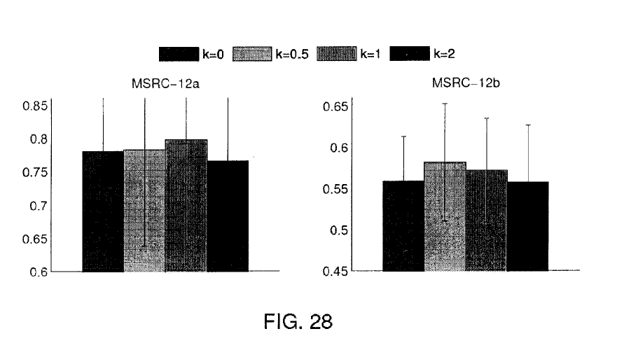

Accuracy of classifiers may be different depending on the number of samples. For example, higher percentages of test samples may produce higher classifier accuracies, while lower percentages of samples few samples may produce lower classifier accuracies. Accuracy percentages may be attributed to problems with the recorded gestures. For example, FIG. 28 is an illustration showing distribution of accuracy across different numbers of samples. The number of samples is shown on the x-axis of FIG. 28. The classification rate is shown on the y-axis of FIG. 28. A gesture (e.g. clapping) performed by one person may include a motion different from another person performing the same gesture, resulting in poor classification.

Other factors that may influence the classification accuracy may include difficulty of recognizing some gestures compared to other gestures. For example, Wind it up (G5), Lift outstretched arm (G1) and Beat both hands (G11) may each include motions that resemble other gestures and, therefore, include lower recognition accuracy. Beat both hands (G11) and lift outstretched arms (G1) both involve lifting of the arms above the head and bringing the arms down sideways. Accordingly, a low latency algorithm according to embodiments described herein may determine that both gestures are the same or similar, increasing the difficulty of determining a difference between the gestures without analyzing a larger window of action.

According to some embodiments, exemplary methods may include distributing a number of classes (e.g., 12 classes) into a lower number of classes (e.g., 2 6-class problems). Using a similar scaling approach (Song), the method may include: (i) evaluating the prior distribution sensitivity to learn with imbalanced data; (ii) comparing it to three baseline methods; (iii) learning with imbalanced data without using the distribution-sensitive prior (k=0); (iv) and learning with balanced data with random under sampling and random oversampling. The method may also determine the sensitivity of the classification performance to the degree k of the prior distribution sensitivity.

In some embodiments, the method may include using the α=1 version of the datasets to simulate highly imbalanced data. The method may include varying the degree k=[0 0.5 1 2] of our distribution-sensitive prior, where k=0 means no distribution-sensitive prior was used. In some aspects, under-sampling and oversampling may include setting the number of samples per class as the minimum (and the maximum) of NO y's and discarded (and duplicated) samples at random to make the sample distribution even.

The method may include validating the two hyper parameters of HCRF, the cardinality of the latent variables |H|=[6 8 10] and the L2 regularization factor σ2=[1 10 100]. The method may include, for each split and for each k, the optimal hyper parameter values based on the F1 score on the validation split. Embodiments may include performing 5-fold cross validation, and the L-BFGS optimization solver may be set to terminate after a number of iterations (e.g., 500 iterations).

FIG. 27 is an illustration showing the exemplary Song method on the dataset's 6-class classification problems. FIG. 28 shows results from Song 6-Class embodiments where the mean F1 scores as a function of k are obtained. Tables 7-10 below show results for iconic gestures without anchoring, results for metaphorical gestures without anchoring, results for iconic gestures with anchoring and results for metaphorical gestures with anchoring, respectively.

TABLE 7

| | G10_ | | | | | |
|---|---|---|---|---|---|---|
| | Change_ | G12_ | G2_ | G4_ | G6_ | G8_ |
| | weapon | Kick | Duck | Goggles | Shoot | Throw |
| G10_Change_ | 68.20% | 1.20% | 1.30% | 7.30% | 19.50% | 2.60% |
| weapon | | | | | | |
| G12_Kick | 0.40% | 91.80% | 4.90% | 0.90% | 0.10% | 1.90% |
| G2_Duck | 1.30% | 3.50% | 87.00% | 5.80% | 0.50% | 1.90% |
| G4_Goggles | 2.30% | 1.80% | 6.30% | 79.80% | 6.70% | 3.00% |
| G6_Shoot | 1.30% | 3.90% | 0.70% | 13.80% | 80.20% | 0.20% |
| G8_Throw | 2.40% | 19.20% | 2.30% | 0.70% | 0.70% | 74.70% |

Overall: 80.45%

TABLE 8

| | G11_ | | G3_ | G5_ | | |
|---|---|---|---|---|---|---|
| | Beat_ | G1_ | Push_ | Wind_ | G7_ | G9_ |
| | both | LOA | Right | it_up | Bow | HE |
| G11_Beat_both | 33.60% | 23.70% | 2.20% | 12.80% | 1.90% | 25.70% |
| G1_LOA | 23.10% | 47.60% | 5.20% | 14.60% | 2.20% | 7.20% |
| G3_Push_Right | 8.80% | 1.10% | 64.50% | 13.50% | 6.20% | 5.90% |
| G5_Wind_it_up | 19.60% | 11.30% | 3.90% | 49.90% | 5.40% | 10.00% |
| G7_Bow | 6.40% | 4.30% | 5.30% | 2.80% | 77.00% | 4.20% |
| G9_HE | 20.70% | 11.50% | 0.30% | 4.60% | 1.80% | 61.20% |

Overall: 54.58%

TABLE 9

| | G10_ | | | | | |
|---|---|---|---|---|---|---|
| | Change_ | G12_ | G2_ | G4_ | G6_ | G8_ |
| | weapon | Kick | Duck | Goggles | Shoot | Throw |
| G10_Change_ | 79.70% | 0.40% | 3.20% | 1.20% | 9.10% | 6.40% |
| weapon | | | | | | |
| G12_Kick | 1.70% | 87.30% | 4.50% | 0.20% | 0.80% | 5.50% |
| G2_Duck | 0.90% | 7.00% | 86.70% | 1.30% | 2.90% | 1.10% |
| G4_Goggles | 1.90% | 0.30% | 5.50% | 88.40% | 3.40% | 0.40% |
| G6_Shoot | 6.90% | 1.10% | 1.30% | 9.00% | 80.40% | 1.20% |
| G8_Throw | 2.20% | 11.20% | 3.60% | 0.70% | 0.20% | 82.00% |

Overall: 84.42%

TABLE 10

| | G11_ | | G3_ | G5_ | | |
|---|---|---|---|---|---|---|
| | Beat_ | G1_ | Push_ | Wind_ | G7_ | G9_ |
| | both | LOA | Right | it_up | Bow | HE |
| G11_Beat_both | 51.50% | 22.60% | 0.10% | 12.70% | 2.80% | 10.20% |
| G1_LOA | 12.20% | 64.70% | 0.30% | 7.40% | 7.40% | 8.00% |
| G3_Push_Right | 1.00% | 1.70% | 78.40% | 10.20% | 8.20% | 0.50% |
| G5_Wind_it_up | 14.20% | 8.70% | 0.30% | 74.30% | 1.50% | 1.00% |
| G7_Bow | 1.20% | 3.70% | 1.60% | 5.80% | 87.40% | 0.20% |
| G9_HE | 17.80% | 7.30% | 0.10% | 4.10% | 0.90% | 69.80% |

Overall: 69.55%

The method may also include conforming the dataset to the framework in Equation [6]. Table 11 show higher accuracy results achieved with the data set using different samples. Table 11 shows results of the dataset, where N1, N2 are the past frame count, D is the Degree of fitted polynomial, V is Variability accounted for by the selected eigenvectors after PCA and EV count is the count of eigenvectors selected.

TABLE 11

| | | | | V (Eigen | Test |
|---|---|---|---|---|---|
| | N1 | N2 | D | vectors) | Accuracy |
| Random Forest, 200 Trees | 30 | 10 | 4 | .95 (18) | 76.79% |
| Random Forest, 200 Trees | 30 | 10 | 4 | .92 (14) | 69.87% |
| Random Forest, 200 Trees | 30 | 10 | 4 | .98 (30) | 74.73% |
| SVM, RBF Kernel, c = 1, | 30 | 10 | 4 | .95 (18) | 62.45% |
| Gamma = 9.25 | | | | | |
| Random Forest, 200 Trees, | 30 | 10 | 2 | .95 (26) | 71.81% |
| Random Forest, 200 Trees | 30 | 10 | 6 | .95 (26) | 63.91% |
| Random Forest, 200 Trees | 60 | 30 | 3 | .95 (22) | 79.09% |
| Random Forest, 200 Trees | 60 | 30 | 3 | .95 (17) | 74.75% |
| Not normalized data | | | | | |

Table 12 is a Confusion Matrix of the dataset 12-class with Anchoring. Table 13 is a Confusion Matrix of MRSC′12 12-class without Anchoring.

TABLE 12

| | G10 | G11 | G12 | G1 | G2 | G3 | G4 | G5 | G6 | G7 | G8 | G9 |
|---|---|---|---|---|---|---|---|---|---|---|---|---|
| G10 | 81.90% | 0.00% | 0.10% | 1.00% | 0.20% | 1.70% | 2.20% | 2.00% | 10.60% | 0.30% | 0.00% | 0.00% |
| G11 | 0.00% | 62.00% | 0.00% | 13.90% | 0.00% | 0.00% | 0.20% | 5.50% | 0.00% | 0.20% | 0.30% | 17.90% |
| G12 | 0.00% | 0.00% | 95.80% | 1.90% | 0.10% | 0.50% | 0.10% | 0.10% | 0.00% | 0.60% | 0.80% | 0.00% |
| G1 | 0.00% | 39.30% | 0.00% | 52.20% | 0.10% | 0.00% | 0.30% | 6.30% | 0.10% | 0.20% | 0.00% | 1.50% |
| G2 | 0.00% | 0.00% | 0.30% | 0.00% | 98.50% | 0.00% | 0.20% | 0.00% | 0.00% | 0.90% | 0.00% | 0.00% |
| G3 | 1.00% | 0.00% | 0.80% | 0.20% | 0.10% | 93.40% | 0.00% | 0.20% | 0.00% | 2.30% | 1.90% | 0.00% |
| G4 | 0.30% | 0.20% | 0.00% | 0.40% | 0.50% | 0.00% | 88.00% | 2.90% | 1.60% | 0.00% | 0.00% | 6.10% |
| G5 | 8.80% | 7.80% | 4.40% | 5.30% | 2.50% | 14.80% | 4.70% | 44.60% | 2.50% | 2.00% | 2.30% | 0.30% |
| G6 | 0.00% | 0.00% | 0.00% | 0.10% | 0.20% | 0.00% | 1.10% | 0.10% | 98.30% | 0.10% | 0.10% | 0.00% |
| G7 | 0.60% | 0.40% | 4.70% | 3.60% | 7.10% | 1.40% | 0.30% | 1.00% | 0.20% | 80.20% | 0.60% | 0.00% |
| G8 | 0.60% | 0.00% | 0.00% | 0.40% | 0.20% | 0.70% | 0.00% | 0.10% | 0.00% | 0.00% | 98.10% | 0.00% |
| G9 | 0.00% | 2.00% | 0.00% | 5.10% | 1.20% | 0.00% | 5.80% | 0.70% | 0.00% | 0.30% | 0.00% | 84.90% |

Overall:
81.49%

TABLE 13

| | G10 | G11 | G12 | G1 | G2 | G3 | G4 | G5 | G6 | G7 | G8 | G9 |
|---|---|---|---|---|---|---|---|---|---|---|---|---|
| G10 | 82.20% | 0.70% | 0.10% | 0.10% | 0.00% | 5.10% | 4.30% | 3.80% | 0.90% | 0.30% | 1.70% | 0.70% |
| G11 | 0.50% | 69.10% | 0.00% | 8.50% | 0.70% | 0.10% | 7.20% | 3.00% | 0.70% | 0.00% | 0.00% | 10.00% |
| G12 | 1.10% | 0.50% | 90.20% | 2.60% | 1.10% | 0.10% | 0.00% | 0.30% | 0.00% | 0.20% | 3.80% | 0.00% |
| G1 | 0.10% | 25.20% | 0.00% | 54.50% | 7.00% | 0.30% | 0.10% | 3.10% | 0.40% | 2.80% | 0.10% | 6.50% |
| G2 | 0.50% | 0.60% | 2.60% | 1.90% | 83.30% | 0.30% | 1.10% | 0.40% | 0.00% | 6.30% | 3.00% | 0.00% |
| G3 | 13.80% | 4.60% | 1.30% | 0.40% | 0.90% | 69.40% | 0.00% | 2.60% | 1.70% | 3.30% | 1.80% | 0.00% |
| G4 | 0.40% | 0.20% | 0.00% | 0.30% | 0.00% | 0.00% | 91.80% | 1.70% | 2.50% | 0.00% | 0.00% | 3.20% |
| G5 | 0.80% | 16.90% | 0.10% | 9.30% | 0.30% | 0.50% | 7.30% | 57.50% | 6.20% | 0.60% | 0.10% | 0.50% |
| G6 | 2.20% | 0.10% | 0.50% | 0.40% | 0.00% | 0.10% | 9.40% | 0.90% | 85.40% | 0.10% | 0.00% | 1.00% |
| G7 | 1.00% | 0.20% | 4.70% | 6.10% | 10.20% | 2.10% | 0.10% | 0.50% | 0.00% | 74.00% | 0.90% | 0.20% |
| G8 | 3.90% | 0.00% | 0.40% | 3.50% | 0.00% | 1.40% | 0.00% | 0.50% | 0.00% | 0.00% | 90.10% | 0.20% |
| G9 | 0.00% | 6.90% | 0.00% | 10.10% | 0.00% | 0.10% | 13.30% | 1.10% | 0.60% | 0.10% | 0.00% | 67.90% |
| | | | | | | | | | | | | Overall: |
| | | | | | | | | | | | | 76.28% |

In some embodiments, the method may include determining only two gesture lengths within the PJVA experiments and gestures (e.g., dance sequences) having length greater than a predetermined threshold length may not be accurately learned. The method may include determining that the dimensionality of the defined polynomial may affect the accuracy. The method may include determining that the tree length affects PJVA accuracy.

APPENDIX
=== Evaluation on test set ===
=== Summary ===

| | | |
|---|---|---|
| Correctly Classified Instances | 176641 | 98.9203% |
| Incorrectly Classified Instances | 1928 | 1.0797% |
| Kappa statistic | 0.9883 | |
| Mean absolute error | 0.0118 | |
| Root mean squared error | 0.0496 | |
| Relative absolute error | 11.9447% | |
| Root relative squared error | 22.3654% | |
| Total Number of Instances | 178569 | |

=== Detailed Accuracy By Class ===

| | TP Rate | FP Rate | Precision | Recall | F-Measure | ROC Area | Class |
|---|---|---|---|---|---|---|---|
| | 0.98 | 0.001 | 0.993 | 0.98 | 0.987 | 1 | AirGuitar |
| | 1 | 0 | 0.998 | 1 | 0.999 | 1 | Archery |
| | 1 | 0.003 | 0.959 | 1 | 0.979 | 1 | Baseball |
| | 0.972 | 0 | 1 | 0.972 | 0.986 | 1 | Boxing |
| | 0.925 | 0.001 | 0.98 | 0.925 | 0.952 | 1 | Celebration |
| | 0.997 | 0 | 0.997 | 0.997 | 0.997 | 1 | Chicken |
| | 0.995 | 0.002 | 0.982 | 0.995 | 0.989 | 1 | Clapping |
| | 0.999 | 0 | 0.992 | 0.999 | 0.995 | 1 | Crying |
| | 1 | 0 | 0.999 | 1 | 1 | 1 | Driving |
| | 0.993 | 0 | 0.995 | 0.993 | 0.994 | 1 | Elephant |
| | 0.994 | 0.001 | 0.967 | 0.994 | 0.98 | 1 | Football |
| | 0.985 | 0 | 0.991 | 0.985 | 0.988 | 1 | HeartAttack |
| | 0.982 | 0 | 0.998 | 0.982 | 0.99 | 1 | Laughing |
| | 0.992 | 0 | 0.988 | 0.992 | 0.99 | 1 | Monkey |
| | 0.994 | 0.002 | 0.911 | 0.994 | 0.951 | 1 | SkipRope |
| | 0.987 | 0 | 0.987 | 0.987 | 0.987 | 1 | Sleeping |
| | 0.981 | 0 | 1 | 0.981 | 0.99 | 1 | Swimming |
| | 0.999 | 0 | 0.991 | 0.999 | 0.995 | 1 | Titanic |
| | 0.999 | 0 | 0.999 | 0.999 | 0.999 | 1 | Zombie |
| Weighted Avg. | 0.989 | 0.001 | 0.989 | 0.989 | 0.989 | 1 | |

=== Confusion Matrix ===

| a | b | c | d | e | f | g | h | i | j | k | l | m | n | o | p |
|---|---|---|---|---|---|---|---|---|---|---|---|---|---|---|---|
| 20406 | 20 | 0 | 0 | 0 | 0 | 143 | 0 | 0 | 0 | 135 | 10 | 0 | 0 | 55 | 48 |
| 0 | 16903 | 0 | 0 | 0 | 0 | 0 | 0 | 0 | 0 | 0 | 0 | 0 | 0 | 0 | 0 |
| 0 | 0 | 10667 | 0 | 0 | 0 | 0 | 0 | 0 | 0 | 0 | 0 | 0 | 0 | 0 | 0 |
| 0 | 10 | 460 | 16502 | 0 | 0 | 0 | 0 | 0 | 0 | 0 | 0 | 0 | 0 | 0 | 0 |
| 106 | 0 | 0 | 0 | 6463 | 0 | 155 | 0 | 0 | 0 | 0 | 0 | 0 | 0 | 256 | 7 |
| 0 | 0 | 0 | 0 | 0 | 7115 | 0 | 0 | 0 | 0 | 0 | 0 | 0 | 0 | 15 | 0 |
| 0 | 0 | 0 | 0 | 76 | 0 | 16641 | 0 | 0 | 0 | 0 | 0 | 0 | 0 | 0 | 0 |
| 0 | 0 | 0 | 0 | 0 | 10 | 0 | 7728 | 0 | 0 | 0 | 0 | 0 | 0 | 0 | 0 |
| 0 | 0 | 0 | 0 | 0 | 0 | 0 | 0 | 22242 | 0 | 0 | 0 | 0 | 0 | 0 | 0 |
| 0 | 0 | 0 | 0 | 0 | 0 | 0 | 0 | 0 | 4370 | 5 | 0 | 5 | 0 | 0 | 0 |
| 0 | 0 | 0 | 0 | 0 | 0 | 0 | 0 | 0 | 0 | 4756 | 0 | 0 | 30 | 0 | 0 |
| 0 | 5 | 0 | 0 | 0 | 7 | 0 | 55 | 0 | 0 | 2 | 5088 | 5 | 5 | 0 | 0 |
| 20 | 0 | 0 | 0 | 10 | 5 | 0 | 0 | 20 | 0 | 0 | 5 | 5299 | 0 | 16 | 10 |
| 0 | 0 | 0 | 0 | 0 | 0 | 0 | 0 | 0 | 19 | 0 | 0 | 0 | 3133 | 0 | 0 |
| 5 | 0 | 0 | 0 | 5 | 0 | 5 | 0 | 0 | 5 | 0 | 0 | 0 | 0 | 3587 | 0 |
| 16 | 0 | 0 | 0 | 35 | 0 | 0 | 0 | 0 | 0 | 0 | 0 | 0 | 0 | 10 | 4776 |
| 0 | 0 | 0 | 0 | 0 | 0 | 0 | 10 | 0 | 0 | 20 | 10 | 0 | 4 | 0 | 0 |
| 0 | 0 | 0 | 0 | 0 | 0 | 0 | 0 | 0 | 0 | 0 | 0 | 0 | 0 | 0 | 0 |
| 0 | 0 | 0 | 0 | 0 | 0 | 0 | 0 | 0 | 0 | 0 | 18 | 0 | 0 | 0 | 0 |

### L. Monitoring System: Systems and Methods for Monitoring Body Movements Using Gesture Data Techniques

In one possible implementation of the invention, a system may be provided for monitoring activities of one or more individuals (“monitored individuals”), by using gesture recognition to detect particular movements of interest, logging these movements to a memory store, and analyzing these movements based on one or more parameters. The parameters may relate for example to detecting activity that is contrary to predetermined rules such as safety rules or rules of conduct for preventing theft of fraudulent activity.

The monitoring of activities may utilize various capture devices, such as cameras, accelerometers, gyroscopes, proximity sensors, etc.

The information captured may include position and movement data, such as data regarding the x, y and z components of one or more points. In some embodiments, other information may also be captured, such as angular position data (e.g., the angle at which a joint is bent), velocity data, rotation data, acceleration data, etc.

The present invention provides for the first time a motion monitoring system that can be deployed in a range of different types of environments or workplaces that can use gesture recognition to enable accurate monitoring of the activities of personnel, thereby promoting a range of business and human objectives such as improved safety or service, and reduction of undesirable activities such as theft or fraud. Significant human resources are normally invested in promoting such objectives, sometimes with less than optimal results. The motion monitoring system provides a cost effective means for improving results achieved in pursuit of these objectives.

The movements of interest may include for example hand movements of monitored individuals. In one particular aspect, the system may capture hand movement data, and analyze the hand movement data may be analyzed to detect behaviour indicative of theft or fraudulent activity.

In some embodiments, the movements of interest may include the movement of objects, such as chips, cards, markers, cash, money, stacks of cards, shufflers, equipment, etc. The movements of interest, for example, may be associated with a monitored individual. For example, the system may be configured to determine when a dealer lifts a stack of cards too high (possibly revealing a bottom card or perhaps indicative of potential fraud).

The system may include: (A) at least a capture device, such as various sensors including wearable accelerometers—or any suitable device capable of capturing location and/or movement data, placed so that the one or more monitored individuals are within the field of view of the camera; (B) a data storage device that stores video data from the camera; (C) an activities analyzer that includes a gesture recognition component, that is operable to analyze the video data to detect one or more gestures consistent with a series of gesture features of interest, based on indications of one or more monitored activities such as for example theft or fraudulent activity.

In some embodiments, there is provided various systems and methods for monitoring activities at a gaming venue, including one or more capture devices configured to capture gesture input data, each of the capture devices disposed so that one or more monitored individuals are within an operating range of the data capture device; and one or more electronic datastores configured to store a plurality of rules governing activities at the gaming venue; an activity analyzer comprising: a gesture recognition component configured to: receive gesture input data captured by the one or more capture devices; extract a plurality of sets of gesture data points from the captured gesture input data, each set corresponding to a point in time, and each gesture data point identifying a location of a body part of the one or more monitored individuals with respect to a reference point on the body of the one or more monitored individuals; identify one or more gestures of interest by processing the plurality of sets of gesture data points, the processing comprising comparing gesture data points between the plurality of sets of gesture data points; and a rules enforcement component configured to: determine when the one or more identified gestures of interest correspond to activity that contravenes one or more of the rules stored in the one or more electronic datastores.

In some embodiments, the system may be provided video data in real-time, near-real time, staggered and/or delayed. For example, the at least one camera may be configured to provide real-time video data for gesture detection.

As previously suggested, the system of the present invention can be adapted to monitor a range of activities, relevant to a range of different objectives. Certain gestures may be indicative of unsafe movements that may contribute for example to worker injury, in which case detection of such gestures may trigger removal of a worker from equipment, or identify the need for training. Other gestures may be indicative for example of undesirable interpersonal communications, which may be of interest in a service environment such as a bank. The present invention should not therefore be interpreted as being limited in any way for use for detecting theft or fraudulent activity, rather this is used as an example of operation of the invention.

Certain gestures may also be tracked to monitor to on-going performance and/or operation of one or more events. For example, the tracking of gestures may be utilized to track the number of hands dealt by a dealer, played by a player, etc.

The system may be configured to detect theft or fraudulent activity in a number of environments, where body movements by monitored individuals may be indicative of undesired activity, whether to detect theft or fraudulent activity or unsafe activity. Environments such as casinos, manufacturing facilities, diamond processing facilities and so on.

For example, these body movements indicative of undesired activity may be identified through the use of a rules enforcement component of the system having one or more stored rules, which may be configured to determine when the one or more identified gestures of interest correspond to activity that contravenes one or more of the rules. The rules enforcement component may, for example, include one or more electronic datastores (e.g., a database, a flat file). Examples of rules include rules describing thresholds for particular movements, movement bounds, angles of rotation, detection of signalling movements, rules regulating the velocity of movements, etc. Where a rule is found to be contravened, the system may be configured to send a notification, issue an alert, engage in further monitoring, flag the monitored individual, etc. These rules, in some embodiments, may involve external data, and/or data from other sensors. For example, a particular dealer may be flagged as a suspicious case, and a smaller movement/gesture threshold may be applied as a rule. In some embodiments, there may be a standard catalog of rules and/or movements that may be accessed and/or updated over time.

In the context of a gaming venue, such as a casino, monitored individuals may include various individuals, such as dealers, visitors, players, cashiers, service staff, security staff, supervisors, pit bosses, etc. In some embodiments, gestures detected for different monitored individuals may be analyzed together (e.g., to determine whether there is collusion, interpersonal discussions). For example, collusion may occur between a player and a dealer, between a cashier and a player, etc., or combinations thereof.

Gaming venues may include casinos, racetracks, sports betting venues, poker tables, bingo halls, etc.

In some embodiments, the systems and methods may be employed at venues other than gaming venues, such as airports, cashiers, banks, tellers, etc.

In some aspects, the present disclosure relates to systems and methods for monitoring movements of objects, such as for example casino chips, in an environment where they are routinely utilized by a person, such as a casino dealer at a casino table. One aspect of the invention consists of systems and methods for accurately tracking the dealer's hands and distinguishing if their palm is facing up or down using the aforementioned gesture data techniques. Furthermore, the present systems and methods may be used for monitoring if a dealer is stealing chips for example by detecting movements that are indicative of theft such as movements that are consistent with placement of chips into pockets of his or her uniform or in the sleeves of their shirt, hiding them in his or her hand or making any movements indicating misappropriation of the casino chips.

Casino dealers may be required by casino management to complete from time to time a “hand washing” routine, where they show their hands to the camera to clarify that they are not hiding any chips in their hands. In some cases, casino dealers may be required to hand wash after each interaction with the chip tray and/or when exiting the table. Presently disclosed systems and methods may be used to detect when a hand wash has occurred, as well as the rate per minute at which the dealer is completing hand washing. This can assist in improving the monitoring of casino dealers, and also making monitoring more efficient.

The gestures indicative of theft, fraud, etc., and also gestures related to handwashing, regular dealer activities, player activities, cashier activities, etc., may be set out using one or more rules. These rules may include, for example, a catalog of standard movements, predetermined movement thresholds (e.g., how much rotation, how far from an object or an individual, distance relative to body, how one touches one's body, the use of a clap signal, the use of hand signals).

The particular rules may be customized, for example, to provide for the threshold and/or gestures related to hand clearing (e.g., the angle of rotation), there may be custom thresholds (e.g., how far someone holds away an object, how often they touch something, where they touch it). For example, such an analysis may be helpful if a dealer or a player is using an adhesive to stick chips on to his/her body. The rules may define actions that can be done, cannot be done, thresholds, signaling movements, etc.

In some embodiments, data may be logged for analytics purposes, such as preparing reports linking various factors, such as dealer efficiency, body language, fatigue, linking events to gestures, etc.

In some embodiments, gestures indicative of nervousness may also be determined using a set of rules. For example, if a monitored individual is lying and develops a nervous tic where a particular gesture is repeated or is made, etc. Other subtle movements may also be captured and the subject of analysis.

In one implementation, a camera device may be positioned at an angle where the casino dealer can be seen, as well as the position at which casino dealer's hands can be seen while the casino dealer is operating at the casino table. The camera may be positioned in front of and above a dealer for example, such that it may see the dealer's upper body (above the table) as well as the dealer's hands and the table.

The foregoing is an example and other types of capture devices, such as accelerometers, gyroscopes, proximity sensors, etc., may also be utilized, each having a particular operating range. The operating range can be used for positioning the capture device to capture various aspects related to a particular monitored individual or individuals, or interaction with objects or other individuals.

The system may comprise a web based interface interconnected with the aforementioned system components to allow the collected data to be displayed and organized. A casino official may then be able to log into the system using a username and password. From the web based interface, the casino official may be able to access the real time information such as the current WPM (wash per minute) for each dealer at every table, current amount of chips at the table, as well as any suspicious moves that a dealer may have performed. This data may also be archived so that it can be accessed in the future.

In one aspect, the system of the present disclosure implements an algorithm that monitors the hands of the dealer. Gesture recognition of hands may be employed to monitor if the dealer, or a player, is holding a chip in his hand, which may be useful to determine an illegal action in the instances in which the player or the dealer should not be holding a chip.

The system may further include the algorithm for monitoring the entire body of the dealer, while also monitoring the hands. The body monitoring may utilize aforementioned gesture data techniques to detect if and when the dealer's hands reach or touch the pockets of their uniform. In such embodiments, various gestures of a dealer touching or approaching or reaching into a pocket of a uniform may be “learned” by the system. Such learned gestures may then be stored into a database and gesture data extracted from the camera looking at a dealer live may be compared against these stored gestures. When a substantial match is found, the system may determine that the dealer has touched, approached or reached into his pocket, depending on the gestures matched.

Associated video data may be brought to the attention of a manager for verification, whether in real time or whether placed in a queue of tickets to be monitored.

The system may be set up to alert the authorities when a particular event has taken place.

The system may also be set up to synchronize the gesture data monitoring with video monitoring, so that a video recording of the event detected by the gesture detection system may be replayed for confirmation.

In addition, the present disclosure is also directed at systems and methods of monitoring chips on the table using scales. A scale may be placed underneath the casino table, or underneath the area on which the chips are placed. The scale may take measurements during the time periods when no movement of the chips is done. For example, a dealer may and the players may place the chips on the table, upon seeing a particular gesture, a scale may read the weight and the system may determine, based on the weight, as well as the monitoring mechanism, the number of chips on the table. The weight reading may be done at a later point, to confirm that no chips were taken off of the table.

It is understood that the present embodiments, while most commonly discussed in terms of monitoring of casino dealers, may also be applied to other casino officials, workers, as well as to the players of the casino games.

The system may be initialized based on a gesture which a dealer may performing before starting the process of playing the casino game. This initialization gesture may be the gesture that resets the system, such that the system begins to watch the dealer's actions and begins tracking the dealer.

In a brief overview, the present disclosure relates to a system of monitoring of casino dealers using gesture data recognition techniques.

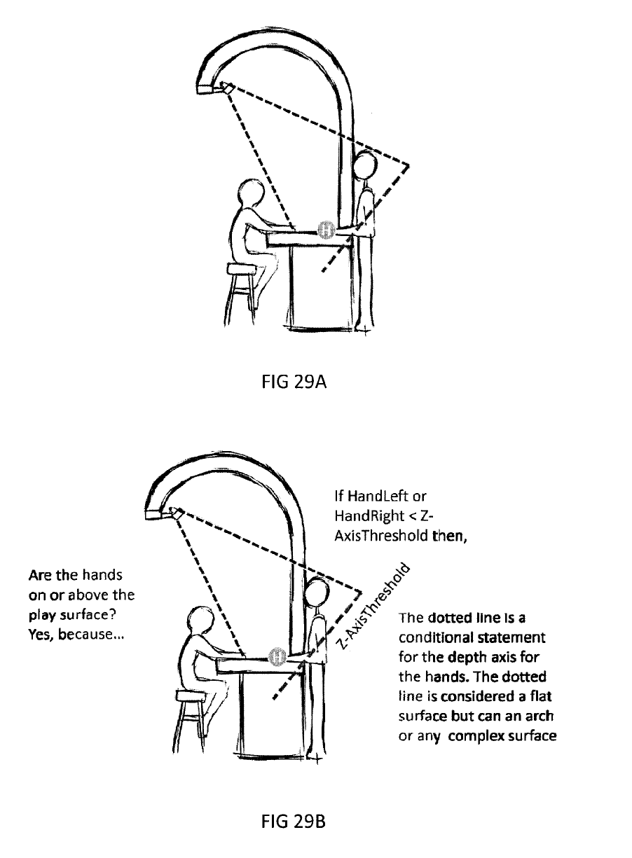

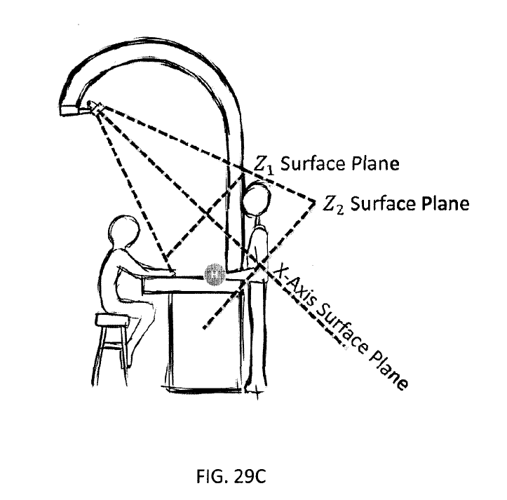

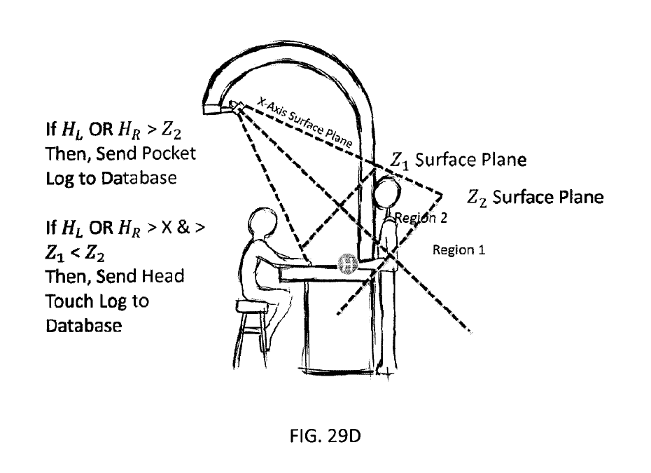

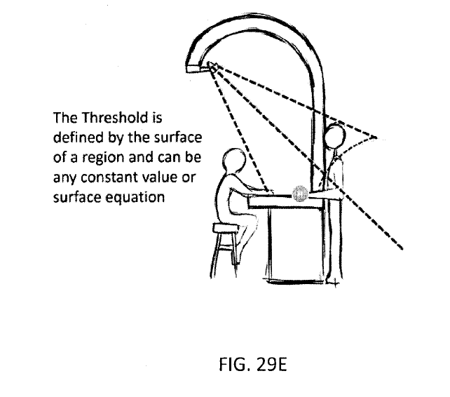

Referring now to FIG. 29A, an embodiment of an environment of the dealer casino gesture monitoring system is displayed. A camera may be positioned in front and above the casino dealer, such that the dealer's entire upper body, as well as the casino table, is within the field of view of the camera.

To calculate when a dealer, cashier, or a precious item handler/sorter/counter reaches to their pocket, stomach, head or other part of their body, the positional matrix of the left and right hand points can be compared to a constant or a surface equation of an axis, which may be used as a threshold. This specified threshold represents the distance away from the camera vision system. This distance can be presented before starting the application or can be automatically calibrated using a calibration tool. The following illustrates comparison operator for computer code implementation where m_PocketThL represents the constant threshold in meters.

if (HandLeft.Position.Z > m_PocketThL)
{
SendToDatabase(″pocket″, ″left″);
}

FIGS. 29B, 29C, 29D, and 29E illustrate the use of different axes, planes or regions for application of the threshold described. FIG. 29B explains implementation of a pocketing detection mechanism using a z-axis threshold. FIG. 29C illustrates the use of a surface of a table as a threshold. FIG. 29D illustrates that multiple surface planes can be used as thresholds, and FIG. 29E illustrates the use of multiple regions as thresholds.

These thresholds, for example, may be used in compressing and/or reducing the amount of data that needs to be analyzed. For example, the data may be truncated if it is outside of this threshold.

In order to track when for example a dealer, cashier, or a precious item handler/sorter/counter reaches to their pocket, stomach, head or other part of their body, a number of body feature points can be actively tracked.

In some embodiments, 3 body feature points may be actively tracked. These points may include the left hand, right hand and the head. In real time the distance between the left hand and head or right hand and head are calculated using this formula where x1, y1, z1 represents the positional matrix of the head and x2, y2, z2 represents the positional matrix of the left or right hand.

\sqrt{(x₂−x₁)²+(y₂−y₁)²+(z₂−z₁)²}

From there a comparator is used to determine if the distance has reached a predefined threshold. Much like the surface planes mentioned above. Proximity and surface regions can be used independently or dependently as follows:

if (calcJointDistance(HandLeft, movedJoint) < normfactor)
{
SendToDatabase(″stomach″, ″left″);
}

Alternative image data acquisition mechanisms can be used. For example a vision sensor mechanism may be used. A vision sensor may include a transmitter that emits high frequency electromagnetic waves. These waves are sent towards the casino table and dealer. In some embodiments, the alternative image data acquisition mechanisms may be used to apply to any table and/or various jobs, such as a cashier and/or precious materials sorter or counter.

The waves then bounce back off of the table and dealer and are collected in a receiver of the device. From the speed of travel, and the intensity of the wave that has bounced back, a computer system using suitable software is able to calculate the distance from each pixel visible to the device. From this dataset, features of the human body, such as for example, hands, head and chest can be recognized and actively tracked in real time. Using the x, y, z co-ordinates of these distinct feature sets for example procedural violations can be detected that have occurred in any given environment or scene being monitored. Other coordinate systems may be contemplated, such as polar coordinates, cylindrical coordinates, spherical coordinates, etc.

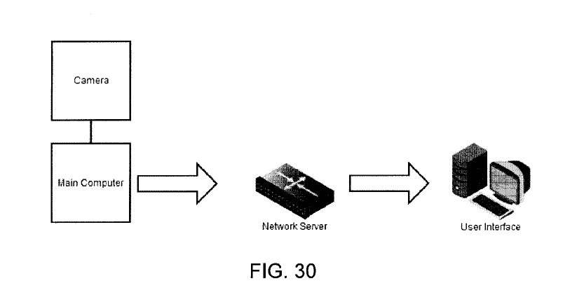

FIG. 30 is a possible computer system resource diagram, illustrating a general computer system implementation of the present invention.

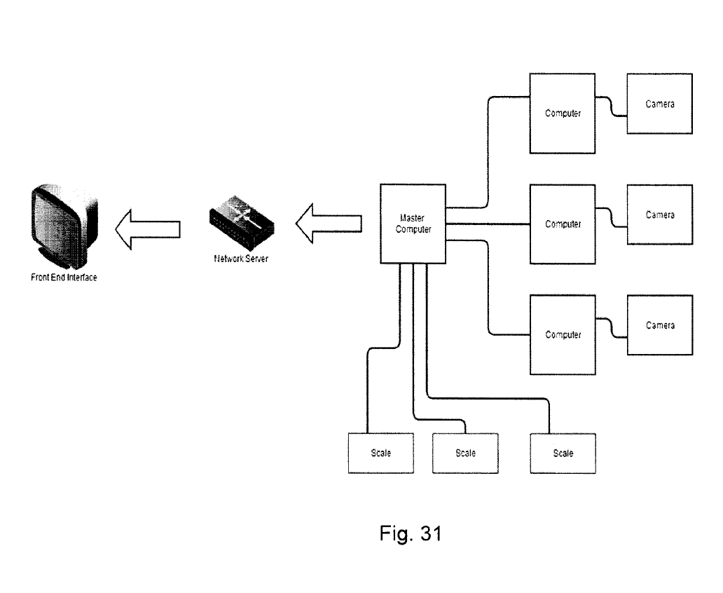

FIG. 31 is a computer system resource diagram, illustrating a possible computer network implementation of a monitoring system of the present invention. FIG. 31, shows multiple cameras which may be networked, for example to monitor multiple tables. Data acquired across multiple cameras may be processed using the crowd sourcing techniques previously described.

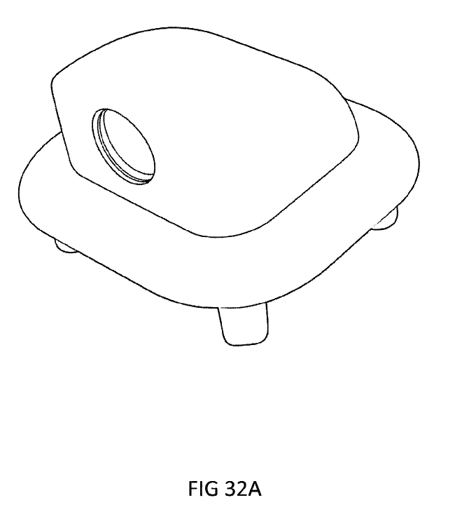

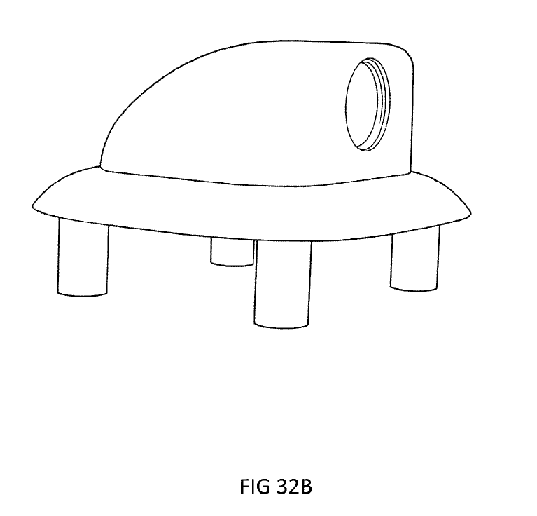

FIGS. 32A and 32B illustrate an example of a camera for use with, or as part of, a monitoring system of the present invention.

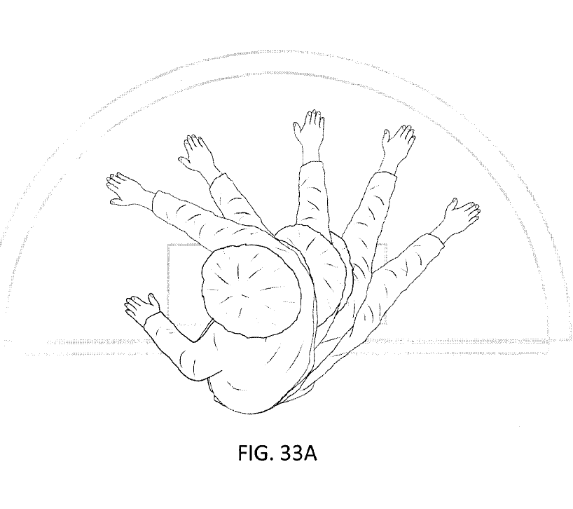

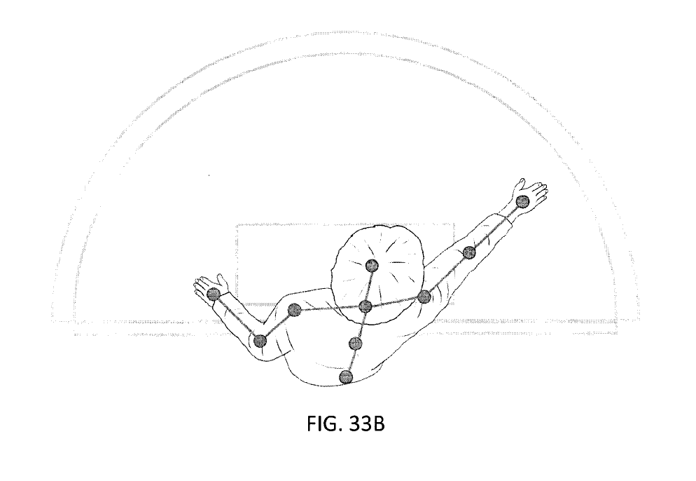

FIG. 33A is a representation of a casino worker monitored using the monitoring system of the present invention.

FIG. 33B is a representation of the recognition of body parts by the monitoring system of the present invention. In this example, a number of points are detected and/or recognized that may be related to the monitored individual's arms, torso, head, etc., and these points may be tracked and/or monitored by the system.

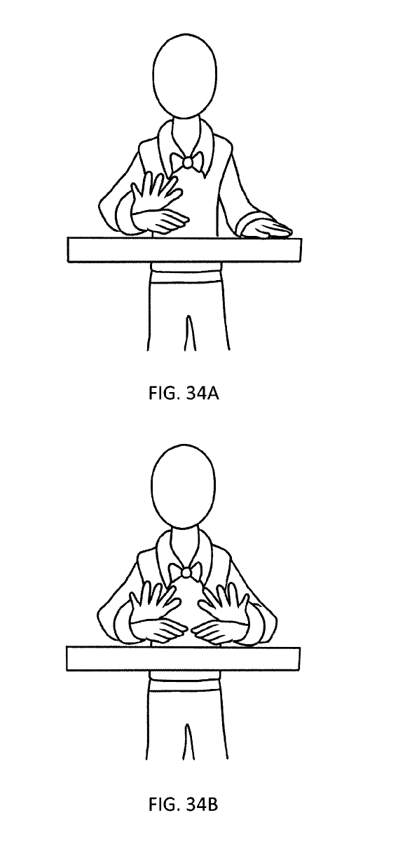

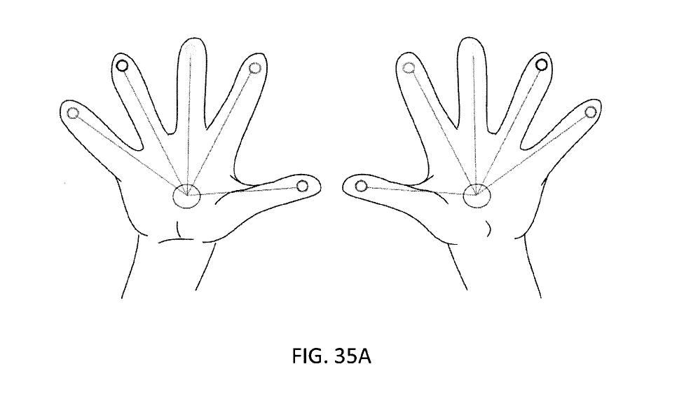

FIGS. 34a and 34B consist of representations of a casino worker performing a “hand wash”.

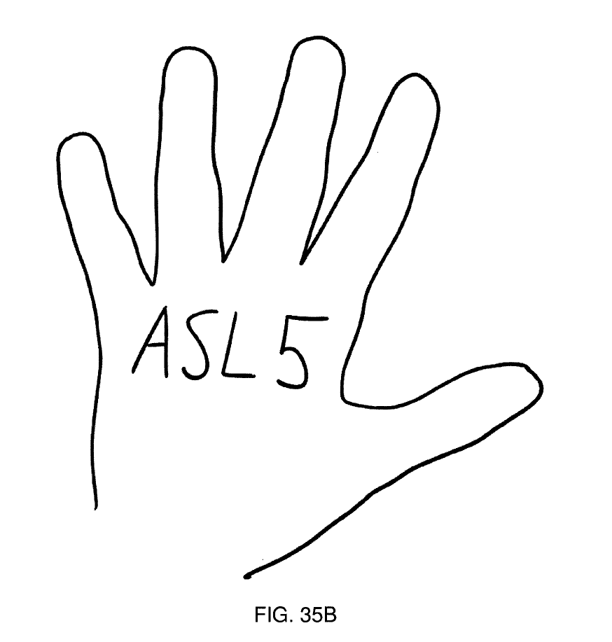

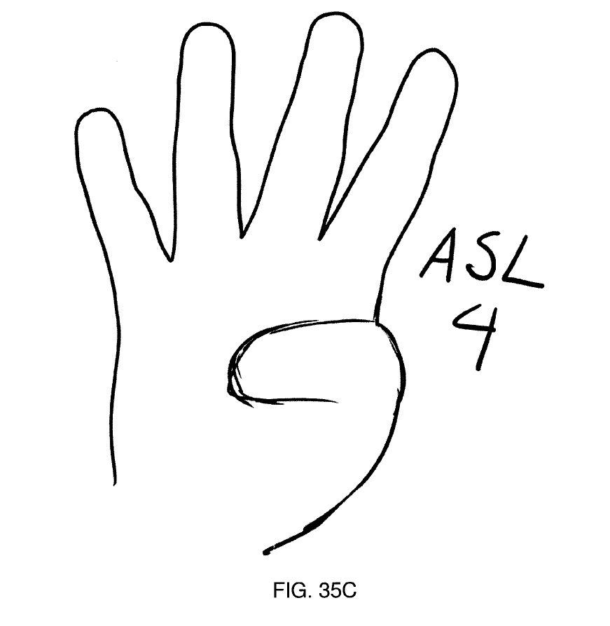

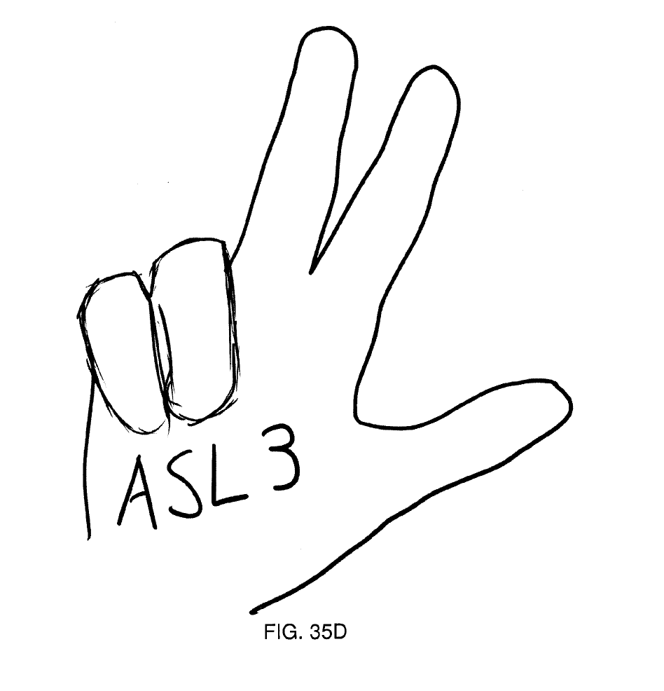

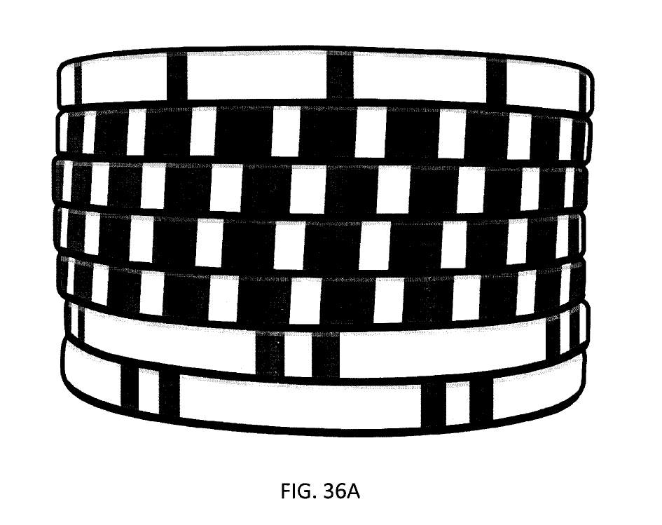

FIGS. 35A, 35B, 35C and 35D illustrates a series of individual gestures involved in detection of a hand wash.

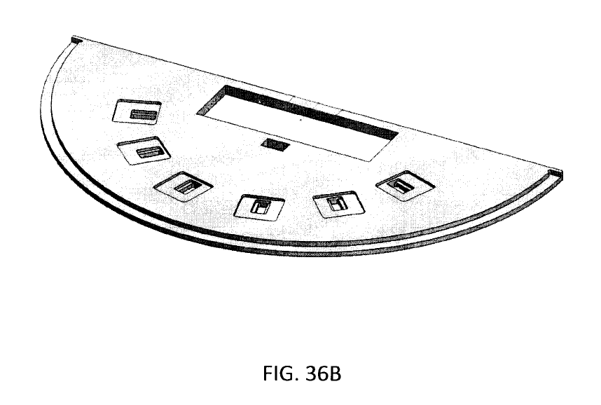

FIG. 36A illustrates a possible view of a dealer from a camera with a table level vantage for detecting movements relative to chips.

FIG. 36B is a photograph showing integration of a scale with a casino table in order to provide further data inputs for monitoring dealer activities, as part of a movement monitoring system that also includes the gesture recognition functionality described.

The scale shown is a simplified example. In some embodiments, the scale may instead be a resistive overlay (e.g., a flat layer) where sections and/or sensed loads may be plotted out to develop a model of objects on the layer and the number of objects at various locations. For example, this information may be utilized to generate a 3D model.

Referring now to FIG. 30, a block diagram of an embodiment of a casino monitoring system is illustrated. A camera that is monitoring a casino dealer, may be connected to a main computer, which may be connected to a network server and finally to the user interface. The camera may be directed at the target, such as the casino dealer, casino player and other person or persons being monitored. Main computer may include the environment in which the aforementioned system components execute the gesture recognition functionality. Finally, the user interface on which the casino officials may monitor the targets, such as the dealers or players, may be connected to the main computer via the network server.

Referring now to FIG. 31, a block diagram of an embodiment of the system is shown where multiple cameras may be networked. In one embodiment, three cameras are required to monitor a table, each of the three cameras monitoring two betting areas. Various other configurations are possible. Other configurations are possible, where multiple tables and associated cameras, are networked. In an enterprise implementation of the present invention, the computer system includes one or more computers that include an administrator dashboard that may example a casino official to monitor one or more tables centrally. The computer system may be accessed for example remotely by the casino official, from any suitable network-connected device. The administrative dashboard may enable the casino official for example to: (A) receive notifications of suspicious behaviour based on monitoring movements using gesture recognition, as described herein, and (B) selectively access real time or recorded video data for a monitored user that is the subject of the notifications(s).

The computer system may incorporate one or more analytical tools or methods for analyzing the gesture data. For example, a casino official may access comparative data for one or more particular dealers so as to enable the detection and monitoring of trends indicative of suspicious behaviour.

Referring now to FIG. 32A and FIG. 32B, illustrations of embodiments of a camera system are illustrated. Camera systems may have an opening for the optics, an enclosure as well as the stands or other similar types of interfaces enabling the camera to be positioned or attached when directed at the monitored target person.

Referring now to FIG. 33A and FIG. 33B, illustrations of embodiments of initialization gestures are illustrated. In FIG. 33A, a casino dealer makes a hand motion on the surface of the table from one side to another, indicating that the table is clear. Similarly, in FIG. 33B the same, or a similar, motion is shown from the point of view of the camera directed at the dealer. This motion may be used as a trigger to begin the process of observing the dealer while the dealer is dealing the cards to the casino players. Similarly, any other specific motion may be used as a trigger, such as a hand wave, finger movement, a hand sign or similar.

Referring now to FIG. 34A and FIG. 34B, illustrations of embodiments of “hand washing” gestures are illustrated. The hand washing gestures may be any gestures which the casino dealer performs to indicate that no chips, cards or other game-specific objects are hidden in the dealer's hands. FIG. 34A illustrates a single hand wash, where the dealer shows both sides of a single hand. FIG. 34B illustrates a two hand wash, where the dealer shows both sides of both hands to show that no chips or cards, or similar objects are hidden.

Referring now to FIGS. 3A-35D, illustrations of embodiments of hand gestures used to indicate hiding or not hiding of the chips by the dealers are illustrated. In brief overview, if a casino dealer takes a chip from the table, gestures of the dealer's hands may be indicative of the dealer's actions of taking a chip. For example, a dealer may take a chip using one or more fingers, while trying to hide the chip underneath the palm of the hand. In such instances, gesture system may use gesture recognitions of hands to detect such actions.

As illustrated in FIG. 35A, gesture recognition of hands may be done by using gesture data points that include tips of each of the fingers: thumb, index finger, middle finger, ring finger and the pinky finger, as well as the location of the center of the palm of the hand. As such each finger may be represented, in the system, as a vector between the gesture data point (i.e. tip of the finger) and the center of the person's palm. Gesture data may then be organized to include locations of each of the fingertip locations with respect to the location of the center of the palm of the hand. Moreover, depending on the embodiments, gesture data may include locations of finger joints, such as the joints of each of the fingers between the intermediate phalanges and proximal phalanges and knuckles. Any of these hand locations may be represented with respect to any reference point on the hand, such as the center of the palm, a knuckle, fingertip or any other part of the human body.

FIG. 35B illustrates a gesture referred to as the American sign language five (ASL 5) gesture, which shows an open hand incapable of holding any objects, such as chips or cards underneath the palm. ASL 5 may be a gesture that indicates that no illegal action is performed.

FIG. 35C illustrates a gesture referred to as the American sign language four (ASL 4) gesture, in which the thumb of the hand is folded underneath the palm. This gesture may be indicative of a dealer or player hiding a chip underneath the hand.

FIG. 35C illustrates a gesture referred to as the American sign language three (ASL 3) gesture, in which the ring and pinky fingers are folded underneath the palm. This gesture may also be indicative of a dealer or player hiding a chip underneath the hand. It is understood that various other combinations of folded fingers may be indicative of chip hiding, such as the folding of any one of, or any combination of the: thumb, index finger, middle finger, ring finger or the pinky finger. By monitoring the gestures of the hands, while also monitoring the movements of the upper body, including the arms, the gesture recognition system may detect not only the stealing of the chips by pocketing the chips, but also hiding of the chips underneath the palm of the hand in the process of pocketing the chips. These gesture recognition techniques may be used individually or in combination to provide various degree of certainty of detecting the misappropriation of the chips.

Referring now to FIG. 36A, an embodiment of a camera view performing a function of chip counting is illustrated. In brief overview, a camera may include the functionality of counting chips based on stacks. Color coding of the chips may be utilized to distinguish the chips and the stacks height may be determinative of the chip amount in the stacks. Chip stacks may be stored as gestures in the system and chip images may be compared against the stored data. When a match between the incoming frame of the chip stack and a stored known chip stack is determined, the system may establish the value of the chips in the stacks. Using this methodology, the system may determine the total value of the chips of each player and the dealer. Combining the aforementioned gesture data with the chip counting may provide an additional layer of protection and prevention of misappropriation of chips.

Referring now to FIG. 36B, an embodiment of a setup in which a scale is installed is illustrated. The scale may be positioned underneath the portion of the table on which the chips are stacked. The scale may take measurements of the weight responsive to a command by the system. As such, the system may determine when the chips are not touched by the dealer or the player, thereby ensuring that a correct measurement is taken, and in response to such a determination send a command to measure the weight of the chips. Based on the weight and the coloring of the chips, the system may determine the present amount of the chips the user may have.

Using these techniques, the system may monitor and track not only the chips of the dealers, but also the chips of the players, may track the progress of each player and may be able to see when and how each player is performing. The system may therefore know the amount of chips gained or lost in real time at any given time.

In some embodiments, other sensors and/or scales may also be utilized in addition to or as alternatives to chip counters.

In some embodiments, various compression techniques may be utilized in relation to the gesture recognition component for the monitoring of monitored individuals. For example, the compression techniques may include the principal joint variable analysis as described in Section B, the personal component analysis as described in Section C, the use of slow and fast motion vector representations as described in Section D, and the use of techniques based on polynomial approximation and eigenvectors as described in Section K.

For example, the systems and methods may be configured for determining that a subset of the set of gesture data points is sufficient to recognize the one or more movements; and identifying one or more movements by comparing gesture data points from the subset of the set of gesture data points between a plurality of the one or more frames, and the identification of the subset may be conducted by applying one or more weights to the one or more gesture data points based on variance of the one or more gesture data points across a plurality of frames; and selecting the one or more gesture data points that satisfy a threshold weight as the subset of the one or more gesture data points.

In an embodiment, gesture recognition techniques described herein may be used for monitoring game activities at gaming tables, e.g., dealing card hands, betting, playing card hands, and so on.

For example, each player, including the dealer and customers, may be dealt a card hand. That is, for a card game, each active player may be associated with a card hand. The card hand may be dynamic and change over rounds of the card game through various plays. A complete card game may result in a final card hand for remaining active players, and a determination of a winning card hand amongst those active players' hands. A player may have multiple card hands over multiple games. Embodiments described herein may count the number of card hands played at a gaming table, where the hands may be played by various players. The card hand count may be over a time period. Card hand count may be associated with a particular gaming table, dealer, customers, geographic location, subset of gaming tables, game type, and so on.

The card hand count data may be used by casino operators and third parties for data analytics, security, customer promotions, casino management, and so on. For example, card hand count data may be associated with a timestamp and gaming table identifier to link data structures for further data analysis, processing and transformation. In an embodiment, the card hand count data may be used in conjunction with data collected in association with other customer/dealer activity in a casino described above. For example, the combined data may be used to detect the scope of theft/fraud (e.g., spanning a certain number of card hands), to trace the progression of theft/fraud over time, e.g., from one hand to another hand.

In an embodiment, movements or gestures of two or more individuals may be detected simultaneously, e.g., a customer and a dealer, or two customers, who may be acting in concert to effect theft/fraud.

1. A system for monitoring activities at a gaming venue, the system comprising:
one or more capture devices configured to capture gesture input data, each of the capture devices disposed so that one or more monitored individuals are within an operating range of the data capture device; and
one or more electronic datastores configured to store a plurality of rules governing activities at the gaming venue;
an activity analyzer comprising:
a gesture recognition component configured to:
receive gesture input data captured by the one or more capture devices;
extract a plurality of sets of gesture data points from the captured gesture input data, each set corresponding to a point in time, and each gesture data point identifying a location of a body part of the one or more monitored individuals with respect to a reference point on the body of the one or more monitored individuals;
identify one or more gestures of interest by processing the plurality of sets of gesture data points, the processing comprising comparing gesture data points between the plurality of sets of gesture data points;
a rules enforcement component configured to:
determine when the one or more identified gestures of interest correspond to activity that contravenes one or more of the rules relating to gaming activities or betting activities stored in the one or more electronic datastores.

2. The system of claim 1, wherein the data capture devices include at least one of: a camera, an accelerometer, and a gyroscope.

3. (canceled)

4. (canceled)

5. The system of claim 1, wherein the gesture input data comprises a east one of: x, y and z position data; position data; rotational data; velocity data; and angular position data.

6. (canceled)

7. (canceled)

8. (canceled)

9. The system of claim 1, wherein the gesture recognition component receives the gesture input data from the one or more capture devices in real-time.

10. (canceled)

11. (canceled)

12. The system of claim 1, wherein the gestures of interest correspond to at least one of dealer hand-washing gestures, hand movements, interactions with body parts, interactions with objects, and placement of hands in pockets.

13. The system of claim 1, wherein the gesture recognition component utilizes one or more compression techniques and at least one of the one of the one or more compression techniques includes configuring a compression engine to:
determine that a subset of the gesture data points is sufficient to recognize the one or more gestures; and
identify one or more gestures of interest by comparing gesture data points from the subset of the gesture data point.

14. (canceled)

15. The system of claim 14, wherein the compression engine is configured to determine that a subset of the set of gesture data points is sufficient to recognize a movement, and the compression engine configured to:
apply one or more weights to the one or more gesture data points based on variance of the one or more gesture data points across a plurality of sets of data points; and
select the one or more gesture data points that satisfy a threshold weight as the subset of the one or more gesture data points.

16. The system of claim 13, wherein the compression techniques include at least one of: principal component analysis; slow and fast motion vector representations; and the use of techniques based on polynomial approximation and eigenvectors.

17. (canceled)

18. (canceled)

19. (canceled)

20. The system of claim 1, further comprising one or more sensors wherein the one or more sensors are chip counting or card detection sensors.

21. (canceled)

22. The system of claim 20, wherein the activity analyzer is further configured to utilize sensor information provided by the one or more sensors in determining whether the one or more gestures corresponds to one or more activities of interest identified.

23. A method of monitoring activities at a gaming venue, the method comprising:
capturing gesture input data using one or more capture devices, each of the capture devices disposed so that one or more monitored individuals are within an operating range of the data capture device; and
storing a plurality of rules governing activities at the gaming venue;
extracting a plurality of sets of gesture data points from the captured gesture input data, each net corresponding to a point in time, and each gesture data point identifying a location of a body part of the one or more monitored individuals with respect to a reference point on the body of the one or more monitored individuals;
processing the plurality of sets of gesture data points to identify one or more gestures of interest, the processing comprising comparing gesture data points between the plurality of sets of gesture data points;
determining when the one or more identified gestures of interest correspond to activity that contravenes one or more of the rules relating to gaming activities or betting activities stored in the one or more electronic datastores.

24. The method of claim 23, wherein the capture devices include at least one of: a camera, an accelerometer, and a gyroscope.

25. (canceled)

26. (canceled)

27. The method of claim 23, wherein the gesture input data comprises at least one of: x, y and z position data; position data; rotational data; velocity data; and angular position data.

28. (canceled)

29. (canceled)

30. (canceled)

31. The method of claim 23, wherein the gesture input data is received from the one or more capture devices in real-time.

32. (canceled)

33. (canceled)

34. The method of claim 23, wherein the gestures of interest correspond to at least one of dealer hand-washing gestures, hand movements, interactions with body parts, interactions with objects, and placement of hands in pockets.

35. The method of claim 23, further comprising utilizing one or more compression techniques wherein at least one of the one or more compression techniques comprises:
determining that a subset of the gesture data points is sufficient to recognize the one or more gestures; and
identifying one or more gestures of interest by comparing gesture data points from the subset of the gesture data point.

36. (canceled)

37. The method of claim 35, wherein the determining that a subset of the set of gesture data points is sufficient to recognize a movement is determined by:
applying one or more weights to the one or more gesture data points based on variance of the one or more gesture data points across a plurality of sets of data points; and
selecting the one or more gesture data points that satisfy a threshold weight as the subset of the one or more gesture data points.

38. The method of claim 35, wherein the compression techniques include at least one of: principal component analysis; slow and fast motion vector representations; and the use of techniques based on polynomial approximation and eigenvectors.

39. (canceled)

40. (canceled)

41. (canceled)

42. The method of claim 23, further comprising receiving sensory information from one or more sensors wherein the one or more sensors are chip counting or card detection sensors.

43. (canceled)

44. (canceled)

45. A non-transitory computer readable media storing machine-readable instructions, the machine-readable instructions, when executed on a processor, cause the processor to perform steps of a method of monitoring activities at a gaming venue, the steps comprising:
capturing gesture input data using one or more capture devices, each of the capture devices disposed so that one or more monitored individuals are within an operating range of the data capture device;
storing a plurality of rules governing activities at the gaming venue;
extracting a plurality of sets of gesture data points from the captured gesture input data, each set corresponding to a point in time, and each gesture data point identifying a location of a body part of the one or more monitored individuals with respect to a reference point on the body of the one or more monitored individuals;
processing the plurality of sets of gesture data points to identify one or more gestures of interest, the processing comprising comparing gesture data points between the plurality of sets of gesture data points;
determining when the one or more identified gestures of interest correspond to activity that contravenes one or more of the rules relating to gaming activities or betting activities stored in the one or more electronic datastores.
